(19) United States
(12) Patent Application Publication
(10) Pub. No.: US 2017/0013477 A1
(43) Pub. Date: Jan. 12, 2017

(54) NETWORK CONTROL METHOD AND SYSTEM

(71) Applicant: NEC Corporation, Tokyo (JP)

(72) Inventor: Yoshiyuki YAMADA, Tokyo (JP)

(73) Assignee: NEC Corporation, Tokyo (JP)

(21) Appl. No.: 15/122,061

(22) PCT Filed: Feb. 19, 2015
(86) PCT No.: PCT/JP2015/000782

§ 371 Date: Aug. 26, 2016

(30) Foreign Application Priority Data
Feb. 28, 2014 (JP) 2014-038996

(51) Int. Cl. H04W 24/02; H04L 12/823; H04L 12/825

(52) U.S. Cl. CPC H04W 24/02; H04L 47/25; H04L 47/32

(57) ABSTRACT

A network control method and system are provided that achieve effective load reduction control, overviewing an entire network. A system for controlling a network (20) including a plurality of nodes (21, 22) includes: a traffic data collection function (11) of collecting traffic data from the network; a traffic feature extraction function (12) of extracting a traffic feature of the network in its entirety from the collected traffic data; and a parameter determination function (13) of determining a control parameter to be set on the nodes, based on the traffic feature.

### TECHNICAL FIELD

The present invention relates to a method for controlling a network including a plurality of nodes, and a control system.

### BACKGROUND ART

In recent years, with the increasing traffic in mobile networks, an increase in control signal packets has become prominent, developing a tendency to make the load of control plane (C-Plane; hereinafter, referred to as C-plane) heavier and heavier. Since C-plane congestion causes a mobile network down in some cases, it is an importance issue to reduce the C-plane load in order to avoid communication failures, which may lead to such unavailability of a network.

Conceivable methods for reducing the C-plane load include: 1) suppression of the occurrence of a C-plane packet itself; 2) discard of a generated C-plane packet on the network side; 3) distributing of the concentrated processing of C-plane packets; and the like.

### 1) Suppression of the Occurrence of a C-Plane Packet Itself

NPL 1, subsection 5.3.5, describes that a base station initiates 51 release procedure due to detection of a terminal's inactive state (User Inactivity), whereby the occurrence of a C-plane packet itself can be suppressed.

Moreover, PTL 1 discloses a system in which, for the purpose of reducing the power consumption of a terminal, the network side measures time for which a terminal is out of communication and, if it is out of communication continuously for a predetermined period of time or longer, causes the terminal to shift to a sleep mode. Further, PTL 1 also discloses a method for changing the timeout period depending on the frequency of a terminal's communication. A timer for measuring a terminal's out-of-communication time and, upon timeout, causing the terminal to shift to a sleep state as described above is referred to as Inactivity Timer and is set as one of base station parameters.

### 2) Discard of a C-Plane Packet on the Network Side

According to NPL 1, subsection 4.3.7.4.1, when a base station receives an OVERLOAD START message including a Traffic Load Reduction Indication from an MME (Mobile Management Entity; hereinafter, referred to as mobility management node), the base station shifts to a communication restriction mode and deletes traffic in accordance with a requested ratio (restriction rate). For example, high priority emergency calls and preferential calls are accepted but low priority calls are rejected in accordance with the restriction rate, whereby the C-plane load can be reduced. Moreover, PTL 2 makes a statement to the effect that the restriction rate is dynamically changed depending on the state of resource occupancy that is dependent on the number of mobile stations in a service area, traffic distribution, or the like.

### 3) Distributing of the Processing of C-Plane Packets

According to NPL 1, subsection 4.3.7.4.1, when a base station rejects a connection request from a terminal for overload reasons, the base station notifies the terminal of a timer value (back-off timer value) that limits the next connection request transmission timing. Moreover, according to PTL 3, the back-off timer value is determined, based on a random seed, to be limited to values not smaller than the value used when the previous connection request was transmitted. The processing of C-plane packets concentrated at a base station can be temporally distributed by using the back-off timer as described above.

### CITATION LIST

### Patent Literature

[PTL 1]
Japanese Patent Application Unexamined Publication No. H11-313370
[PTL 2]
Japanese Patent Application Unexamined Publication No. H10-136423
[PTL 3]
Japanese Patent Application Unexamined Publication No. 2006-505200

### Non Patent Literature

[NPL 1]
3GPP TS 23.401 V12.1.0 (2013-06)

### SUMMARY

### Technical Problem

According to the above-described background technology, a control parameter such as the inactive timer value, restriction rate, or back-off timer value is determined by using a predetermined value or random seed, or alternatively by using information specific to a mobile terminal such as the communication frequency or battery charge remaining. The use of information specific to a terminal makes it possible to perform parameter control responding to the status of each individual mobile terminal.

However, processing for always keeping track of the status of each individual mobile terminal makes heavy loads in general. Moreover, in some cases, it is more effective for avoiding congestion to consider the status of the entire network than to consider the status of each individual mobile terminal. According to the above-described background technology, parameters other than those related to the connection frequency (occurrence rate) are not taken into consideration in particular with respect to traffic characteristics, and effective traffic reduction control based on information acquired from the entire network cannot be performed.

For example, even if individual terminals are observed, it is difficult to recognize a change in traffic caused by a failure of network equipment. Moreover, when communication control is performed for the purpose of avoiding communication failures or avoiding congestion at communication processing servers, it is difficult to take consideration of the effects of simultaneous connection requests, which are created by a plurality of terminals generating packets at the same timing, even if the status of each individual mobile terminal or the number of mobile terminals in a service area is observed. Accordingly, load reduction control responding to the status of the entire network cannot be performed even if a parameter for restricting traffic is set depending on the predetermined value, random number, information specific to a terminal, or the number of mobile terminals in a service area.

Accordingly, an object of the present invention is to provide a network control method and system that can achieve an effective load reduction, overviewing the entire network.

### Solution to Problem

A network control system of the present invention is a system for controlling a network including a plurality of nodes, and is characterized by including: a traffic data collection means for collecting traffic data from the network; a traffic feature extraction means for extracting a traffic feature of the network in its entirety from the collected traffic data; and a parameter determination means for determining a control parameter to be set on the nodes, based on the traffic feature.

A network control method of the present invention is a method for controlling a network including a plurality of nodes, and is characterized by including: by a traffic data collection means, collecting traffic data from the network; by a traffic feature extraction means, extracting a traffic feature of the network in its entirety from the collected traffic data; and by a parameter determination means, determining a control parameter to be set on the nodes, based on the traffic feature.

### Advantageous Effects of Invention

According to the present invention, a control parameter of communication apparatuses is determined based on a traffic feature of the entire network, whereby it is possible to achieve an effective network load reduction.

### BRIEF DESCRIPTION OF DRAWINGS

FIG. 1 is a schematic system architecture diagram for describing functions of a network control system according to a first exemplary embodiment of the present invention.

FIG. 2 is a graph showing the relationship between C-plane occurrence rate and average delay, using the simultaneous arrival rate for a parameter.

FIG. 3 is a time chart for describing the operation of an inactivity timer.

FIG. 4 is a graph showing the relationship between U-plane packet occurrence rate and C-plane service request occurrence rate, using the inactivity timer value for a parameter.

FIG. 5 is a network architecture diagram for describing a network control system according to a second exemplary embodiment of the present invention.

FIG. 6 is a block configuration diagram showing a first example of a radio base station in the second exemplary embodiment.

FIG. 7 is a block configuration diagram showing a first example of a mobility management node in the second exemplary embodiment.

FIG. 8 is flowcharts showing a traffic data collection phase and a parameter control phase in a first example of a network control method according to the second exemplary embodiment.

FIG. 9 is a sequence chart showing the traffic data collection phase and parameter control phase in the first example of the network control method according to the second exemplary embodiment.

FIG. 10 is a block configuration diagram showing a second example of the mobility management node in the second exemplary embodiment.

FIG. 11 is flowcharts showing a traffic data collection phase and a parameter control phase in a second example of the network control method according to the second exemplary embodiment.

FIG. 12 is a sequence chart showing the traffic data collection phase and parameter control phase in the second example of the network control method according to the second exemplary embodiment.

FIG. 13 is a network architecture diagram for describing a network control system according to a third exemplary embodiment of the present invention.

FIG. 14 is a block diagram showing the functional configuration of a mobility management node in the third exemplary embodiment.

FIG. 15 is a block diagram showing the functional configuration of an analysis and determination apparatus in the third exemplary embodiment.

FIG. 16 is a sequence chart showing a traffic data collection phase in a network control method according to the third exemplary embodiment.

FIG. 17 is a sequence chart showing a parameter control phase in the network control method according to the third exemplary embodiment.

FIG. 18 is a network architecture diagram for describing a network control system according to a fourth exemplary embodiment of the present invention.

FIG. 19 is a block diagram showing the functional configuration of a radio base station in the fourth exemplary embodiment.

FIG. 20 is a block diagram showing the functional configuration of a mobility management node in the fourth exemplary embodiment.

FIG. 21 is a block diagram showing the functional configuration of an analysis and determination apparatus in the fourth exemplary embodiment.

FIG. 22 is a sequence chart showing a traffic data collection phase in a network control method according to the fourth exemplary embodiment.

FIG. 23 is a sequence chart showing a parameter control phase in the network control method according to the fourth exemplary embodiment.

FIG. 24 is a network architecture diagram for describing a network control system according to a fifth exemplary embodiment of the present invention.

FIG. 25 is a block diagram showing the functional configuration of a radio base station in the fifth exemplary embodiment.

FIG. 26 is a block diagram showing the functional configuration of an analysis and determination apparatus in the fifth exemplary embodiment.

FIG. 27 is a sequence chart showing a traffic data collection phase in a network control method according to the fifth exemplary embodiment.

FIG. 28 is a sequence chart showing a parameter control phase in the network control method according to the fifth exemplary embodiment.

FIG. 29 is a network architecture diagram for describing a network control system according to a sixth exemplary embodiment of the present invention.

FIG. 30 is a block diagram showing the functional configuration of a radio base station in the sixth exemplary embodiment.

FIG. 31 is a block diagram showing the functional configuration of a base station control apparatus in the sixth exemplary embodiment.

FIG. 32 is flowcharts showing a traffic data collection phase and a parameter control phase in a network control method according to the sixth exemplary embodiment.

FIG. 33 is a sequence chart showing the traffic data collection phase in the network control method according to the sixth exemplary embodiment.

FIG. 34 is a sequence chart showing the parameter control phase in the network control method according to the sixth exemplary embodiment.

FIG. 35 is a network architecture diagram for describing a network control system according to a seventh exemplary embodiment of the present invention.

FIG. 36 is a block diagram showing the functional configuration of an analysis and determination apparatus in the seventh exemplary embodiment.

FIG. 37 is flowcharts showing a traffic data collection phase and a parameter control phase in a network control method according to the seventh exemplary embodiment.

FIG. 38 is a sequence chart showing the traffic data collection phase in the network control method according to the seventh exemplary embodiment.

FIG. 39 is a sequence chart showing the parameter control phase in the network control method according to the seventh exemplary embodiment.

FIG. 40 is a network architecture diagram for describing a network control system according to an eighth exemplary embodiment of the present invention.

FIG. 41 is a block diagram showing the functional configuration of a radio base station in the eighth exemplary embodiment.

FIG. 42 is a block diagram showing the functional configuration of a mobility management node in the eighth exemplary embodiment.

FIG. 43 is a block diagram showing the functional configuration of an analysis and determination apparatus in the eighth exemplary embodiment.

FIG. 44 is flowcharts showing a traffic data collection phase and a parameter control phase in a network control method according to the eighth exemplary embodiment.

FIG. 45 is a sequence chart showing the traffic data collection phase in the network control method according to the eighth exemplary embodiment.

FIG. 46 is a sequence chart showing the parameter control phase in the network control method according to the eighth exemplary embodiment.

FIG. 47 is a network architecture diagram for describing a network control system according to a ninth exemplary embodiment of the present invention.

FIG. 48 is a block diagram showing the functional configuration of a radio base station in the ninth exemplary embodiment.

FIG. 49 is a block diagram showing the functional configuration of a mobility management node in the ninth exemplary embodiment.

FIG. 50 is a block diagram showing the functional configuration of an analysis and determination apparatus in the ninth exemplary embodiment.

FIG. 51 is a block diagram showing the functional configuration of a mobile terminal in the ninth exemplary embodiment.

FIG. 52 is flowcharts showing a traffic data collection phase and a parameter control phase in a network control method according to the ninth exemplary embodiment.

FIG. 53 is a sequence chart showing the traffic data collection phase in the network control method according to the ninth exemplary embodiment.

FIG. 54 is a sequence chart showing the parameter control phase in the network control method according to the ninth exemplary embodiment.

### DETAILED DESCRIPTION

Hereinafter, preferred embodiments of the present invention will be described with reference to the accompanied drawings.

### 1. First Exemplary Embodiment

According to a first exemplary embodiment of the present invention, a control parameter of a node included in a network is determined based on traffic feature(s) of the entire network. Thereby, it is possible to achieve an effective network load reduction by an overall view of the entire network. Hereinafter, the present exemplary embodiment will be described in detail with reference to drawings.

### 1.1) System Architecture

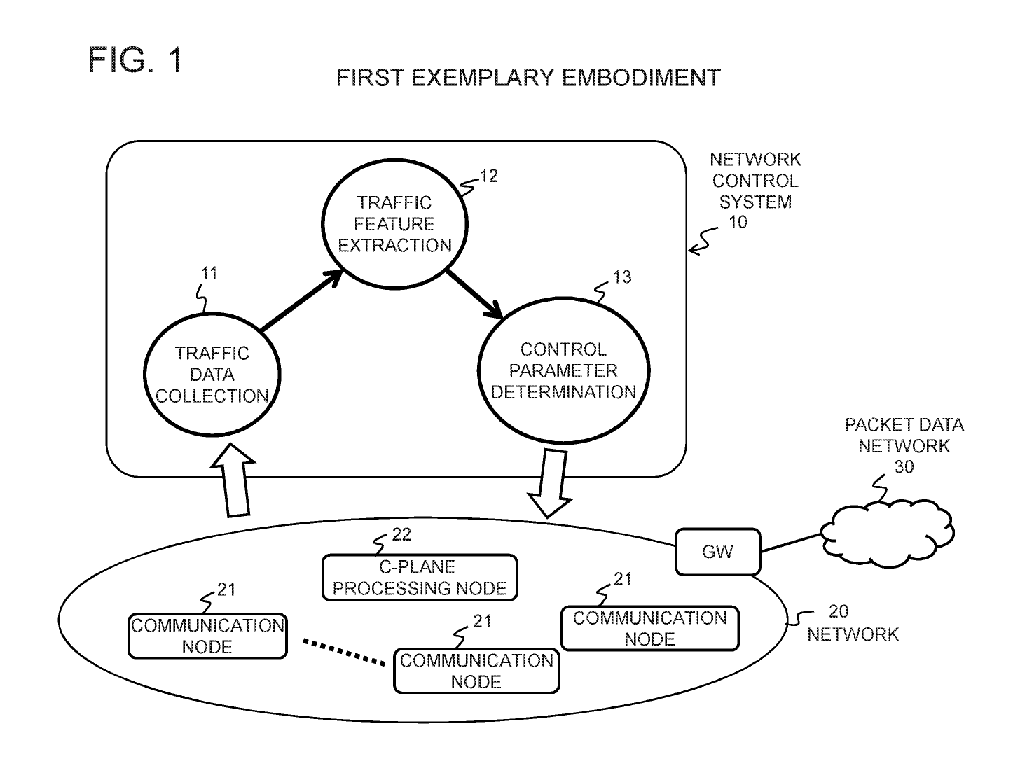

Referring to FIG. 1, a network control system 10 according to the first exemplary embodiment of the present invention observes an entire network 20, which includes a plurality of communication nodes 21 and a C-plane processing node 22, and controls parameter(s) to be set on node(s) in the network 20 based on traffic data in the entire network. It is assumed that the network 20 can perform packet communication with an external packet data network 30 via a gateway node (GW).

The network control system 10 includes a function 11 of collecting traffic data from the network 20, a function 12 of extracting a traffic feature from the traffic data collected, and a function 13 of determining control parameter(s) of node(s) included in the network 20 from the traffic feature extracted. However, the traffic data collection function 11, traffic feature extraction function 12, and control parameter determination function 13 may be centralized in a single apparatus, or may be distributed among a plurality of apparatuses. For example, the functions 11 to 13 may be provided to the C-plane processing node 22 or another analysis apparatus.

Alternatively, it is also possible that the traffic feature extraction function 12 is hierarchized, and a lower-level traffic feature extraction function is provided to communication node(s) 21 or an upper control apparatus (not shown) of the communication nodes 21 in the network 20, and their collected information are compiled as the traffic feature of the entire network by an even upper apparatus (the C-plane processing node or another analysis apparatus). Note that the functions 11 to 13 may be implemented by using hardware devices individually, or may be implemented with software by executing programs stored in a storage device on a computer.

### 1.2) Traffic Feature

A traffic feature is a quantity indicating a characteristic or property of traffic of the entire network and is one, or a combination of some, of quantities listed below as examples.
Occurrence rate or arrival rate of connection requests (the frequency of connections in the entire network)
Rate of simultaneous arrivals from a plurality of terminals (also referred to as synchronization rate between terminals, synchronization rate in the network, or burst rate)
periodic interval (in case periodicity is exhibited)
Phase (e.g., in case the occurrence time is fixed on the hour every hour, or the like)
Phase deviation (in case occurrence times are distributed in a certain range with a reference phase in the middle)

When the above-described traffic feature is extracted from collected traffic data, a node control parameter is calculated by using the extracted feature. Hereinafter, a description will be given by using a case as an example where the simultaneous arrival rate is used as the traffic feature.

### <Simultaneous Arrival Rate>

The simultaneous arrival rate is an indicator that indicates the degree at which packets generated from a plurality of terminals simultaneously arrive within a predetermined period of time in a network. Here, it is represented by letter “η”. The simultaneous arrival rate η can be defined by using a statistic such as the average, distribution, or variable coefficient of time intervals between the arrivals of generated packets. Alternatively, viewed from another aspect, the simultaneous arrival rate η can be also regarded as the ratio of the occurrence rate λ^{b} of simultaneous arrivals to the occurrence rate λ of packets in the entire network. Hereinafter, the concept of the simultaneous arrival rate will be described by using a case, as an example, where independently occurring packets and simultaneously arriving packets (arriving in a group) coexist, considering, for simplicity, the simultaneous arrival rate η as those packets that simultaneously arrive among the packets that occur in the entire network.

First, it is assumed that A is the occurrence rate of all events, λ^{e} is the occurrence rate of those independently occurring, λ^{b} is the occurrence rate of those simultaneously arriving, η (0≦η≦1) is the simultaneous arrival rate, N is the number of terminals that are origins of the packets, and t (seconds) is the average time interval between packet occurrences.

The occurrence rate λ^{b} of those simultaneous arriving can be expressed as N/t if simultaneous arrivals are defined as that N packets simultaneously occur, or arrive at a server, every t seconds in average. Here, t may depend on an arbitrary distribution, which may be an independent distribution (random) or a fixed period.

Moreover, the simultaneous arrival rate η can be regarded as the ratio of the occurrence rate λ^{b} of those simultaneously arriving to the occurrence rate λ of all events as described above if the occurrence rate λ of all events is the sum of the occurrence rate λ^{e} of those independently occurring and the occurrence rate λ^{b} of those simultaneously arriving: λ=λ^{e} λ^{b}. That is, the simultaneous arrival rate η can be expressed as:

η=λ^{b}/λ.

The occurrence rate λ of all events can be expressed as:

λ=λ^{e}+λ^{b}=(1−η)λ+ηλ.

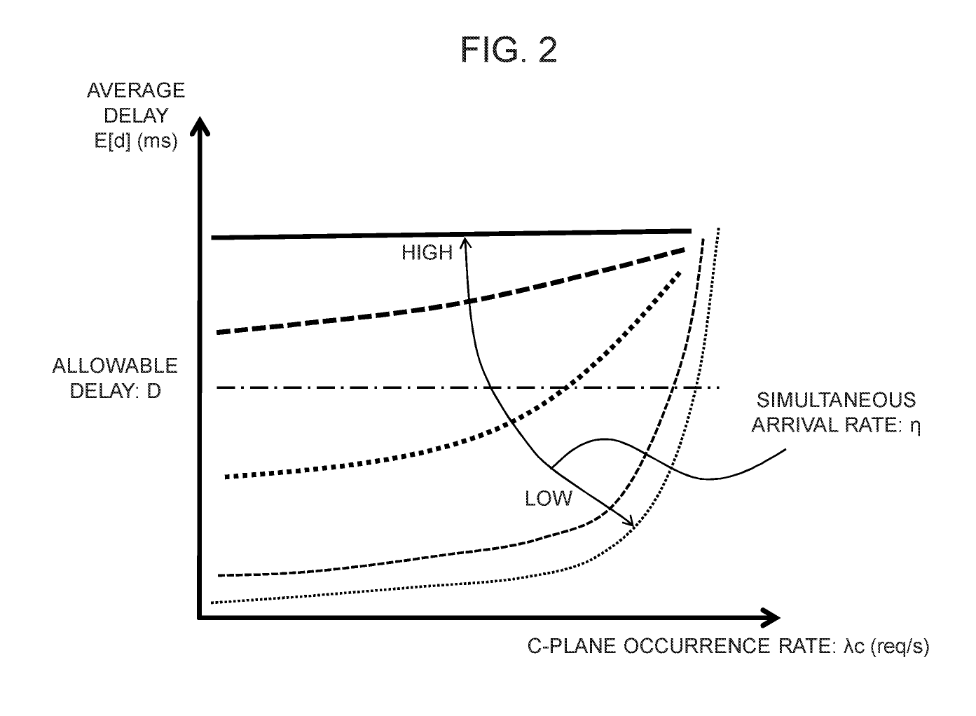

As shown in FIG. 2, the relationship between the C-plane packet occurrence rate λc and the average delay E varies depending on the simultaneous arrival rate η. Here, the average delay E is a processing delay at the C-plane processing node 22 and corresponds to, for example, the processing load on an MME (mobility management node) in a mobile network.

Referring to FIG. 2, as the simultaneous arrival rate η increases, the average delay E exceeds an allowable level D even if the C-plane packet occurrence rate λc becomes small. Conversely, as the simultaneous arrival rate η decreases, the average delay E stays under the allowable level D even if the C-plane packet occurrence rate λc becomes great to some extent. Accordingly, a communication node parameter such as an inactivity timer value or a back-off timer value is determined based on the simultaneous arrival rate η, which is a traffic feature, whereby it is possible to control the C-plane occurrence rate λc and thus to reduce the C-plane load in accordance with the network status.

Note that the use of the correlation between the parameters η, λc, and E as shown in FIG. 2 makes it possible to estimate, based on any two of the parameters, the remaining one parameter. For example, if the specifications of the C-plane processing node 22 are known, the processing load on the C-plane processing node 22 (which is evaluated as the average delay E here) can be calculated only by analyzing traffic. Moreover, the proportion of simultaneous occurrences can be calculated by monitoring the C-plane packet occurrence rate and the processing load on the C-plane processing node 22.

### 1.3) Control Parameter

As methods for reducing the C-plane processing load, known are suppression of the occurrence of a C-plane packet itself, discard of a generated C-plane packet on the network side, and distributing of the concentrated processing of C-plane packets, as described already. Hereinafter, a description will be given of an inactivity timer as a means for suppression of the occurrence of a packet itself, a restriction rate as a means for discard of a packet on the network side, and a back-off timer as a means for distributing of the packet processing.

### <Inactivity Timer>

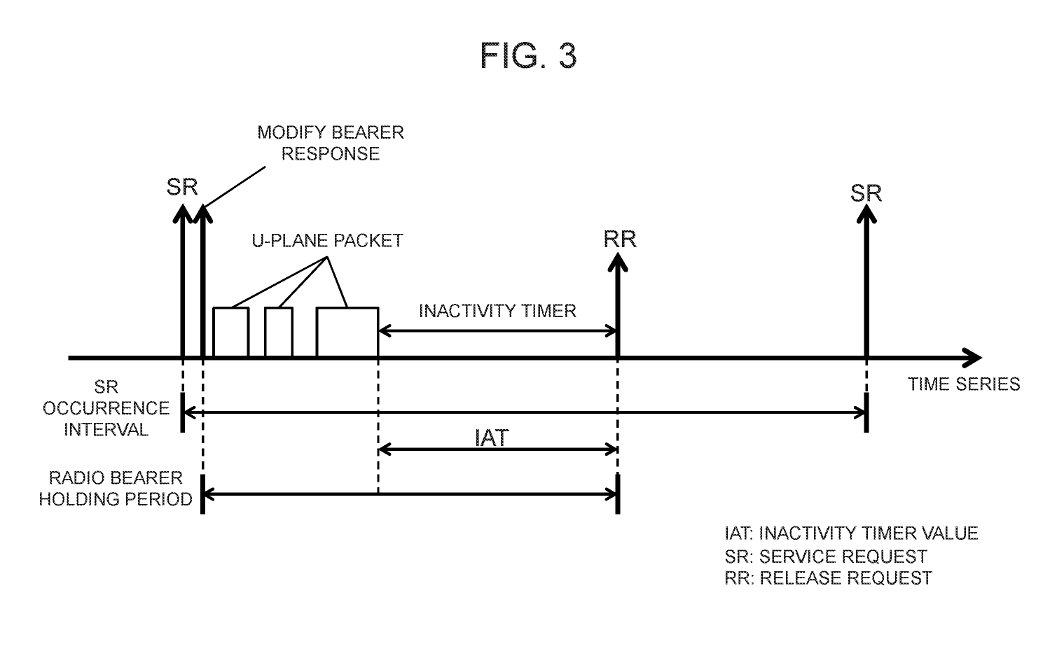

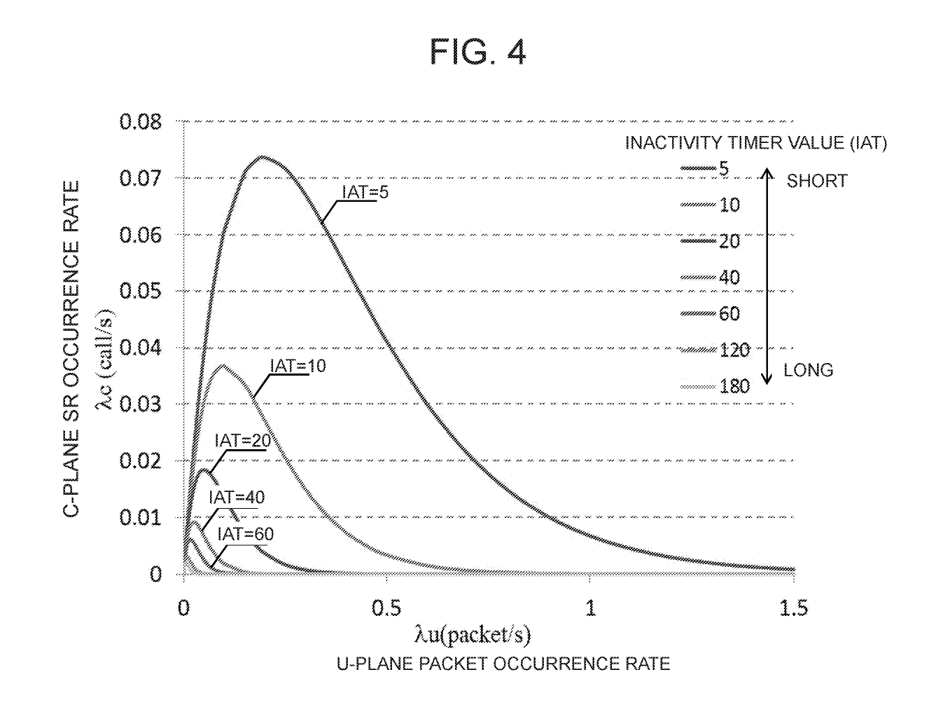

A control parameter known as an inactivity timer value greatly affects the amount of C-plane packets occurring. Hereinafter, a description will be given with reference to FIGS. 3 and 4.

Referring to FIG. 3, the inactivity timer is a timer for measuring a non-communication period to determine a timing for a terminal in a state of CONNECTED (connected state) to a base station to transition to IDLE state (sleep state). That is, when time having elapsed since the last occurrence of a U-plane packet reaches an inactivity timer value (IAT value), then a release request RR is generated, and a radio resource (radio bearer) is released. Accordingly, assuming that the reciprocal of a time interval at which a service request SR occurs is the SR occurrence rate, then as the IAT value is increased, the period of time during which the terminal occupies a radio resource (radio bearer holding period) is prolonged, causing hard transitioning between the connected state and the sleep state. That is, the amount of C-plane packets occurring per terminal is suppressed, and consequently the total number of C-plane packets on the network is also suppressed. Conversely, if the IAT value is decreased, the radio resource used by the terminal is released earlier, and consequently the total number of C-plane packets occurring is increased.

A graph shown in FIG. 4 depicts the SR occurrence rate in case where the inactivity timer value (IAT value) is used for a parameter. Here, it is assumed that the occurrence of C-plane packets at a terminal follows the Poisson process (exponential distribution), and that the horizontal axis represents the U-plane packet occurrence rate λu and the vertical axis represents the C-plane SR occurrence rate λc. The longer the inactivity timer value (IAT value), the smaller the C-plane SR occurrence rate λc, as shown in FIG. 4. Accordingly, if this relation is utilized, the amount of C-plane traffic can be also calculated analytically from the IAT value.

As described above, the SR occurrence rate is suppressed by making the IAT value longer. This, however, is accompanied by the tradeoff that the number of simultaneous connections increases accordingly because the radio resource use period per terminal becomes longer. Accordingly, the Inactivity Timer value, which is a base station parameter, is set depending on the traffic status, whereby it is possible to achieve network control taking consideration of the tradeoff between the load on a C-plane packet processing apparatus (MME) and the number of simultaneous connections.

For example, it is possible to perform control based on the network status in such a manner that under congestion, since apparatuses have no extra capacities, a reduction in the load on a core apparatus is prioritized by suppressing the occurrence of C-plane packets, whereas under less congestion, since apparatuses have extra capacities, the number of simultaneous connections is reduced to prioritize better connectivity.

### <Restriction Rate>

When the C-plane load has become large, a mobility management node or a base station transitions to a communication restriction mode, in which arriving packets are discarded at a requested restriction rate, whereby the C-plane load can be reduced. In this event, it is also possible to impose communication restrictions on terminals. According to the present exemplary embodiment, the restriction rate is determined based on the traffic feature, and it is possible to impose communication restrictions on at least one of, for example, a mobility management node, base station, and terminal depending on the network status indicated by the traffic feature.

In general, for communication restrictions, the restriction rate is adjusted depending on the magnitude of the packet arrival rate (occurrence rate) in the entire network, and a mobility management node imposes restrictions on terminals or base stations. Here, enlarging the targets to which communication restrictions are applied, for example, communication restrictions are applied to the mobility management node, or alternatively restrictions are imposed at the level of terminals or base stations, even if the simultaneous arrival rate is high, whereby packets arriving at the mobility management node can be reduced, and the load can be lightened. Moreover, if packet occurrence events have periodicity or phases, communication restrictions are imposed on terminals or base stations so that packet occurrences will not be concentrated. With such restrictions, for example, a connection request is accepted/rejected in accordance with the restriction rate, whereby the C-plane load can be reduced or adjusted.

### <Back-Off Timer>

A control parameter known as a back-off timer value contributes greatly to the distributing of C-plane packet processing. As the simultaneous arrival rate η increases, the average delay E exceeds an allowable level D in some cases even if the C-plane packet occurrence rate λc becomes smaller, as shown in FIG. 2. Accordingly, when the simultaneous arrival rate η is large in particular, load distributing of the C-plane packet processing is effective to solve a state of overload. Moreover, if packet occurrence events have periodicity or phases, a back-off timer value is set such that packet occurrences will not be concentrated, whereby it is possible to effectively distribute the C-plane packet processing.

### 1.4) Operations

### <Collection of Traffic Data>

Traffic data collected from the network 20 includes control signal traffic on the C-plane and user data traffic on the U-plane. Note that the C-plane traffic can be also analytically obtained if the inactivity timer value is known. The traffic data can be acquired at the egress/ingress of an IP tunnel configured between a communication node 21 and a gateway node GW or the C-plane processing node 21.

The targets from which traffic data is to be collected may be all communication nodes 21 in the network 20, but also may be part of the communication nodes sampled at random, or may be part of the communication nodes selected by design. Moreover, it is also possible that the communication nodes are classified based on the number of users per communication node, population statistical information, or the like as an index, and targets for collection are selected at random from each class such that they agree with the proportions of the classes in distribution.

### <Extraction of Traffic Feature>

The traffic feature is statistical information on the traffic data collected from the network 20 as described above. Information on the connection request occurrence rate, arrival rate, periodic characteristic, phase, or phase deviation in the entire network can be obtained from, for example, statistical information of terminals, which are the origins of packets, or of base stations that receive packets from the terminals. Moreover, the simultaneous arrival rate (synchronization rate among a plurality of terminals, synchronization rate in the network, or burst rate) can be calculated as described above.

### <Determination of Control Parameter>

The network control system 10 determines control parameter(s) of node(s) in the network based on the extracted traffic feature, as described above. Specifically, the traffic feature is compared with a determination condition, and a control parameter is calculated depending on the comparison result. The thus calculated parameter is applied to all or part of the nodes, whereby it is possible to perform network control based on the traffic status.

For example, it is determined whether or not to change the control parameter value, depending on whether the traffic feature is larger or smaller than a predetermined threshold. Alternatively, a predetermined range is preset for the threshold, and the control parameter is kept at a current value if the traffic feature falls within the range where the traffic feature meets the determination condition, but the control parameter value is changed if the traffic feature does not meet the determination condition. Assuming that the traffic feature is the packet occurrence rate in the entire network and that the control parameter is the inactivity timer value, then the occurrence rate is suppressed by making the inactivity timer value longer when the occurrence rate exceeds the predetermined threshold. When the occurrence rate falls under the predetermined threshold, the inactivity timer value is made shorter if there is processing capacity available. It is also possible that thresholds are set at two levels so that the timing of changing the control parameter will have hysteresis characteristics. Moreover, for the timing of determining a parameter change, determination can be performed at predetermined periods, or can be triggered when specific processing requests occur in extraordinarily large amounts as compared with normal times.

The threshold for the determination condition can be determined, for example, in consideration of device specifications such as the throughput of the C-plane processing node 22. Moreover, it is also possible to take consideration of the effects of deviations (dispersion) from the average value related to C-plane packet occurrence, or to estimate a rough dispersion characteristic of the C-plane packet occurrence rate based on data on age, gender, and the like in the area where base stations are deployed so as to reflect it on the threshold.

Moreover, as for the granularity at which the control parameter is set, the same value may be set on all communication nodes 21, or a different value may be set on each node or each group of some communication nodes, depending on the status of the individual communication nodes 21. For example, if the communication nodes are mobile terminals, the inactivity timer is a parameter managed for each mobile terminal and therefore can be set differently on each terminal.

### 1.5) Effects

As described above, according to the first exemplary embodiment of the present invention, a control parameter (inactivity timer value, restriction rate, back-off timer value, or the like) of a node or nodes, which are constituent elements of a network, is determined based on a traffic feature (C-packet occurrence rate, simultaneous arrival rate, periodic interval, phase, phase shift, or the like) in the entire network, whereby it is possible to achieve an effective C-plane load reduction, overviewing the entire network. For example, the inactivity timer value of communication nodes is changed, whereby the C-plane packet occurrence rate can be restricted to achieve a reduction in the C-plane processing load, and also the number of simultaneous connections can be adjusted to improve connectivity. That is, it is possible to perform network control, taking consideration of the tradeoff between the C-plane processing load and the number of simultaneous connections. Further, it is possible to perform adequate parameter control on communication nodes even in the face of a failure of network equipment or a change in the status of the network such as congestion.

### 2. Second Exemplary Embodiment

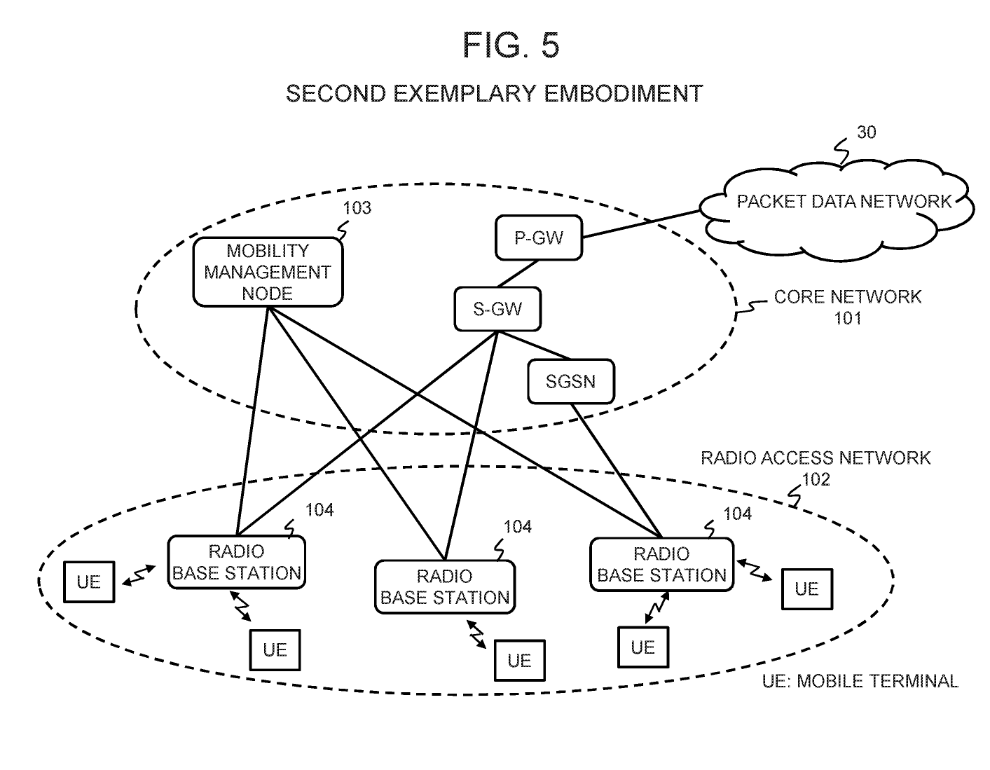

In a second exemplary embodiment of the present invention, a mobility management node in a mobile network is provided with the traffic data collection function 11, traffic feature extraction function 12, and base station parameter determination function 13 of the network control system 10 in FIG. 1, and controls C-plane traffic. Moreover, it is assumed that the network nodes 21 in the network 20 are radio base stations and mobile terminals. Hereinafter, a mobile network according to the present exemplary embodiment will be described with reference to FIGS. 5 to 12. Note that the following signs will be used as appropriate to represent functions.
UE: User Equipment (mobile terminal)
eNB: enhanced NodeB (radio base station)
S-GW: Serving Gateway (serving gateway)
P-GW: Packet data network Gateway (PDN gateway)
MME: Mobility Management Entity (mobility management node)
SGSN: Serving General packet radio service Support Node (packet radio service support node)

### 2.1) System Architecture

Referring to FIG. 5, a system will be considered that includes a core network 101, which is connected to an external packet data network, and a radio access network 102. In the example shown in FIG. 5, a mobility management node 103 in the core network 101 corresponds to the C-plane processing node 22 in FIG. 1. That is, the mobility management node 103 collects C-plane traffic data from radio base stations 104 in the radio access network 102, extracts a traffic feature from the collected traffic data, and determines a control parameter of the radio base stations 104 (hereinafter, referred to as “base station parameter”) based on the extracted traffic feature, thereby controlling the plurality of radio base stations 104 in the radio access network 102. The traffic data can be acquired at the egress/ingress of an IPsec tunnel configured between the mobility management mode 103 and each radio base station 104, i.e., by the mobility management node 103 or each radio base station 104. However, since it is impossible to acquire packets themselves because of security restrictions, it is preferable that the feature be calculated at the level of radio base stations 104 and then sent.

The targets from which traffic data is to be collected may be all base stations, but also may be part of the base stations sampled at random or by design. Moreover, since ways of using terminals can vary with user properties, it is also possible that the base stations are classified based on the number of users per base station, population statistical information (gender and age imbalance in each region), or the like as an index, and targets for collection are selected from each class at random such that they agree with the proportions of the classes in distribution.

### 2.2) First Example

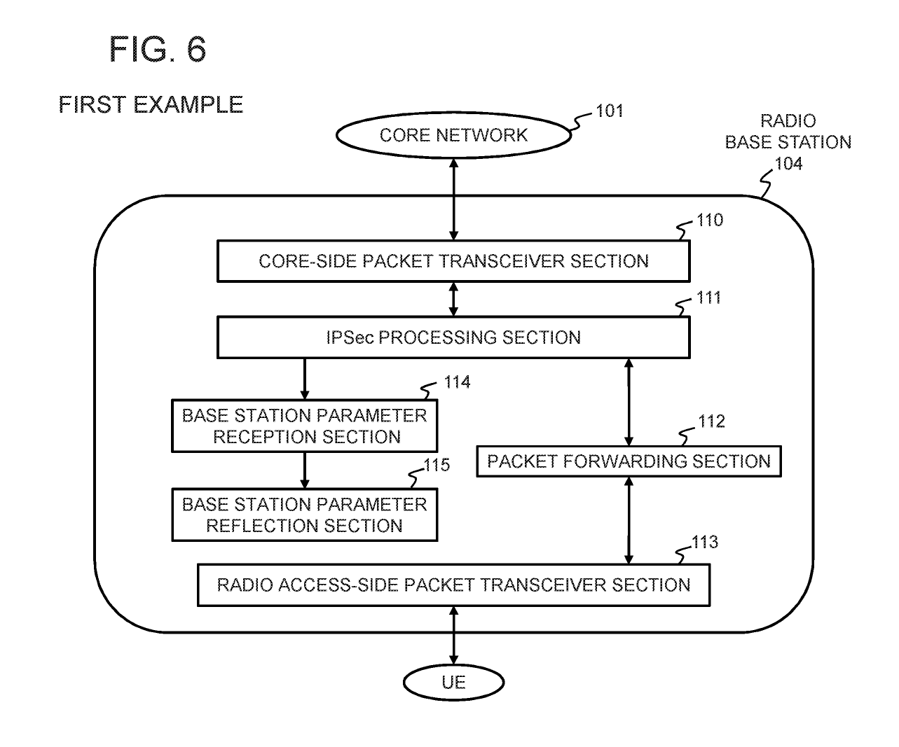

In a first example of the system according to the present exemplary embodiment, the mobility management node 103 has a function of knowing a parameter (the maximum packet throughput or the like) of its own node. Hereinafter, the more detailed architecture and functions of the system according to the first example will be described with reference to FIGS. 6 to 9.

### <System Architecture>

Referring to FIG. 6, a core-side packet transceiver section 110 of the radio base station 104 sends and receives packets to/from the core network 101, and an IPsec processing section 111 terminates an IPsec protocol on the core side. Packets from mobile terminals UE or packets addressed to mobile terminals UE are received from or sent to the mobile terminals UE under control via a packet forwarding section 112 and a radio access-side packet transceiver section 113. A base station parameter reception section 114 receives a base station parameter from the core network 101, and the parameter is set by a base station parameter reflection section 115. Note that these functional configurations can be also implemented by executing programs on a processor (not shown) of the radio base station 104.

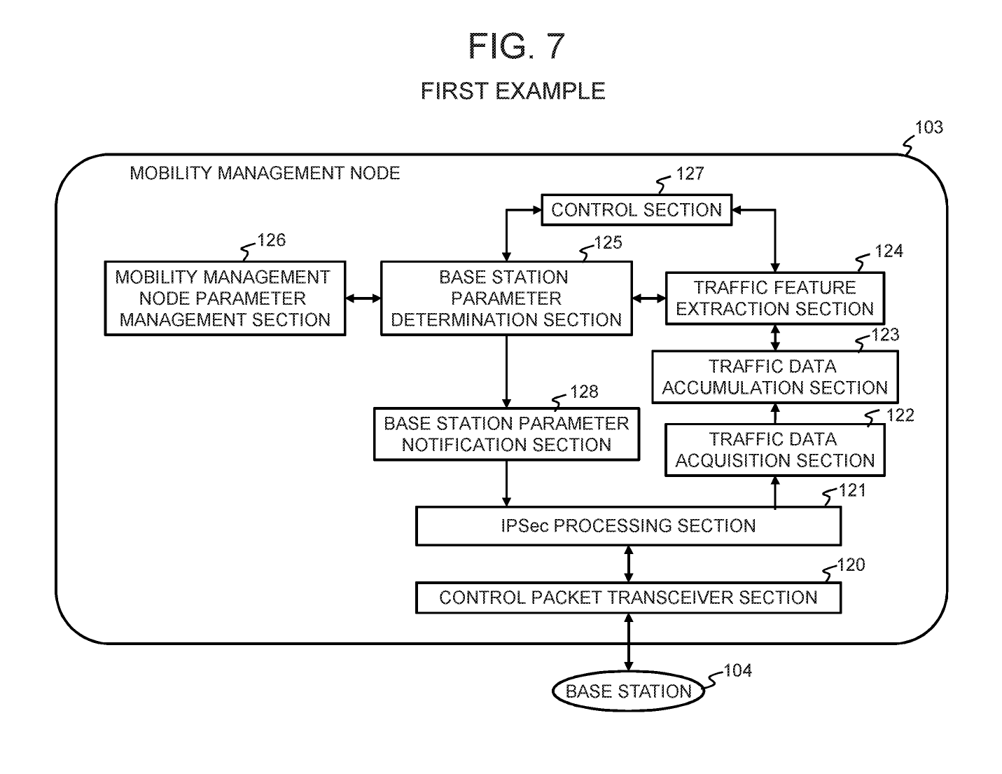

Referring to FIG. 7, a control packet transceiver section 120 of the mobility management node 103 sends and receives control packets to/from radio base stations 104 under control, and an IPsec processing section 121 terminates an IPsec protocol on the base station side. A traffic data acquisition section 122 acquires traffic data from the base stations under management, and a traffic data accumulation section 123 accumulates the acquired traffic data. A traffic feature extraction section 124 extracts a traffic feature from the accumulated traffic data. A base station parameter determination section 125 determines a base station parameter by using the extracted traffic feature and a mobility management node parameter such as C-plane packet throughput, which is managed by a mobility management node parameter management section 126. The operations of the traffic feature extraction section 124 and base station parameter determination section 125 are controlled by a control section 127. A base station parameter notification section 128 notifies the determined base station parameter to all base stations under control, or one or some specified base stations, via the IPsec processing section 121 and control packet transceiver section 120. Note that these functional configurations can be also implemented by executing programs on a processor (not shown) of the mobility management node 103.

### <Operation>

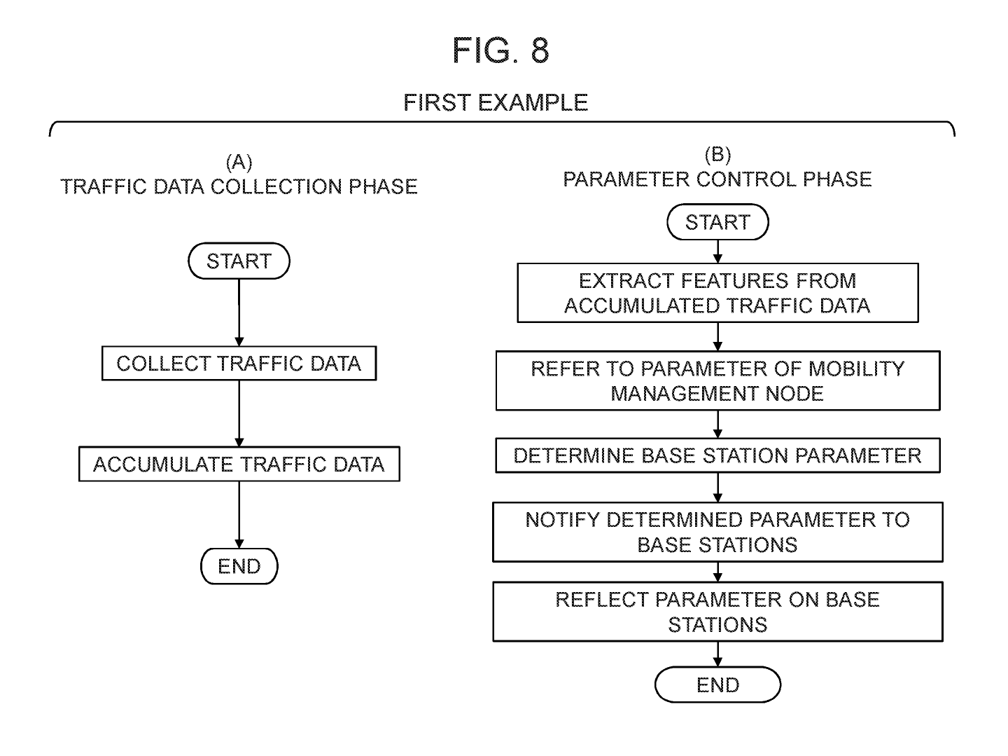

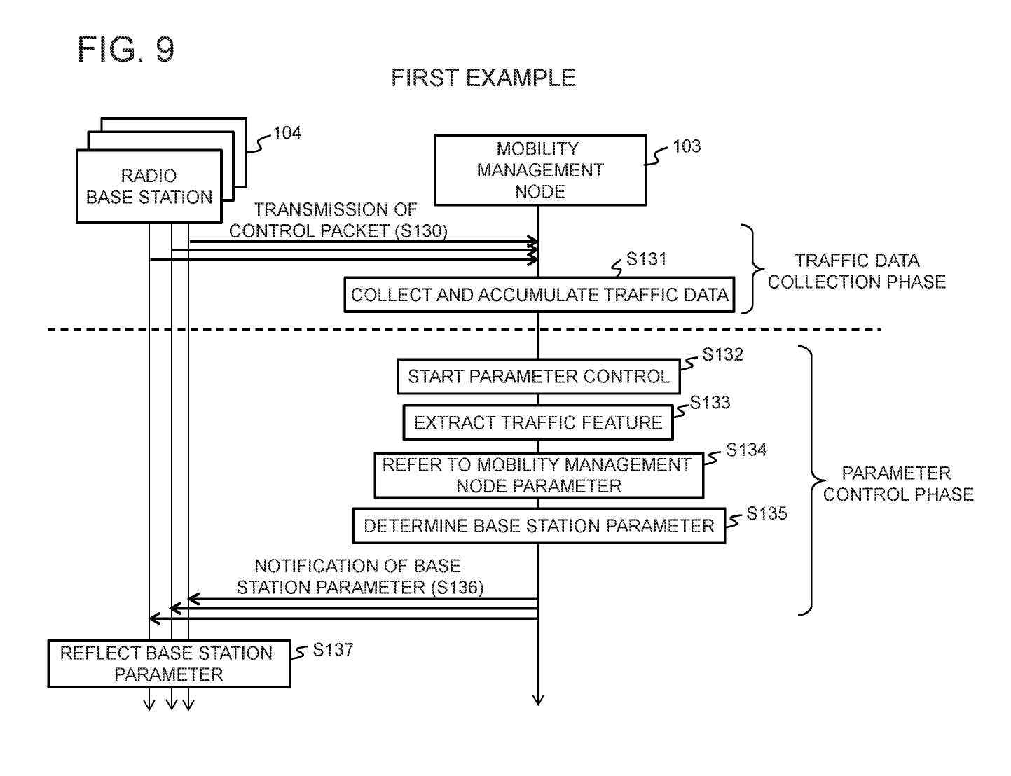

As shown in FIG. 8, Operation according to the first example of the present exemplary embodiment includes a traffic data collection phase and a parameter control phase. Hereinafter, the traffic data collection phase and parameter control phase will be described in detail with reference to FIG. 9. However, the traffic data collection phase and parameter control phase can be operated independently of each other, and it is also possible that while traffic data is collected, parameter control is performed in parallel every time data is accumulated. Real-time control can be achieved, in particular, by making time taken to transition from the completion of the traffic data collection phase to the parameter control phase as null as possible.

In the traffic data collection phase shown in FIG. 9, it is assumed that the mobility management node 103 has received control packets from radio base stations 104 in the radio access network 102 (Operation S130). The traffic data acquisition section 122 of the mobility management node 103 collects traffic data from the plurality of radio base stations 104 and accumulates it in the traffic data accumulation section 123 (Operation S131).

In the parameter control phase shown in FIG. 9, after the traffic data from the plurality of radio base stations 104 included in the radio access network 102 has been accumulated, the control section 127 starts parameter control at an arbitrary timing (Operation S132). First, the traffic feature extraction section 124 extracts a traffic feature from the accumulated traffic data (Operation S133), and the base station parameter determination section 125 refers to the mobility management node parameter of the mobility management node parameter management section 126 (Operation S134) and determines a base station parameter (Operation S135). For example, a base station parameter is determined such that the C-plane packet arrival rate or the simultaneous arrival rate in the entire network will be lowered as this arrival rate/simultaneous arrival rate becomes closer to the throughput of the mobility management node 103. The determined base station parameter is notified to all base stations under control, or one or some specified base stations, via the IPsec processing section 121 and control packet transceiver section 120 (Operation S136).

At the radio base stations 104, when the base station parameter reception section 114 receives the base station parameter, the base station parameter reflection section 115 sets the notified base station parameter (Operation S137). Thus, the radio base stations 104 are controlled in accordance with the notified control parameter. For example, if the inactivity timer value is changed with the base station parameter, a radio resource is released in accordance with the changed inactivity timer value, so that the C-plane packet occurrence rate/arrival rate is adjusted in the entire network or part thereof, resulting in the reduced load on the mobility management node 103. Alternatively, if the back-off timer value is changed with the base station parameter, the next occurrence timing is adjusted when a C-plane packet of a radio base station 104 is rejected in accordance with the changed back-off timer value. Accordingly, the timings of processing a C-plane packet are distributed in the enter network or part thereof, and the load on the mobility management node 103 is reduced.

### 2.3) Second Example

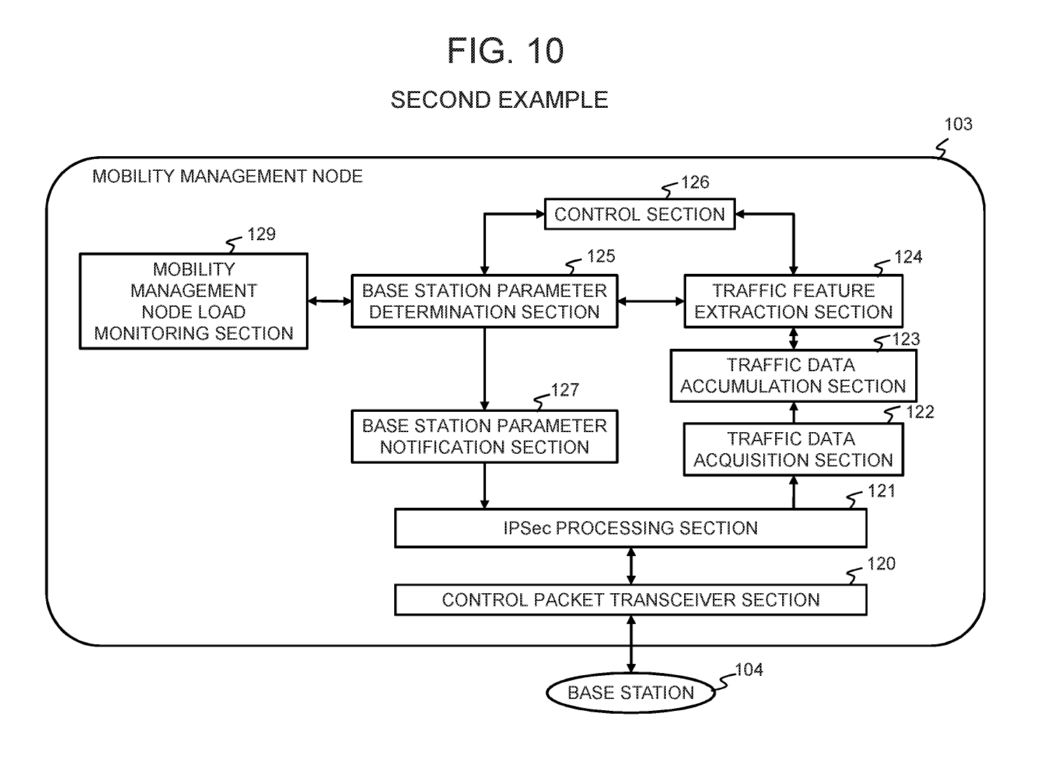

In a second example of the system according to the present exemplary embodiment, the mobility management node 103 has a function of monitoring the load status of its own node in real time. Hereinafter, the concrete architecture and functions of the system according to the second example will be described with reference to FIGS. 10 to 12.

### <System Architecture>

The configuration of the radio base station 104 is similar to that of the first example shown in FIG. 6, and therefore a description thereof will be omitted.

As shown in FIG. 10, the mobility management node 103 has a configuration and functions similar to those of the first example shown in FIG. 1 except that the mobility management node parameter management section 126 is replaced with a mobility management node load monitoring section 129, and therefore a description thereof will be omitted.

### <Operation>

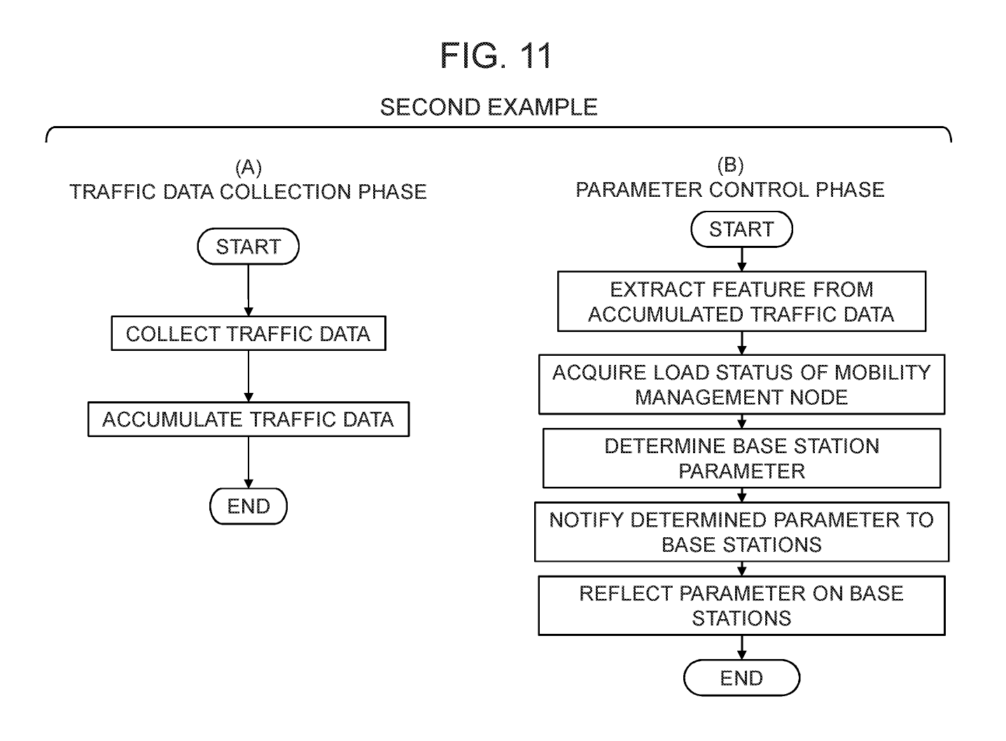

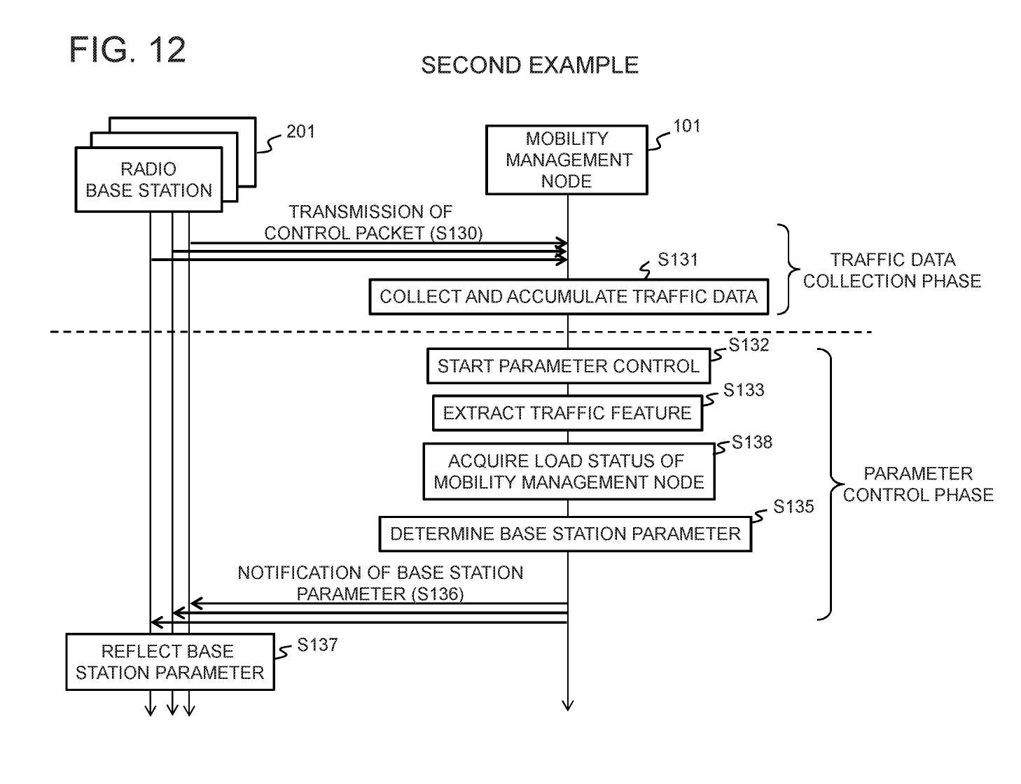

As shown in FIG. 11, operation according to the second example of the present exemplary embodiment includes a traffic data collection phase and a parameter control phase. Hereinafter, with reference to FIG. 12, the traffic data collection phase and parameter control phase will be described in detail. However, the same operations as in the first example shown in FIG. 9 are given the same reference signs, and a description will be given only of Operation S138 for acquiring mobility management node load status, which is different from the first example.

The mobility management node load monitoring section 129 of the mobility management node 103 monitors the load status of its own node and retains information indicating the load status. As described above, after Operations S130 to S133, the base station parameter determination section 125 acquires the mobility management node load status monitored by the mobility management node load monitoring section 129 along with the traffic feature (Operation S138) and determines a base station parameter (Operation S135). For example, a base station parameter is determined such that the C-plane packet arrival rate in the entire network or the simultaneous arrival rate will be lowered as the mobility management node 103 approaches its maximum throughput. Operations S136 and 137 thereafter are as described in the first example.

### 2.4) Effects

As described above, according to the second exemplary embodiment of the present invention, a parameter (inactivity timer value, restriction rate, back-off timer value, or the like) of radio base stations 104 is determined based on a traffic feature (C-packet occurrence rate, simultaneous arrival rate, periodic interval, phase, phase shift, or the like) in the radio access network 102. Thus, it is possible to achieve an effective load reduction of the mobility management node, overviewing the entire network. Further, it is possible to perform adequate parameter control on base stations even in the face of a failure of network equipment and a change in the status of the network such as congestion.

### 3. Third Exemplary Embodiment

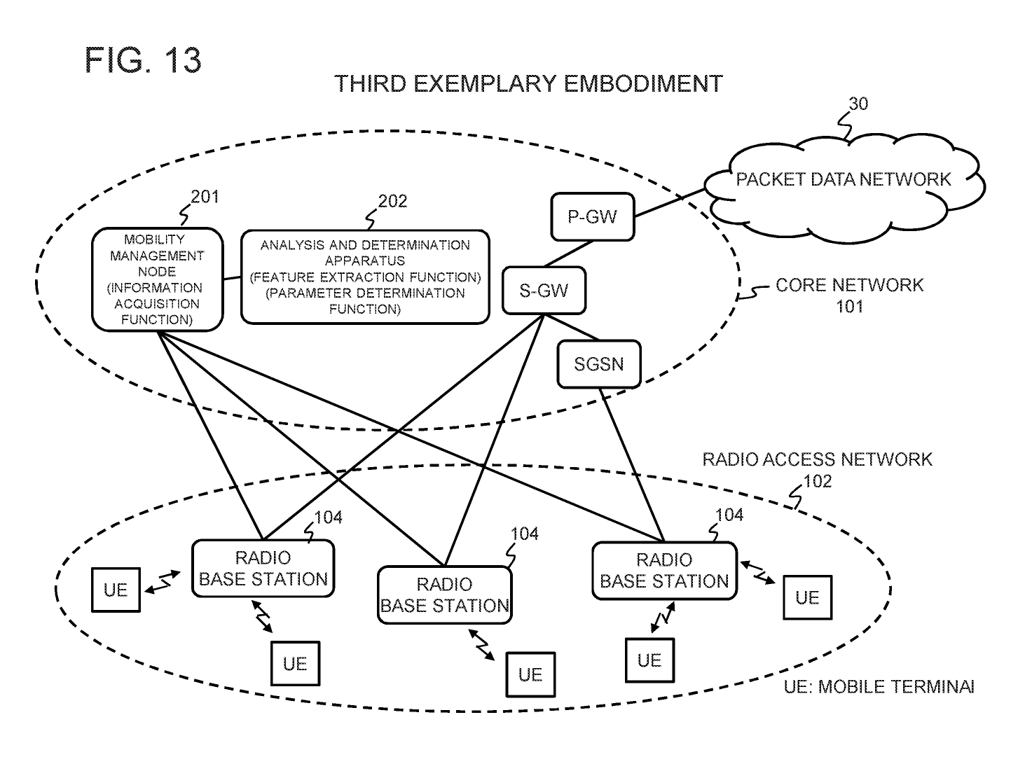

In a third exemplary embodiment of the present invention, the traffic data collection function 11 is provided to a mobility management node in a mobile network, and the traffic feature extraction function 12 and base station parameter determination function 13 are provided to another apparatus (an analysis and determination apparatus). The mobility management node sets a determined parameter on each radio base station, thereby controlling C-plane traffic. Moreover, it is assumed that the communication nodes 21 in the network 20 are radio base stations and mobile terminals as in the second exemplary embodiment. Hereinafter, a mobile network according to the present exemplary embodiment will be described with reference to FIGS. 13 to 17.

### 3.1) System Architecture

Referring to FIG. 13, it is assumed that the basic architecture of the network according to the present exemplary embodiment is similar to that of the second exemplary embodiment, and includes a core network 101 and a radio access network 102. However, an analysis and determination apparatus 202 is provided separately from a mobility management node 201 in the core network 101. The mobility management node 201 has a function of collecting C-plane traffic data from radio base stations 104 in the radio access network 102, and the analysis and determination apparatus 202 has functions of extracting a traffic feature from the collected traffic data and determining a base station parameter of the radio base stations 104 based on the extracted traffic feature. The mobility management node 201 sets the base station parameter determined by the analysis and determination apparatus 202 on the plurality of radio base stations 104 in the radio access network 102. The other architecture and functions, as well as the targets from which traffic data is to be collected, are similar to those of the second exemplary embodiment, and therefore a description thereof will be omitted, using the same reference signs. Moreover, the configuration of the radio base station 104 is also similar to that of the second exemplary embodiment shown in FIG. 6, and therefore a description thereof will be omitted.

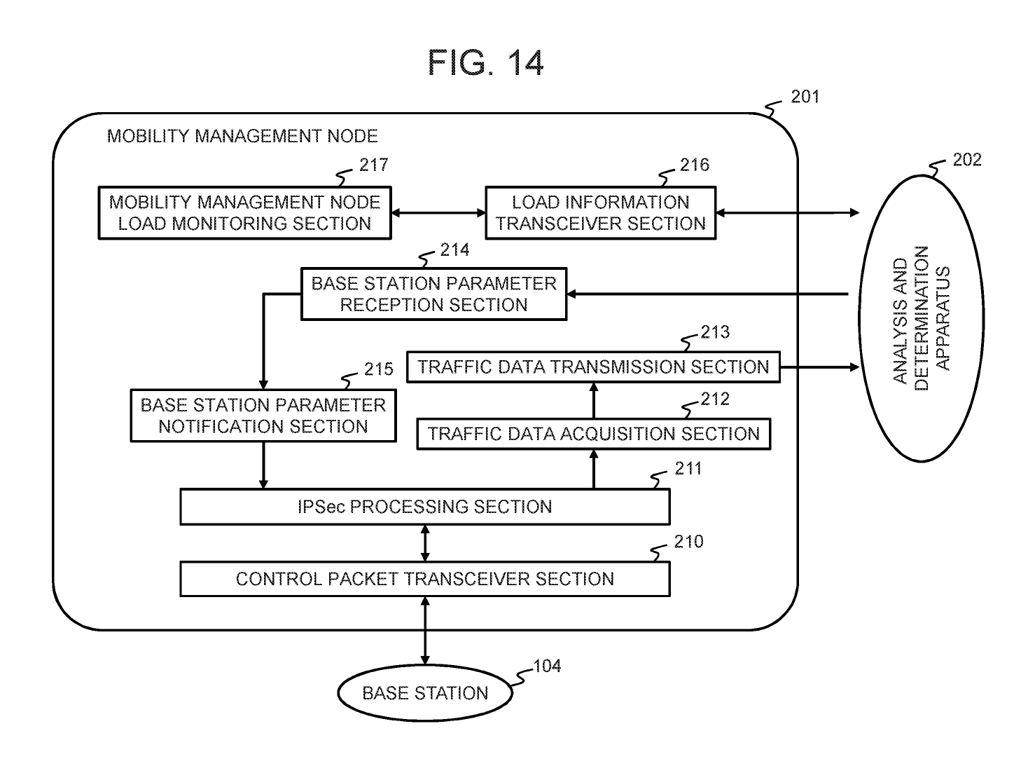

Referring to FIG. 14, a control packet transceiver section 210 of the mobility management node 201 sends and receives control packets to/from radio base stations 104 under control, and an IPsec processing section 211 terminates an IPsec protocol on the base station side. A traffic data acquisition section 212 acquires traffic data from the base stations under management, and a traffic data transmission section 213 sends the acquired traffic data to the analysis and determination apparatus 202. When a base station parameter reception section 214 receives a base station parameter corresponding to the traffic data sent by the traffic data transmission section 213 from the analysis and determination apparatus 202, a base station parameter notification section 215 notifies the base station parameter to all base stations under control, or one or some specified base stations, via the IPsec processing section 211 and control packet transceiver section 210. Moreover, a load information transceiver section 216 sends information indicating the load status of its own node, which is retained by a mobility management node load monitoring section 217, to the analysis and determination apparatus 202 in accordance with a request from the analysis and determination apparatus 202. Note that these functional configurations can be also implemented by executing programs on a processor (not shown) of the mobility management node 201.

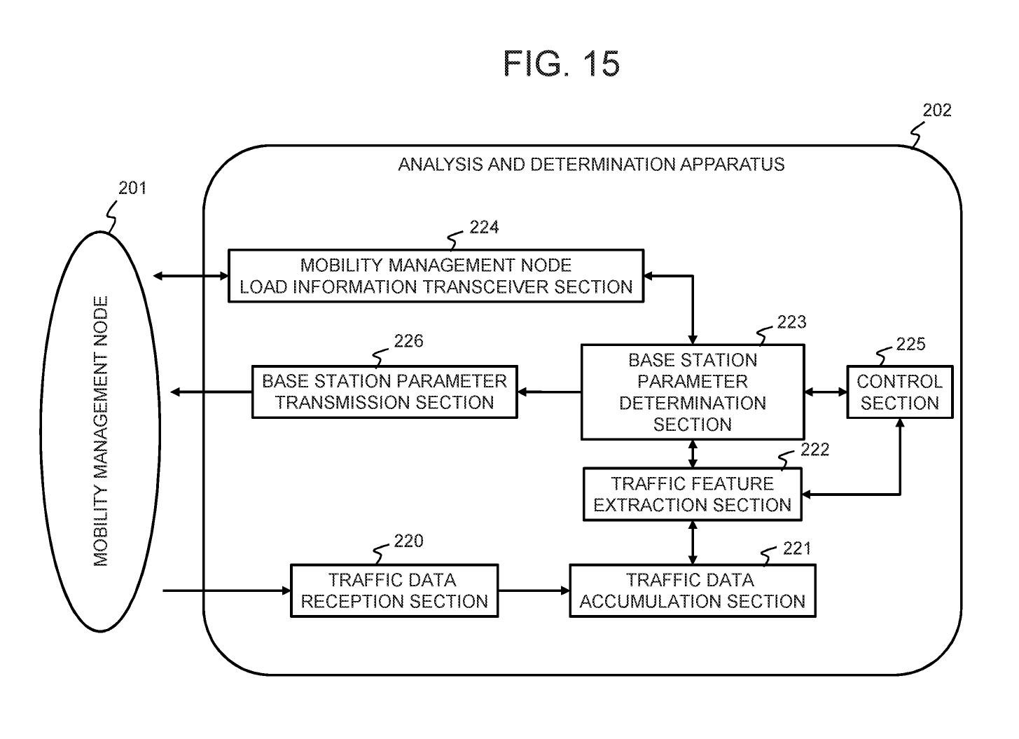

Referring to FIG. 15, a traffic data reception section 220 of the analysis and determination apparatus 202 receives traffic data from the mobility management node 201 and accumulates it in a traffic data accumulation section 221. A traffic feature extraction section 222 extracts a traffic feature from the accumulated traffic data. A base station parameter determination section 223 determines a base station parameter by using the extracted traffic feature and motility management node load information, which is received from the mobility management node 201 via a mobility management node load information transceiver section 225. The operations of the traffic characteristic extraction section 222 and base station parameter determination section 223 are controlled by a control section 225. A base station parameter notification section 226 sends the determined base station parameter to the mobility management node 201. Note that these functional configurations can be also implemented by executing programs on a processor (not shown) of the analysis and determination apparatus 202.

### 3.2) Operation

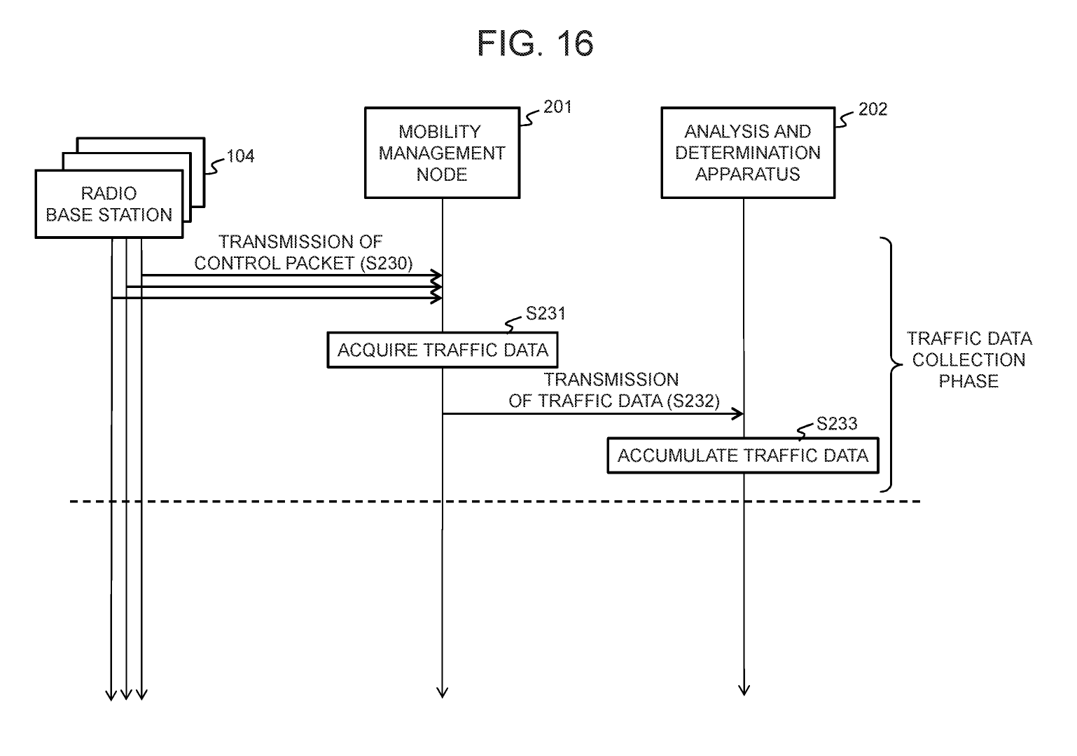

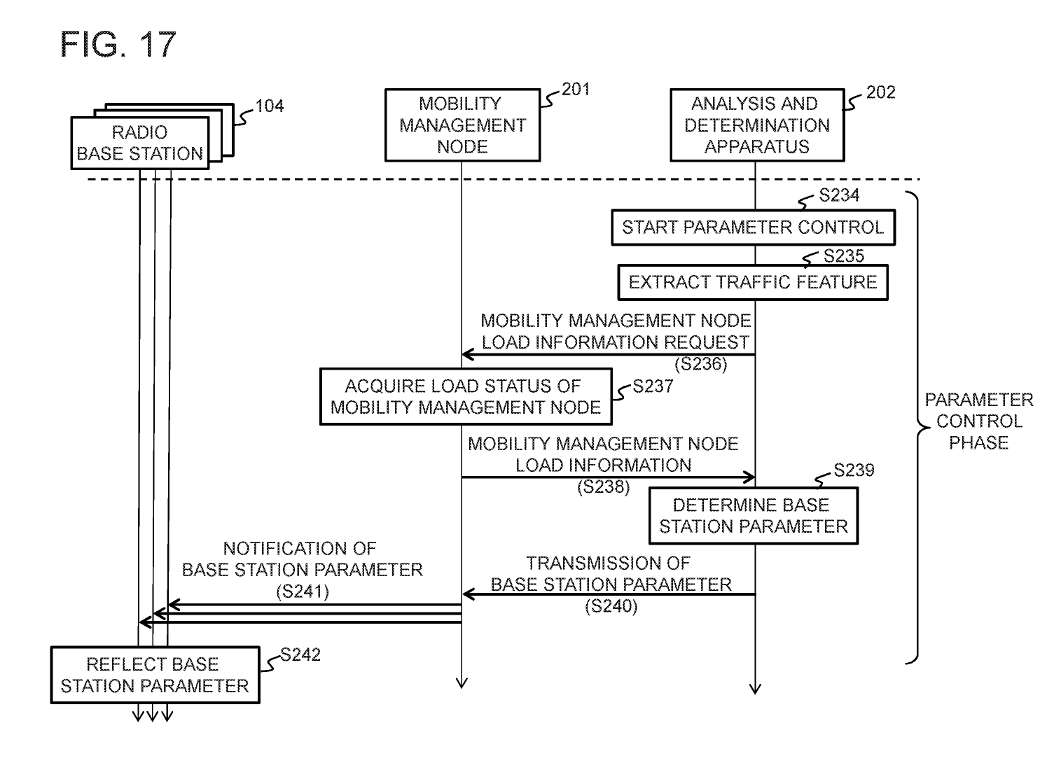

Hereinafter, a traffic data collection phase and a parameter control phase will be individually described in detail with reference to FIGS. 16 and 17. The traffic data collection phase and parameter control phase can be operated independently of each other.

In the traffic data collection phase shown in FIG. 16, it is assumed that the mobility management node 201 has received control packets from radio base stations 104 in the radio access network 102 (Operation S230). The traffic data acquisition section 212 of the mobility management node 201 collects traffic data from the plurality of radio base stations 104 (Operation S231) and sends it to the analysis and determination apparatus 202 via the traffic data transmission section 213 (Operation S232). At the analysis and determination apparatus 202, when receiving the traffic data from the mobility management node 201, the traffic data reception section 220 accumulates the received traffic data in the traffic data accumulation section 221 (Operation S233).

In the parameter control phase shown in FIG. 17, after the traffic data has been accumulated in the traffic data accumulation section 221, the control section 225 starts parameter control at an arbitrary timing (Operation S234). First, the traffic feature extraction section 222 extracts a traffic feature from the accumulated traffic data (Operation S235), and then the control section 225 controls the base station parameter determination section 223 to send a mobility management node load information request to the mobility management node 201 via the mobility management node load information transceiver section 224 (Operation S236).

When receiving the mobility management node load information request from the analysis and determination apparatus 202, the load information transceiver section 216 of the mobility management node 201 acquires information about the load status of its own node from the mobility management node load monitoring section 217 (Operation S237) and sends it to the analysis and determination apparatus 202 (Operation S238).

The base station parameter determination section 223 of the analysis and determination apparatus 202 determines a base station parameter by using the mobility management node load information received via the mobility management node load information transceiver section 224 and the traffic feature extracted by the traffic feature extraction section 222 (Operation S239). The determined base station parameter is sent to the mobility management node 201 via the base station parameter transmission section 226 (Operation S240).

When receiving the base station parameter from the analysis and determination apparatus 202 via the base station parameter reception section 214 of the mobility management node 201, the base station parameter notification section 215 notifies the base station parameter to all base stations under control, or one or some specified base stations, via the IPsec processing section 211 and control packet transceiver section 210 (Operation S241). The radio base stations 104 operates, reflecting the received base station parameter (Operation S242).

### 3.3) Effects

As described above, according to the third exemplary embodiment of the present invention, since the analysis and determination function of the mobility management node in the above-described second exemplary embodiment is provided externally, it is possible to distribute the calculation load related to traffic data analysis and parameter determination and the storage capacity for accumulating traffic data. Thus, it is possible to achieve an effective load reduction of the mobility management node overviewing the entire network as in the second exemplary embodiment, without reinforcing the throughput of the mobility management node.

### 4. Fourth Exemplary Embodiment

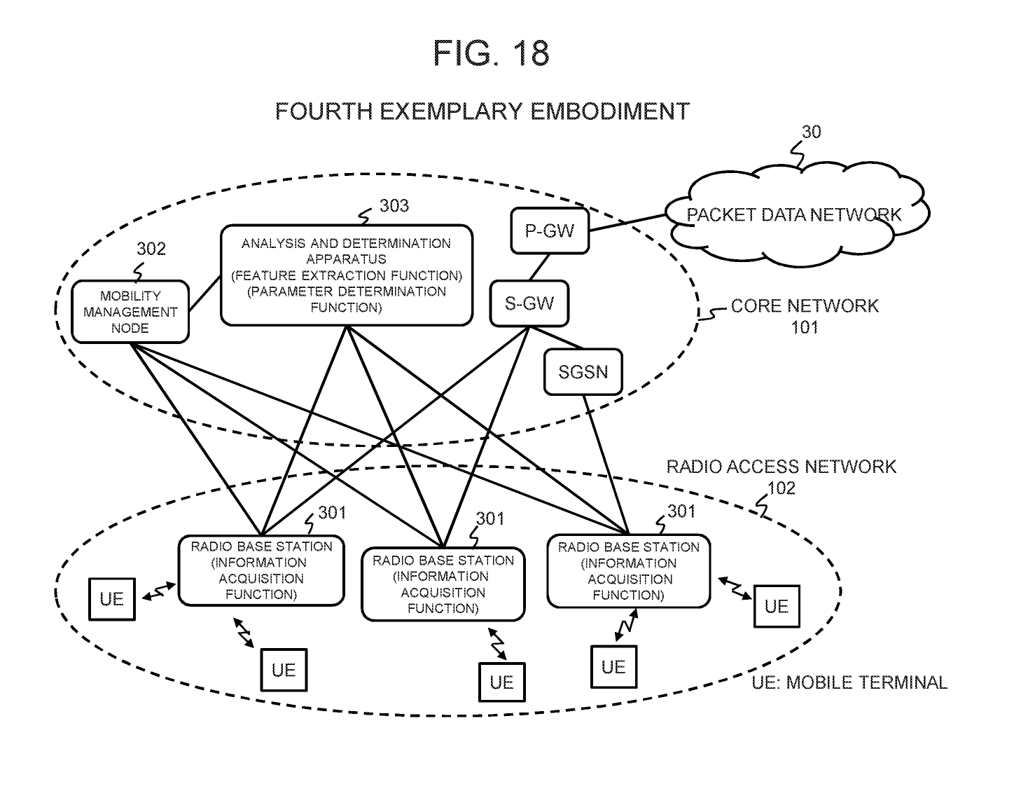

In a fourth exemplary embodiment of the present invention, the traffic data collection function 11 is provided to radio base stations in the radio access network 102, and the traffic feature extraction function 12 and base station parameter determination function 13 are provided to a management apparatus that is different from a mobility management node. Further, according to the present exemplary embodiment, the management apparatus can directly collect C-plane and/or U-plane traffic data from each radio base station and also can directly set a base station parameter on each radio base station, whereby it is possible to suppress changes ordinarily made by a mobility management node. Hereinafter, a mobile network according to the present exemplary embodiment will be described with reference to FIGS. 18 to 21.

### 4.1) System Architecture

Referring to FIG. 18, the network according to the present exemplary embodiment includes a core network 101 and a radio access network 102, wherein radio base stations 301 in the radio access network 102 are provided with a function of acquiring C-plane and U-plane traffic data, and an analysis and determination apparatus 303 as a management apparatus is provided separately from a mobility management node 302 in the core network 101.

The analysis and determination apparatus 303 has functions of extracting a traffic feature from traffic data acquired by the radio base stations 301, determining a base station parameter of the radio base stations 301 based on the extracted traffic feature, and directly setting it on each radio base station 301. The analysis and determination apparatus 303 can be also implemented on, for example, a SON (Self-Organizing Network) server. The mobility management node 302 only needs to have a function of notifying load monitoring information to the analysis and determination apparatus 303, which will be described later, apart from the ordinary mobility management functionality. The other architecture and functions, as well as the targets from which traffic data is to be collected, are similar to those of the second and third exemplary embodiments, and therefore a description thereof will be omitted, using the same reference signs.

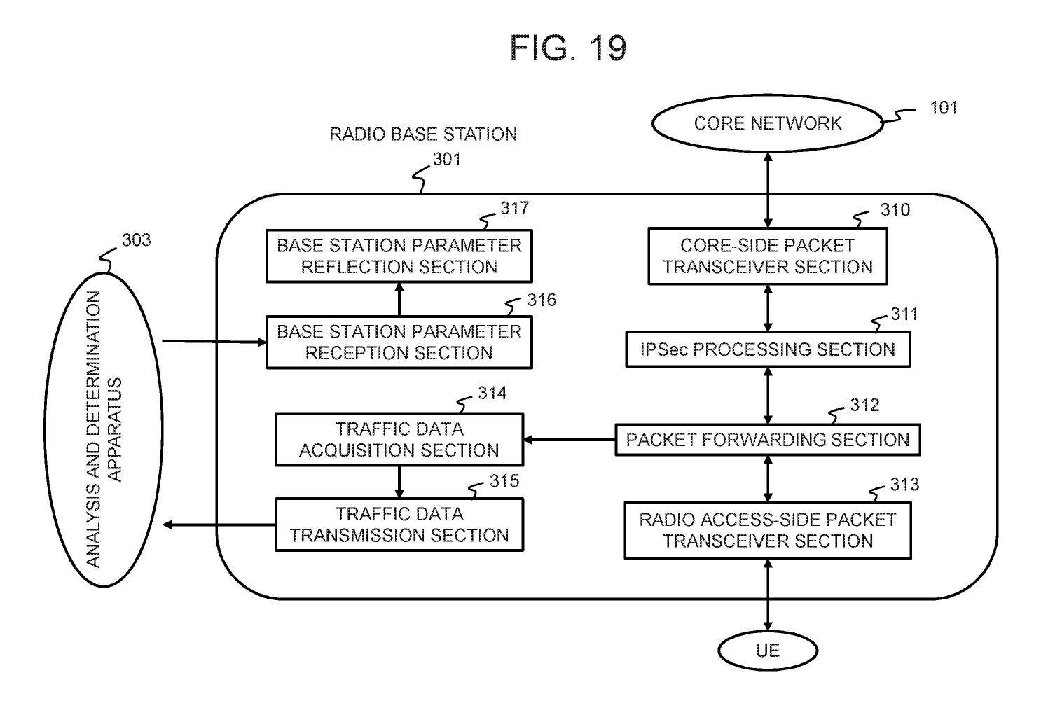

Referring to FIG. 19, a core-side packet transceiver section 310 of the radio base station 301 sends and receives packets to/from the core network 101, and an IPsec processing section 311 terminates an IPsec protocol on the core side. Packets from mobile terminals UE or packets addressed to mobile terminals UE are received from or sent to the mobile terminals UE under control via a packet forwarding section 312 and a radio access-side packet transceiver section 313. Moreover, a traffic data acquisition section 314 acquires traffic data from the packet forwarding section 312 and sends it to the analysis and determination apparatus 303 via a traffic data transmission section 315. A base station parameter reception section 316 receives a base station parameter from the analysis and determination apparatus 303, and a base station parameter reflection section 317 sets the base station parameter. Note that these functional configurations can be also implemented by executing programs on a processor (not shown) of the radio base station 301.

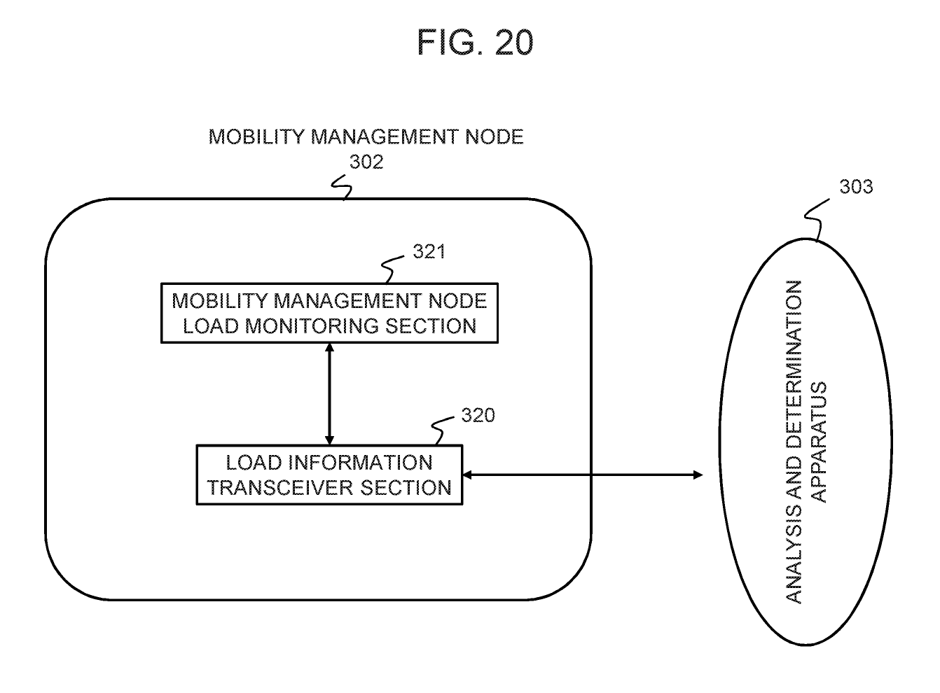

Referring to FIG. 20, the mobility management node 302 includes a load information transceiver section 320 and a mobility management node load monitoring section 321, apart from the ordinary mobility management functionality. In accordance with a request from the analysis and determination apparatus 303, the load information transceiver section 320 acquires information indicating the load status of its own node from the mobility management node load monitoring section 321, and sends it to the analysis and determination apparatus 303.

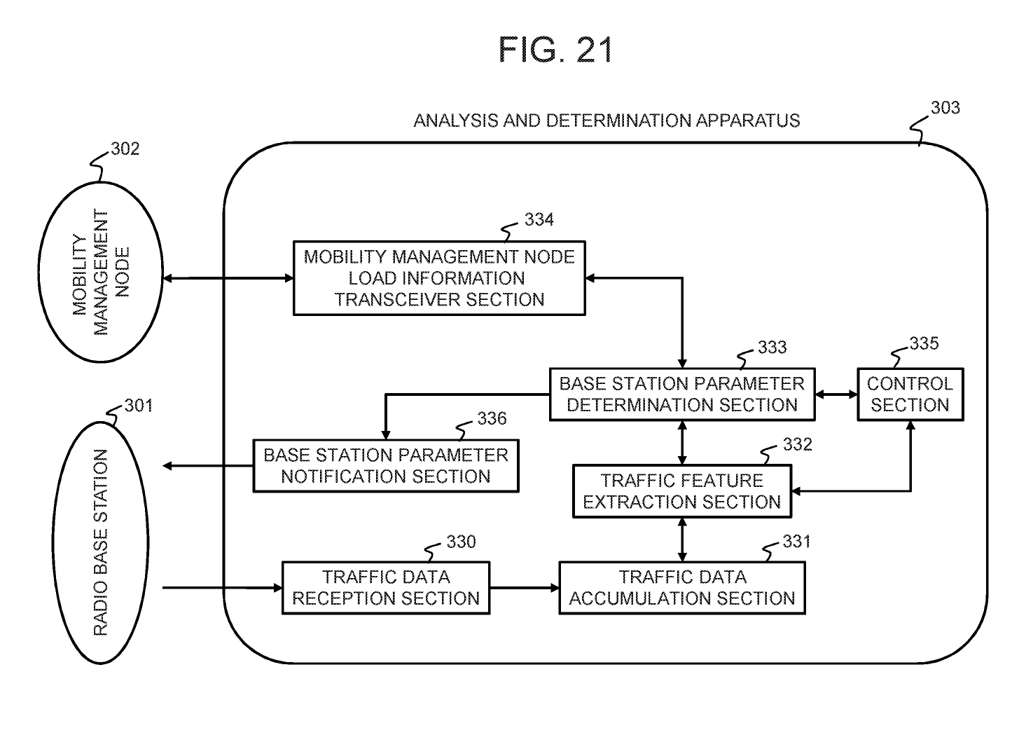

Referring to FIG. 21, a traffic data reception section 330 of the analysis and determination apparatus 303 receives traffic data from the radio base stations 301 and accumulates it in a traffic data accumulation section 331. A traffic feature extraction section 332 extracts a traffic feature from the accumulated traffic data. A base station parameter determination section 333 determines a base station parameter by using the extracted traffic feature and mobility management node load information, which is received from the mobility management node 302 via a mobility management node load information transceiver section 334. The operations of the traffic feature extraction section 332 and base station parameter determination section 333 are controlled by a control section 335. A base station parameter notification section 336 sends the determined base station parameter to the radio base station 301.

### 4.2) Operation

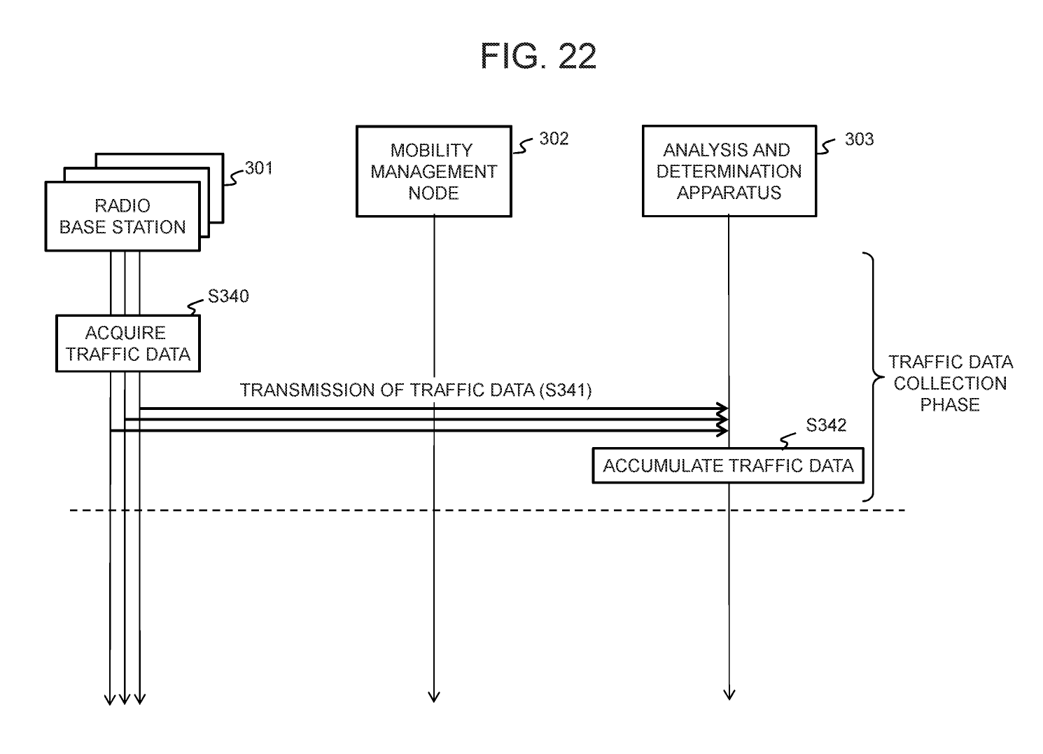

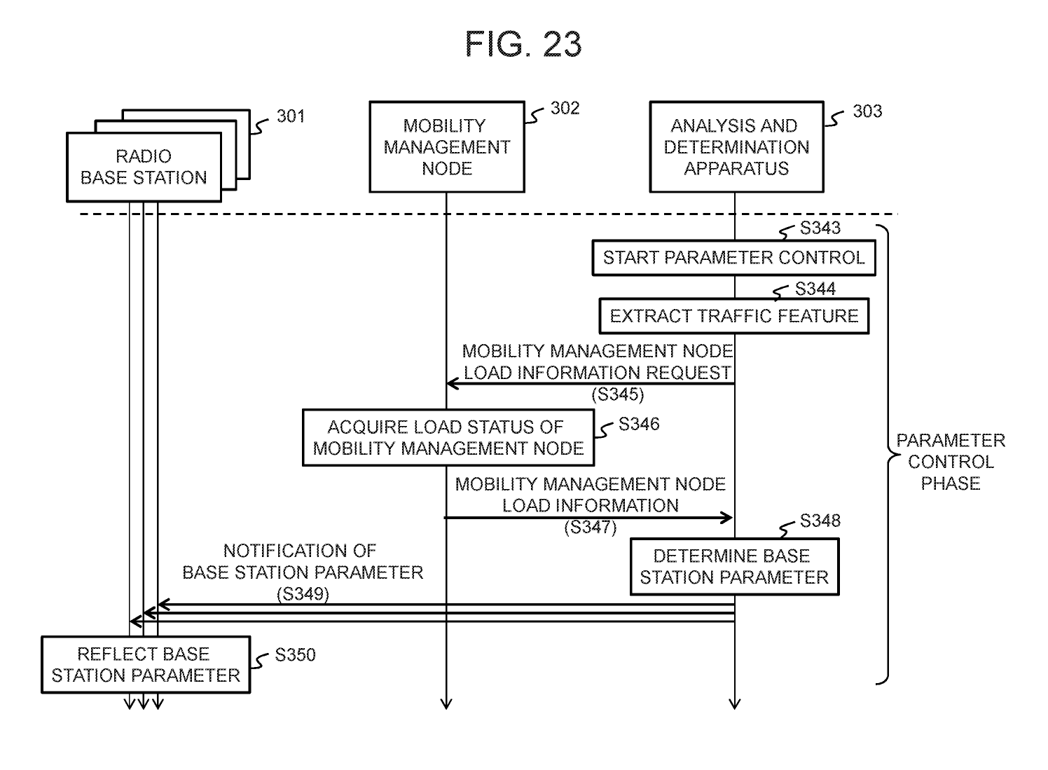

Hereinafter, a traffic data collection phase and a parameter control phase will be individually described in detail with reference to FIGS. 22 and 23. The traffic data collection phase and parameter control phase can be operated independently of each other.

In the traffic data collection phase shown in FIG. 22, it is assumed that the radio base stations 301 have acquired traffic data (Operation S340) and have sent it to the analysis and determination apparatus 303 (Operation S341). The traffic data reception section 330 of the analysis and determination apparatus 303 collects the traffic data from the plurality of radio base stations 301 and accumulates it in the traffic data accumulation section 331 (Operation S342).

In the parameter control phase shown in FIG. 23, after the traffic data is accumulated in the traffic data accumulation section 331, the control section 335 starts parameter control at an arbitrary timing (Operation S343). First, the traffic feature extraction section 332 extracts a traffic feature from the accumulated traffic data (Operation S344), and then the control section 335 controls the base station parameter determination section 333 to send a mobility management node load information request to the mobility management node 302 via the mobility management node load information transceiver section 334 (Operation S345).

When receiving the mobility management node load information request from the analysis and determination apparatus 303, the load information transceiver section 320 of the mobility management node 302 acquires information about the load status of its own node from the mobility management node load monitoring section 321 (Operation S346) and sends it to the analysis and determination apparatus 303 (Operation S347).

The base station parameter determination section 333 of the analysis and determination apparatus 303 determines a base station parameter by using the mobility management node load information received via the mobility management node load information transceiver section 334 and the traffic feature extracted by the traffic feature extraction section 332 (Operation S348). The determined base station parameter is sent to the radio base station 301 via the base station parameter transmission section 336 (Operation S349). The radio base stations 301 operate, reflecting the received base station parameter (Operation S350).

### 4.3) Effects

As described above, according to the fourth exemplary embodiment of the present invention, the analysis and determination apparatus 303 is provided externally as in the above-described third exemplary embodiment, and the analysis and determination apparatus 303 directly sets a control parameter on the radio base stations 301. Accordingly, it is possible to distribute the processing load further than the second exemplary embodiment. It is possible to distribute the calculation load related to traffic data analysis and parameter determination and the storage capacity for accumulating traffic data. Thus, it is possible to achieve an effective mobility management node load reduction overviewing the entire network as in the second exemplary embodiment, without reinforcing the throughput of the mobility management node. Further, since traffic data is acquired by the radio base stations 301, U-plane traffic information can be also acquired, making it possible to increase information that can be used in control.

### 5. Fifth Exemplary Embodiment

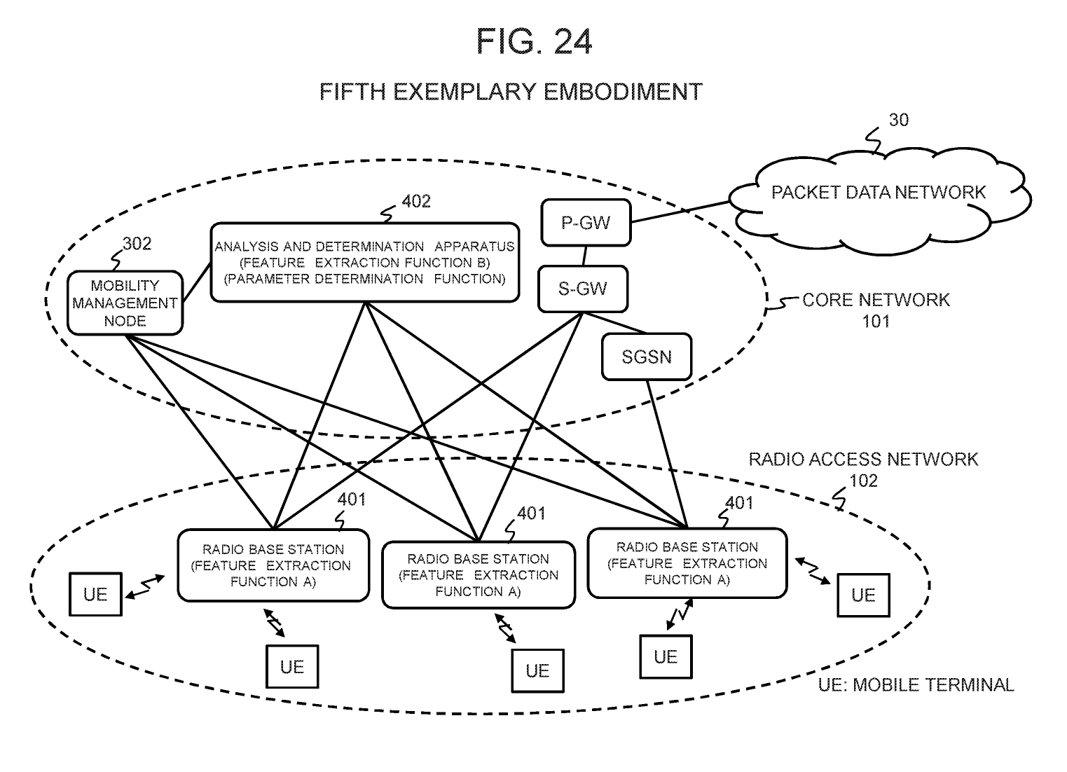

According to a fifth exemplary embodiment of the present invention, the traffic feature extraction function 12 is hierarchized, and lower-level traffic features are collected from a plurality of base stations, and then a traffic feature of the entire network is extracted. That is, a base station is provided with the traffic data collection function 11 and a lower-level traffic feature extraction function 12a, and a management apparatus is provided with a higher-level traffic feature extraction function 12b and the base station parameter determination function 13. At each radio base station, a local traffic feature is extracted from C/U-plane traffic data, and the traffic feature, not the traffic data, is sent to the management apparatus. Accordingly, it is possible to reduce traffic volumes sent to the management apparatus. Hereinafter, a mobile network according to the present exemplary embodiment will be described with reference to FIGS. 24 to 28.

### 5.1) System Architecture

Referring to FIG. 24, the network according to the present exemplary embodiment includes a core network 101 and a radio access network 102. Radio base stations 401 in the radio access network 102 are provided with a function of acquiring C-plane and U-plane traffic data and a function A of extracting a local traffic feature from the traffic data. Moreover, an analysis and determination apparatus 402 as a management apparatus is provided separately from a mobility management node 302 in the core network 101.

The analysis and determination apparatus 402 has a function B of collecting the local traffic features received from the radio base stations 401 and extracting a traffic feature of the entire network, and further has a function of determining a base station parameter of the radio base stations 401 based on the extracted traffic feature and a function of directly setting it on each radio base station 401. The analysis and determination apparatus 402 can be also implemented on, for example, a SON (Self-Organizing Network) server. The mobility management node 302 only needs to have a function of notifying load monitoring information to the analysis and determination apparatus 402, which will be described later, apart from the ordinary mobility management functionality. The other architecture and functions, as well as the targets from which traffic data is to be collected, are similar to those of the fourth exemplary embodiment, and therefore a description thereof will be omitted, using the same reference signs.

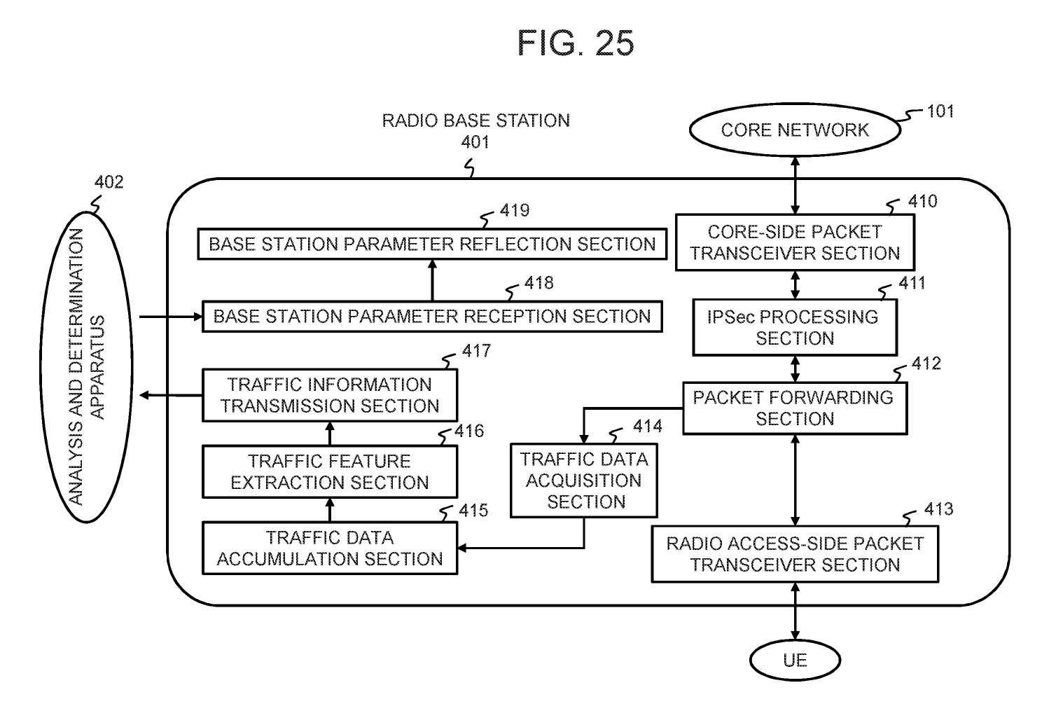

Referring to FIG. 25, a core-side packet transceiver section 410 of the radio base station 401 sends and receives packets to/from the core network 101, and an IPsec processing section 411 terminates an IPsec protocol on the core side. Packets from mobile terminals UE or packets addressed to mobile terminals UE are received from or sent to the mobile terminals UE under control via a packet forwarding section 412 and a radio access-side packet transceiver section 413. Moreover, a traffic data acquisition section 414 acquires traffic data from the packet forwarding section 412 and accumulates it in a traffic data accumulation section 415. A traffic feature extraction section 416 extracts a local traffic feature as traffic information from the accumulated traffic data and sends it to the analysis and determination apparatus 402 via a traffic information transmission section 417. The traffic data is packet data itself or packet header information, while the feature to be extracted is a parameter (occurrence rate, simultaneous arrival rate, or the like) that characterizes the traffic. A base station parameter reception section 418 receives a base station parameter from the analysis and determination apparatus 402, and a base station parameter reflection section 419 sets the base station parameter. Note that these functional configurations can be also implemented by executing programs on a processor (not shown) of the radio base station 401.

The mobility management node 302 is the same as the mobility management node shown in FIG. 20, and therefore a description thereof will be omitted, using the same reference signs.

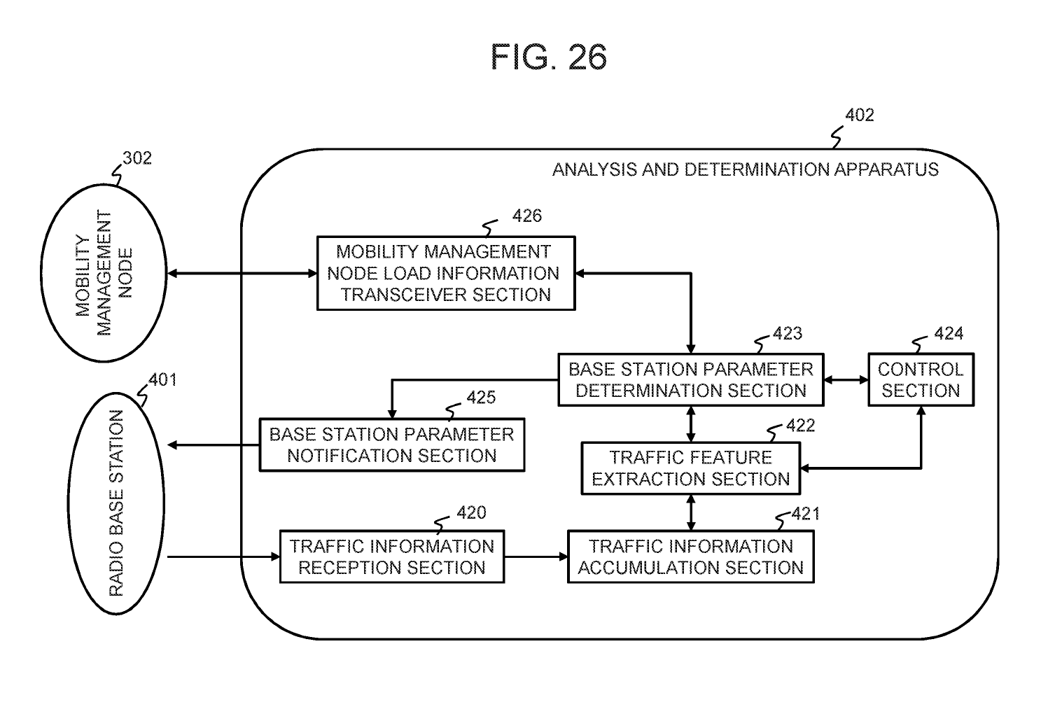

Referring to FIG. 26, a traffic information reception section 420 of the analysis and determination apparatus 402 receives local traffic features from the radio base stations 402 and accumulates them in a traffic information accumulation section 421. A traffic feature extraction section 422 extracts a traffic feature of the entire network by using the local traffic features received from the radio base stations 401. A base station parameter determination section 423 determines a base station parameter by using the extracted traffic feature and mobility management node load information, which is received from the mobility management node 302 via a mobility management node load information transceiver section 425. The operations of the traffic feature extraction section 422 and base station parameter determination section 423 are controlled by a control section 424. A base station parameter notification section 425 sends the determined base station parameter to the radio base station 401.

### 5.2) Operation

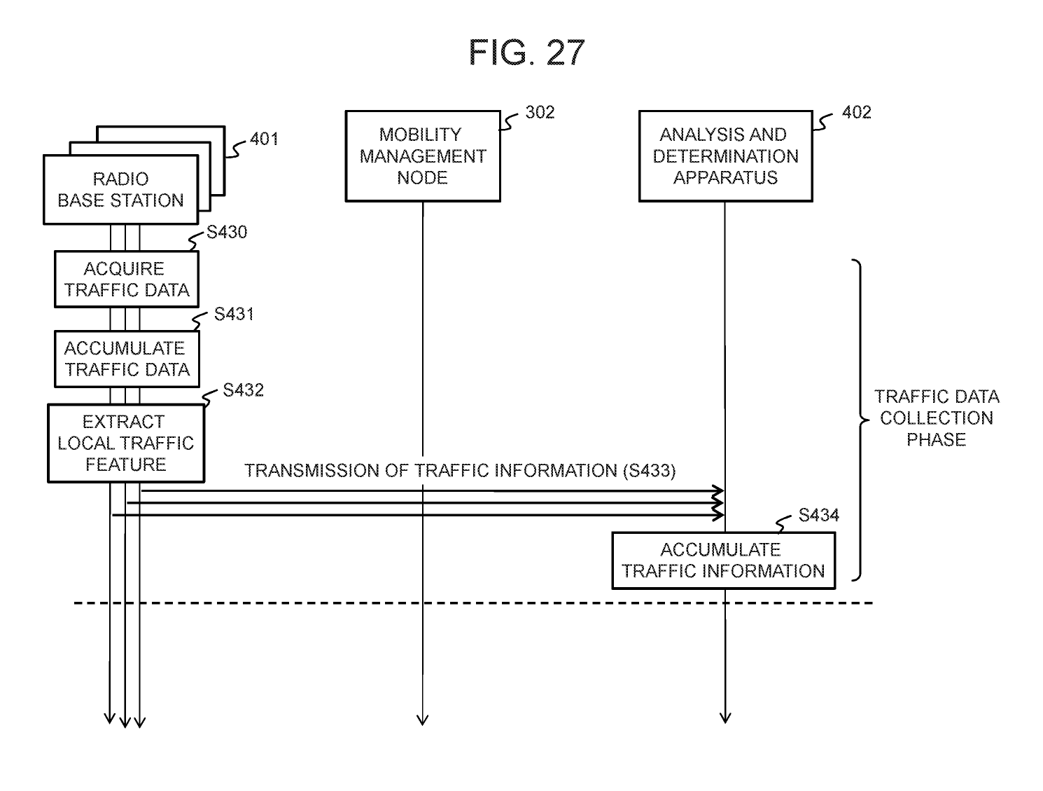

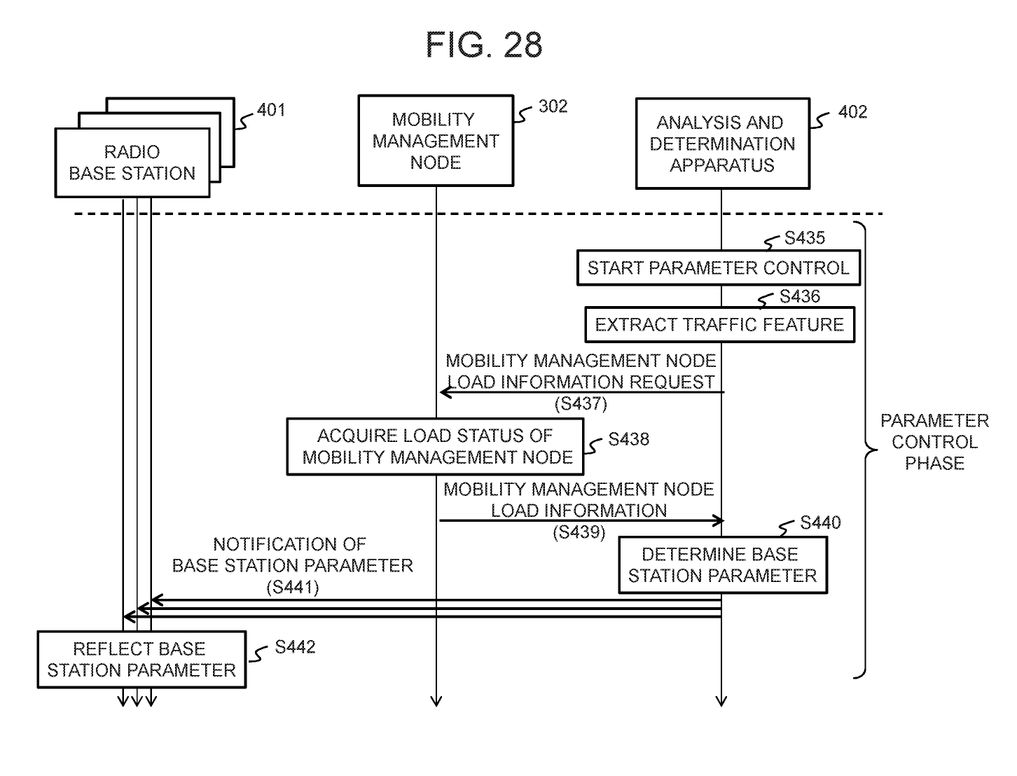

Hereinafter, a traffic data collection phase and a parameter control phase will be individually described in detail with reference to FIGS. 27 and 28. The traffic data collection phase and parameter control phase can be operated independently of each other.

In the traffic data collection phase shown in FIG. 27, when the traffic data acquisition section 414 of each radio base station 401 has acquired traffic data and accumulated it in the traffic data accumulation section 415 (Operations S430 and S431), the traffic feature extraction section 416 extracts a local traffic feature from the accumulated traffic data (Operation S432) and sends it to the analysis and determination apparatus 402 via the traffic information transmission section 417 (Operation S433). The traffic information reception section 420 of the analysis and determination apparatus 402, when receiving the traffic information (local traffic features) from the plurality of radio base stations 401 in the radio access network 102, accumulates them in the traffic information accumulation section 421 (Operation S434).

In the parameter control phase shown in FIG. 28, after the local traffic features have been accumulated in the traffic information accumulation section 421, the control section 424 starts parameter control at an arbitrary timing (Operation S435). First, the traffic feature extraction section 422 extracts a traffic feature of the entire network by using the accumulated local traffic features (Operation S436), and then the control section 424 controls the base station parameter determination section 423 to send a mobility management node load information request to the mobility management node 302 via the mobility management node load information transceiver section 426 (Operation S437).

When receiving the mobility management node load information request from the analysis and determination apparatus 402, the mobility management node 302 acquires information about the load status of its own node (Operation S438) and sends it to the analysis and determination apparatus 402 (Operation S439).

The base station parameter determination section 423 of the analysis and determination apparatus 402 determines a base station parameter by using the mobility management node load information received via the mobility management node load information transceiver section 426 and the traffic feature extracted by the traffic feature extraction section 422 (Operation S440). The determined base station parameter is sent to the radio base station 401 via the base station parameter notification section 425 (Operation S441). The radio base stations 401 operate, reflecting the received base station parameter (Operation S442).

### 5.3) Effects

As described above, according to the fifth exemplary embodiment of the present invention, traffic feature extraction is hierarchized, whereby it is possible that a local traffic feature extracted from C-U-plane traffic by each radio base station is sent to the analysis and determination apparatus, and the analysis and determination apparatus extracts a traffic feature of the entire network. According to the present exemplary embodiment, effects similar to those of the above-described fourth exemplary embodiment are obtained, and it is also possible to reduce the amount of information transmitted because information sent from each radio base station to the analysis and determination apparatus is not traffic data but a traffic feature.

### 6. Sixth Exemplary Embodiment

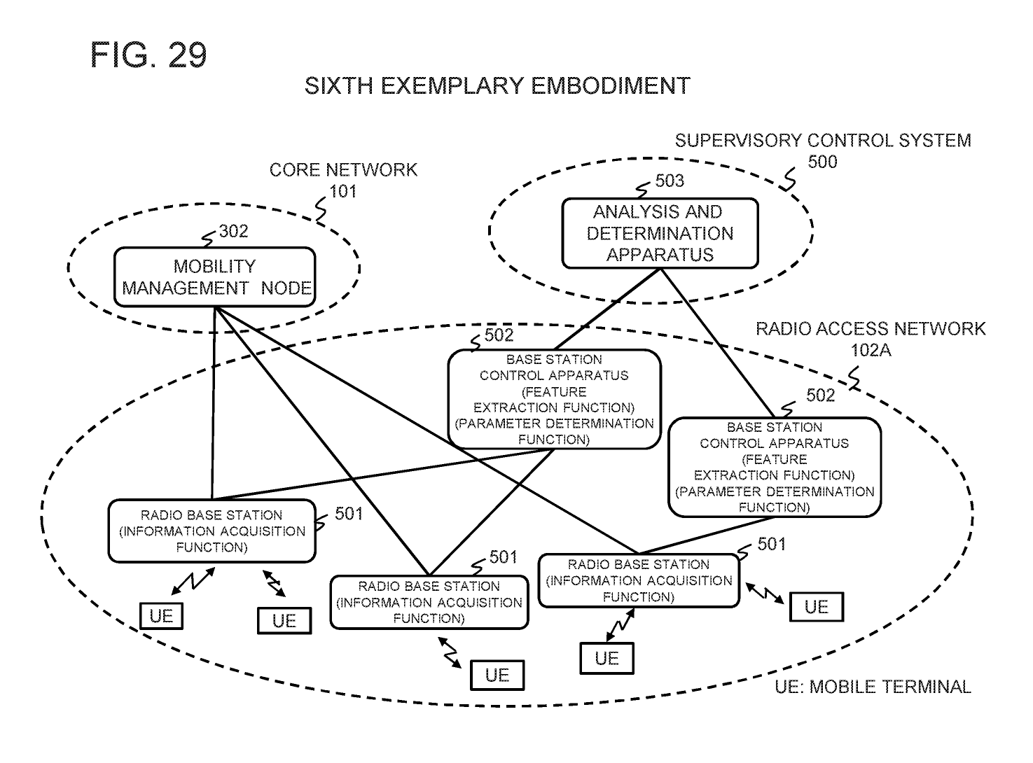

A network system according to a sixth exemplary embodiment of the present invention has a hierarchical structure in which a plurality of radio base stations are accommodated by an upper base station control apparatus, and a plurality of base station control apparatuses are further accommodated by an even upper analysis and determination apparatus. Each radio base station acquires traffic data, and each base station control apparatus extracts a traffic feature from the traffic data collected from a plurality of radio base stations and determines a base station parameter based on the extracted traffic feature. The base station control apparatuses each accommodating a plurality of radio base stations are deployed and an upper supervisory control system is deployed in this manner, whereby it is possible to perform parameter control using traffic information in an arbitrary area at each base station control apparatus. Hereinafter, a mobile network according to the present exemplary embodiment will be described with reference to FIGS. 29 to 34.

### 6.1) System Architecture

Referring to FIG. 29, the network system according to the present exemplary embodiment includes a core network 101, a radio access network 102a, and a supervisory control system 500. A mobility management node 302 is provided in the core network 101, as described already. The radio access network 102a includes a plurality of radio base stations 501 and a plurality of base station control apparatuses 502. The plurality of radio base stations 501 are managed by the mobility management node 302. Each of the plurality of base station control apparatuses 502 accommodates some of the radio base stations 501 under its control and is connected to an analysis and determination apparatus 503, which is provided in the upper supervisory control system 500. That is, the network system has a hierarchical structure in which all radio base stations 501 included in the radio access network 102a are accommodated by the base station control apparatuses 502, and the plurality of base station control apparatuses 502 are further accommodated by the analysis and determination apparatus 503.

Each radio base station 501 has a traffic data acquisition function of acquiring C/U-plane traffic data, and each base station control apparatus 502 has a function of extracting a traffic feature from the traffic data collected from the radio base stations and a function of determining a base station parameter based on the traffic feature. The determined base station parameter is set on all of the radio base stations 501, or those within a predetermined area, under control of the relevant base station control apparatus 502. Note that the analysis and determination apparatus 503 may collect the base station parameters determined by the base station control apparatuses 502 to monitor the entire network or to extract a traffic feature of the entire network.

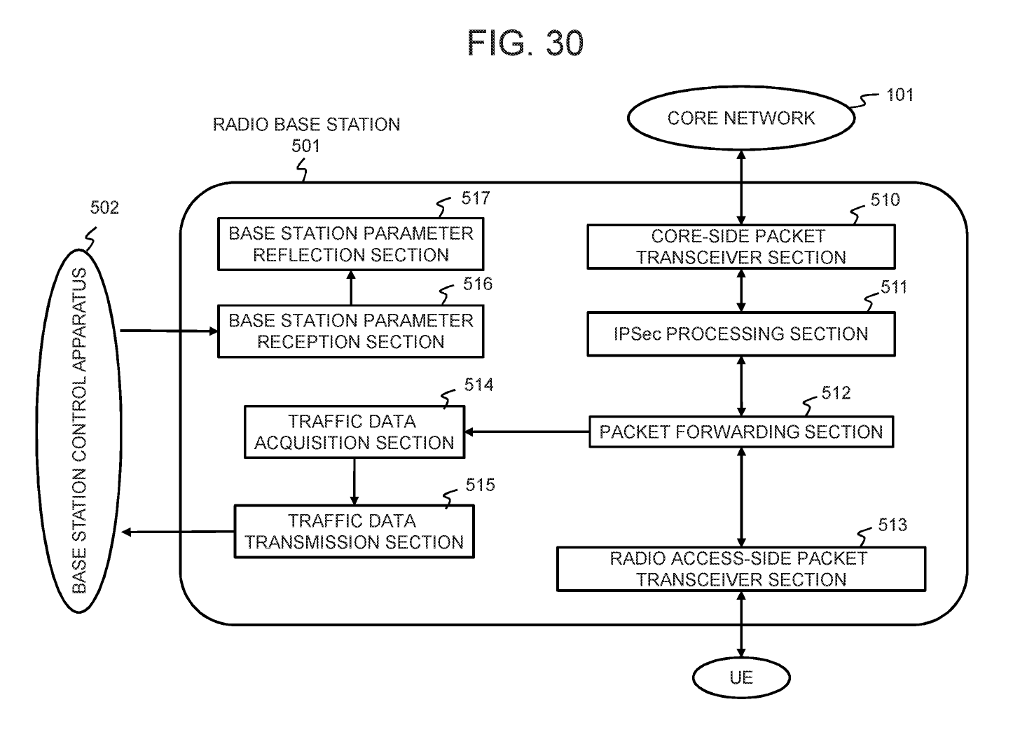

Referring to FIG. 30, a core-side packet transceiver section 510 of the radio base station 501 sends and receives packets to/from the core network 101, and an IPsec processing section 511 terminates an IPsec protocol on the core side. Packets from mobile terminals UE or packets addressed to mobile terminals UE are received from or sent to the mobile terminals UE under control via a packet forwarding section 512 and a radio access-side packet transceiver section 513. Moreover, a traffic data acquisition section 514 acquires traffic data from the packet forwarding section 512 and send it to a base station control apparatus 502 via a traffic data transmission section 515. The traffic data is packet data itself or packet header information. A base station parameter reception section 516 receives a base station parameter from the base station control apparatus 502, and a base station parameter reflection section 517 sets the base station parameter. Note that these functional configurations can be also implemented by executing programs on a processor (not shown) of the radio base station 501.

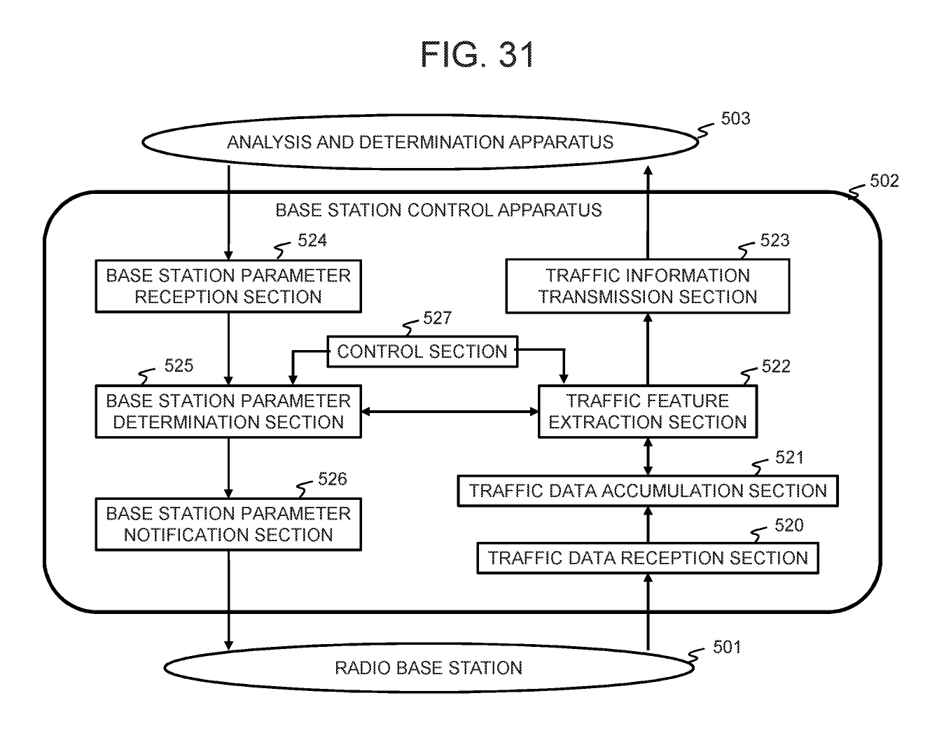

Referring to FIG. 31, a traffic data reception section 520 of the base station control apparatus 502 receives traffic data from radio base stations 501 under control and accumulates it in a traffic data accumulation section 521. When the traffic data is accumulated, a control section 527 controls a traffic feature extraction section 522 and a base station parameter determination section 525 to determine a base station parameter. That is, the traffic feature extraction section 522 extracts a traffic feature as traffic information from the accumulated traffic data. The traffic feature to be extracted is a parameter (occurrence rate, simultaneous arrival rate, or the like) that characterizes the traffic. The base station parameter determination section 525 determines a base station parameter based on the traffic feature extracted by the traffic feature extraction section 522. The determined base station parameter is sent to the radio base stations 501 under control via a base station parameter notification section 526. Accordingly, the base station parameter suitable for a partial network under control of this base station control apparatus 502 can be set only on the radio base stations 501 under control thereof.

Moreover, it is also possible that the traffic feature extracted by the traffic feature extraction section 522 is sent to the analysis and determination apparatus 503 via a traffic information transmission section 523. If a base station parameter is received from the analysis and determination apparatus 503, a base station parameter reception section 524 sends the received base station parameter to the radio base stations 501 under control via the base station parameter notification section 526.

### 6.2) Operation

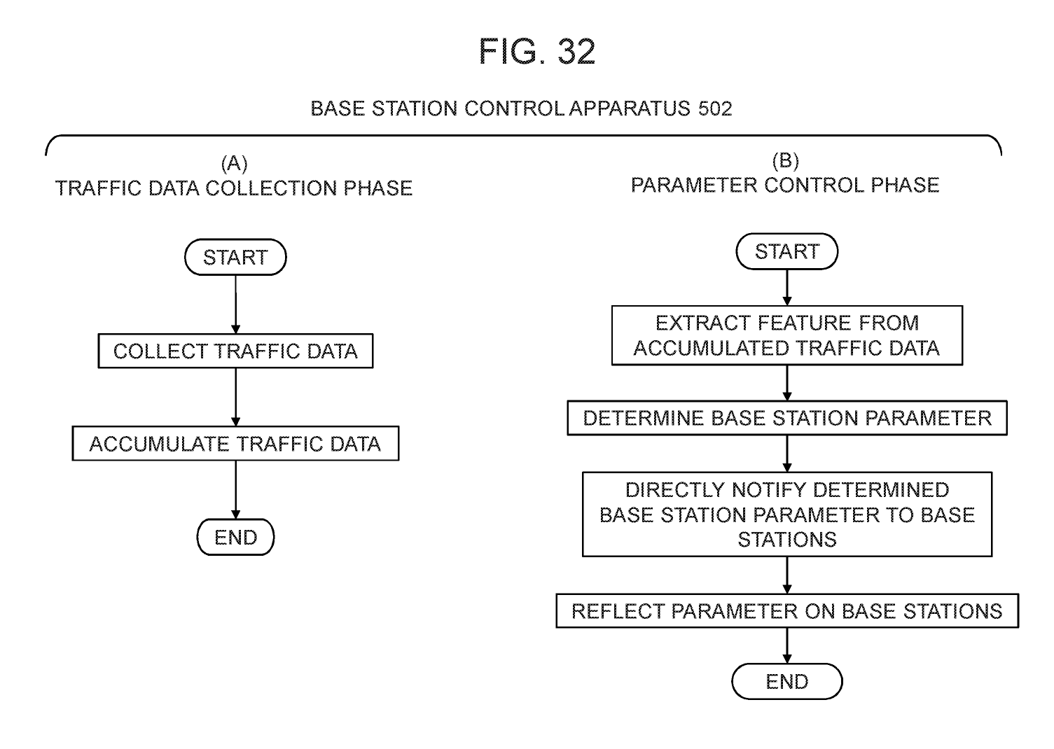

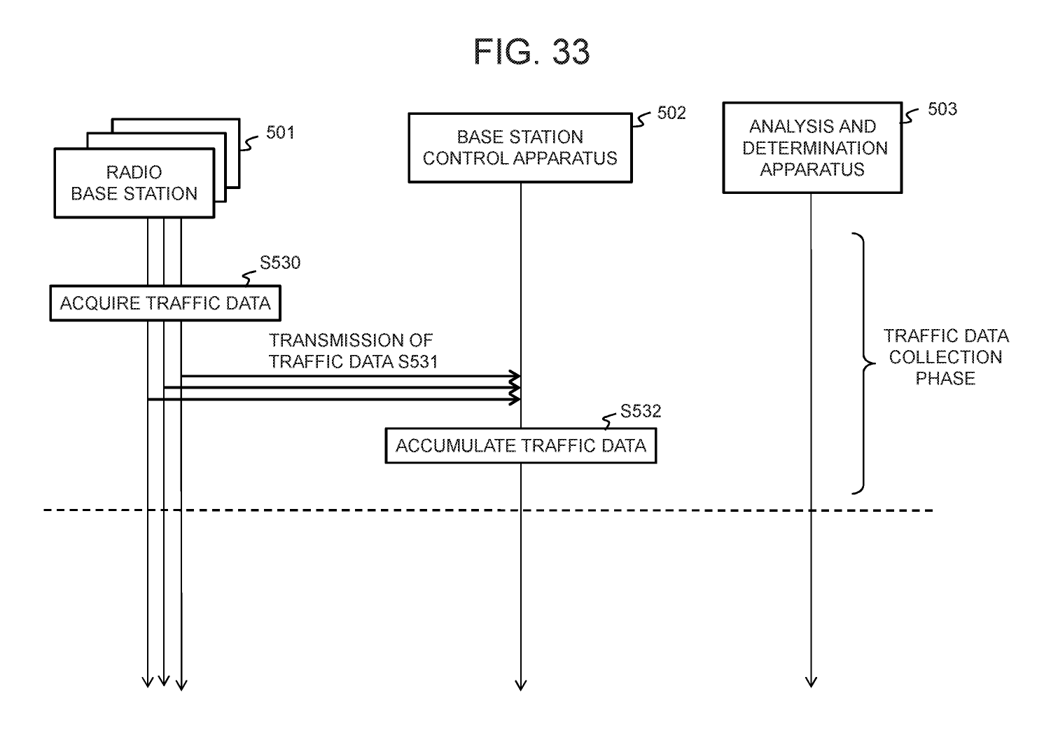

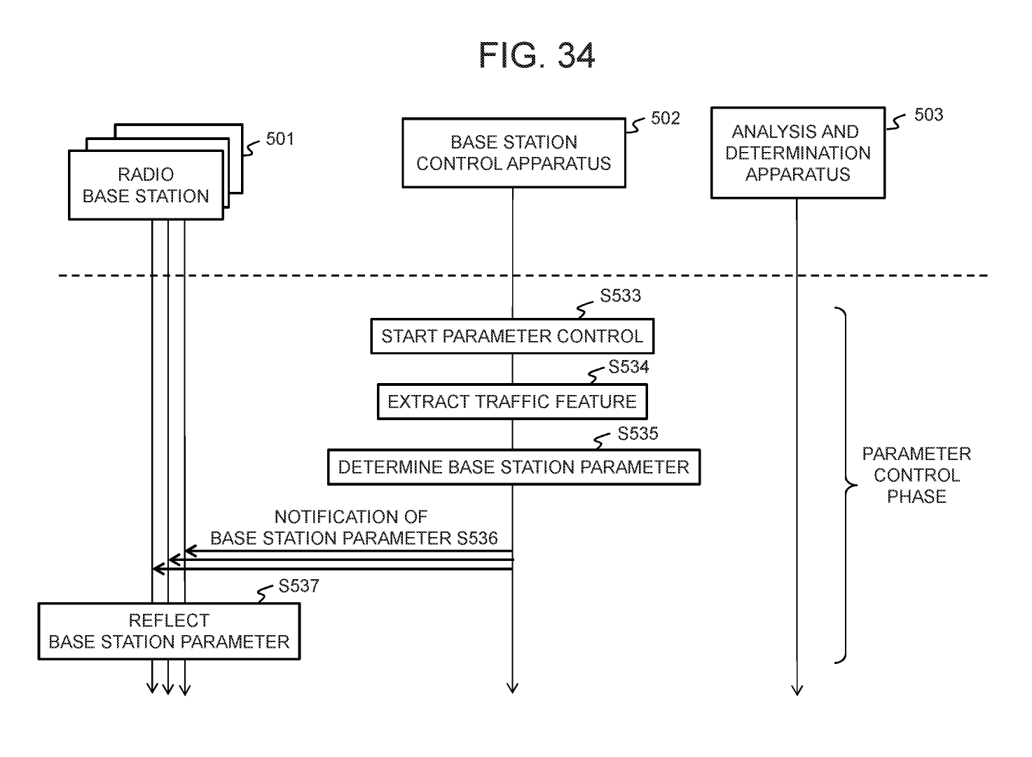

As shown in FIG. 32, operation in the present exemplary embodiment includes a traffic data collection phase and a parameter control phase. Hereinafter, the traffic data collection phase and parameter control phase will be described in detail with reference to FIGS. 33 and 34. However, the traffic data collection phase and parameter control phase can be operated independently of each other, and it is also possible that while traffic data is collected, parameter control is performed in parallel every time data is accumulated. Real-time control can be achieved, in particular, by making time taken to transition from the completion of the traffic data collection phase to the parameter control phase as null as possible.

In the traffic data collection phase shown in FIG. 33, each radio base station 501 in the radio access network 102a acquires traffic data (Operation S530) and sends the traffic data to a upper base station control apparatus 502 (Operation S531). The base station control apparatus 502, upon receiving the traffic data from the radio base stations 501 under control, accumulates it in the traffic information accumulation section 521 (Operation S532).

In the parameter control phase shown in FIG. 34, after the traffic data from the plurality of radio base stations 501 included in the radio access network 102a is accumulated, the control section 527 of the base station control apparatus 502 starts parameter control at an arbitrary timing (Operation S533). First, the traffic feature extraction section 522 extracts a traffic feature from the accumulated traffic data (Operation S534), and then the base station parameter determination section 525 determines a base station parameter (Operation S535). The determined base station parameter is notified to all radio base stations under control, or one or some specified base stations, via the base station parameter notification section 526 (Operation S536). At the radio base stations 501, when the base station parameter reception section 516 receives the base station parameter, the base station parameter reflection section 517 sets the notified base station parameter (Operation S537).

### 6.3) Effects

As described above, according to the sixth exemplary embodiment of the present invention, in a hierarchical structure in which the base station control apparatuses each accommodating a plurality of radio base stations are deployed and the even upper analysis and determination apparatus is deployed, it is possible to perform parameter control similar to that of the above-described fifth exemplary embodiment. Since a traffic feature is extracted and a base station parameter is determined at each base station control apparatus, in particular, it is possible achieve parameter control using traffic information in an arbitrary area.

### 7. Seventh Exemplary Embodiment

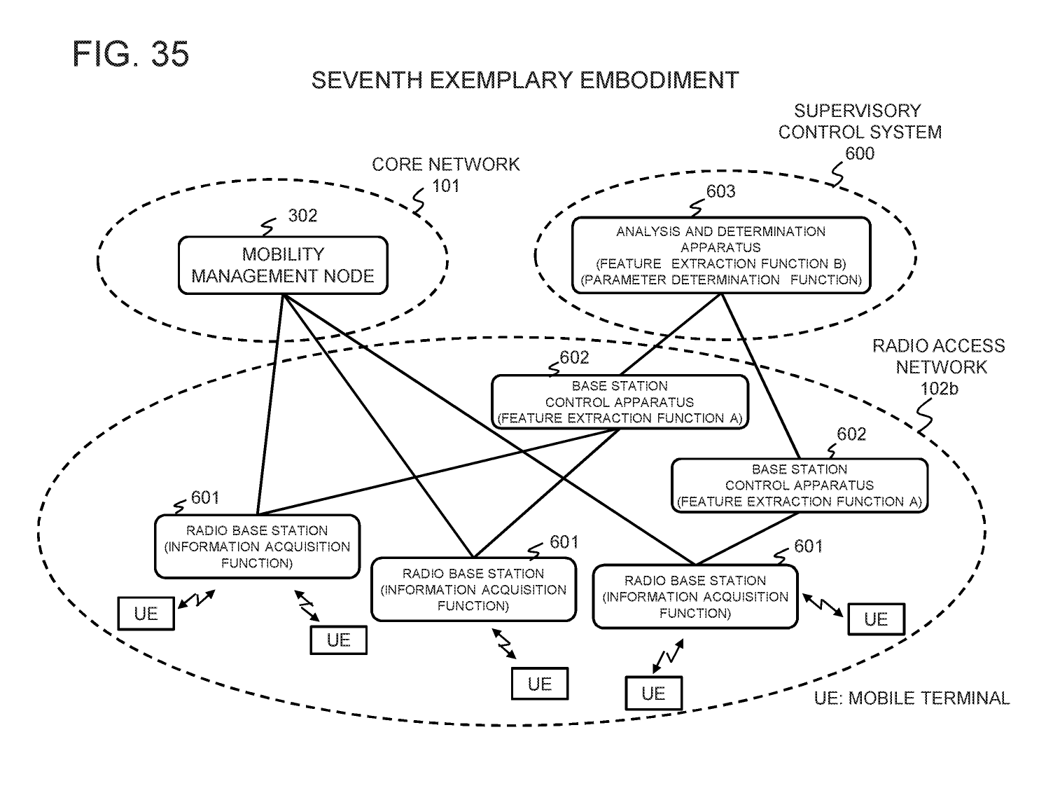

A network system according to a seventh exemplary embodiment of the present invention has a hierarchical structure in which a plurality of radio base stations are accommodated by an upper base station control apparatus, and a plurality of base station control apparatuses are further accommodated by an even upper supervisory control system. Each radio base station acquires traffic data; each base station control apparatus extracts a local traffic feature as traffic information; the supervisory control system extracts a feature of the entire network and determines a base station parameter. The base station control apparatuses each accommodating a plurality of radio base stations and the supervisory control system accommodating the plurality of base station control apparatuses are deployed in this manner, whereby it is possible to perform parameter control using traffic information in an arbitrary area at each base station control apparatus or the supervisory control system. Hereinafter, a mobile network according to the present exemplary embodiment will be described with reference to FIGS. 35 to 39.

### 7.1) System Architecture

Referring to FIG. 35, the network system according to the present exemplary embodiment includes a core network 101, a radio access network 102b, and a supervisory control system 600. A mobility management node 302 is provided in the core network 101, as described already. The radio access network 102b includes a plurality of radio base stations 601 and a plurality of base station control apparatuses 602. Each of the plurality of base station control apparatuses 602 accommodates some of the radio base stations 601 under its control and is connected to an analysis and determination apparatus 603, which is provided in the upper supervisory control system 600. That is, the network system has a hierarchical structure in which all radio base stations 601 included in the radio access network 102b are accommodated by the base station control apparatuses 602, and the plurality of base station control apparatuses 602 are further accommodated by the analysis and determination apparatus 603.

Each radio base station 601 has a traffic data acquisition function of acquiring C/U-plane traffic data, and each base station control apparatus 602 has a function A of extracting a local traffic feature from the traffic data collected from the radio base stations. The analysis and determination apparatus 603 has a function B of collecting the local traffic features received from the base station control apparatuses 602 and extracting a traffic feature of the entire network and further has a function of determining a base station parameter of the radio base station 601 based on the extracted traffic feature. The determined base station parameter is set on all of the radio base stations 601, or those within a predetermined area, via the base station control apparatuses 602.

The mobility management node 302 is the same as the mobility management node shown in FIG. 20, and therefore a description thereof will be omitted, using the same reference signs. Moreover, the radio base station 601 and the base station control apparatus 602 have configurations similar to those shown in FIGS. 30 and 31, respectively, and therefore a description thereof will be omitted, using the same reference signs.

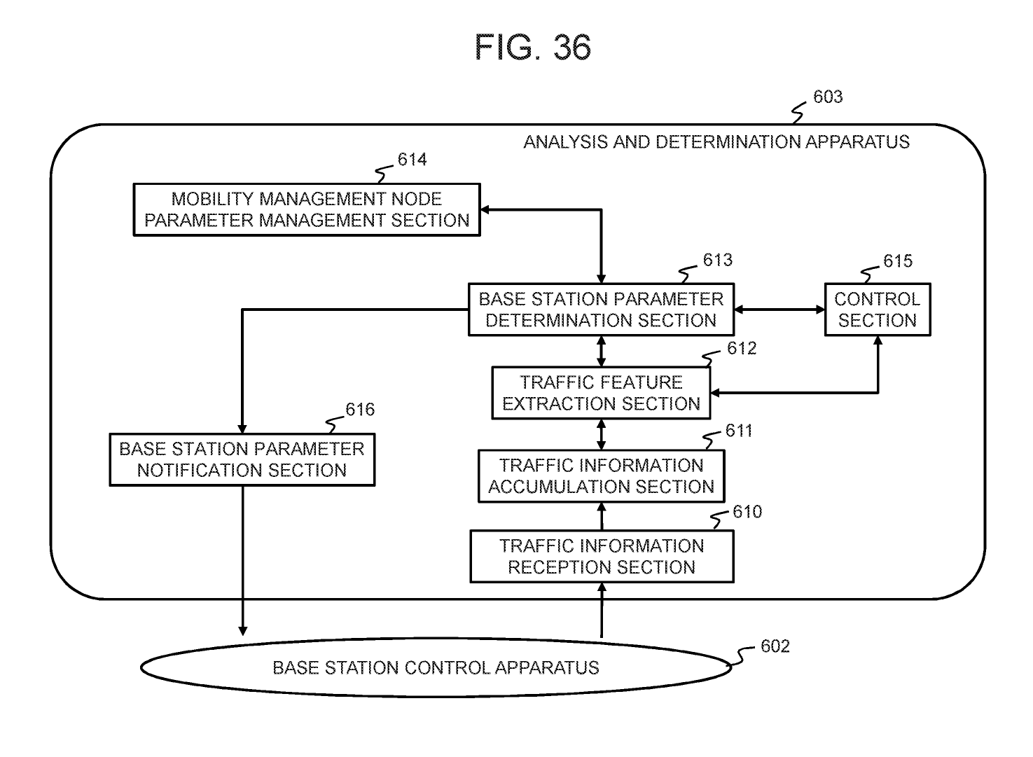

Referring to FIG. 36, a traffic information reception section 610 of the analysis and determination apparatus 603 receives local traffic features from the base station control apparatuses 602 and accumulates them in a traffic information accumulation section 611. A traffic feature extraction section 612 extracts a traffic feature in the entire network by using the local traffic features received from the base station control apparatuses 602. A base station parameter determination section 613 determines a base station parameter by using the extracted traffic feature and a mobility management node parameter such as C-plane packet throughput, which is managed by a mobility management node parameter management section 614. The operations of the traffic feature extraction section 612 and base station parameter determination section 613 are controlled by a control section 615. A base station parameter notification section 616 sends the determined base station parameter to the base station control apparatuses 602 under control. Note that it is also possible to use the load information of the mobility management node monitored by a mobility management node load monitoring section as in the second example of the first exemplary embodiment, in place of the mobility management node parameter management section 614.

### 7.2) Operation

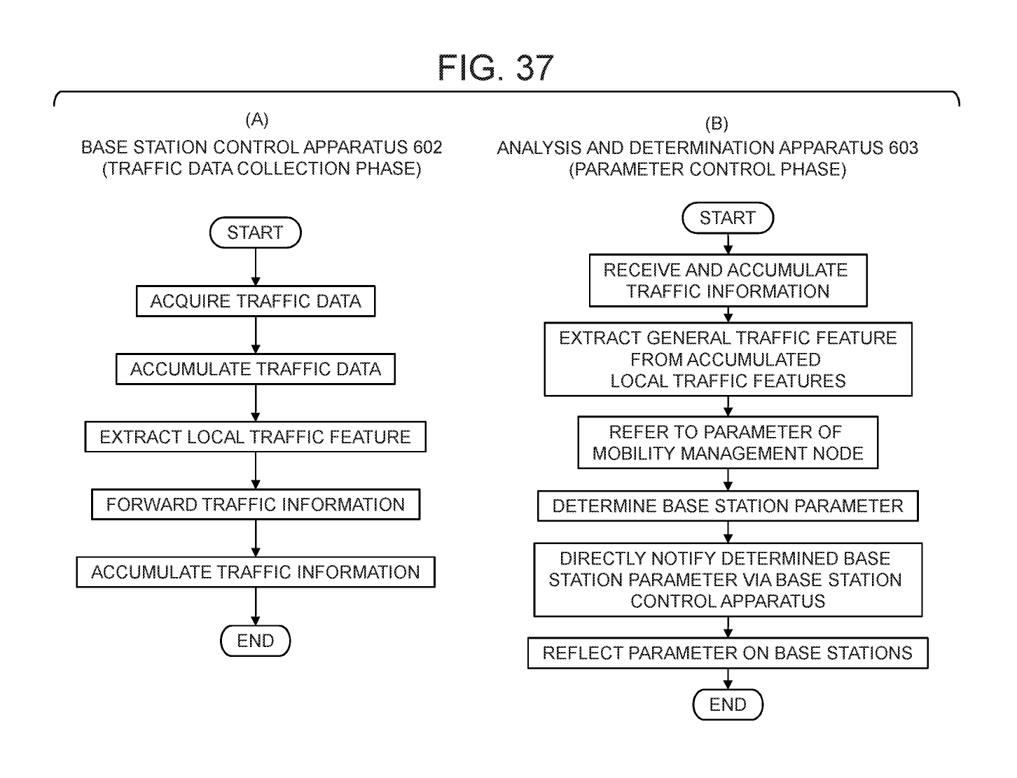

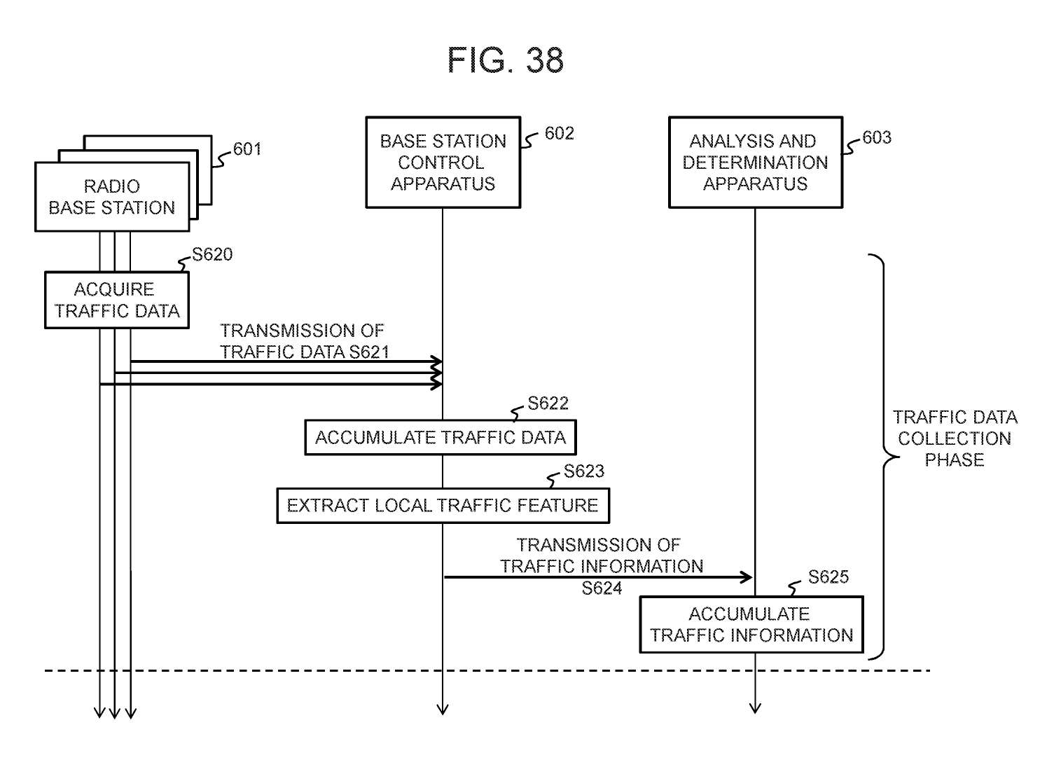

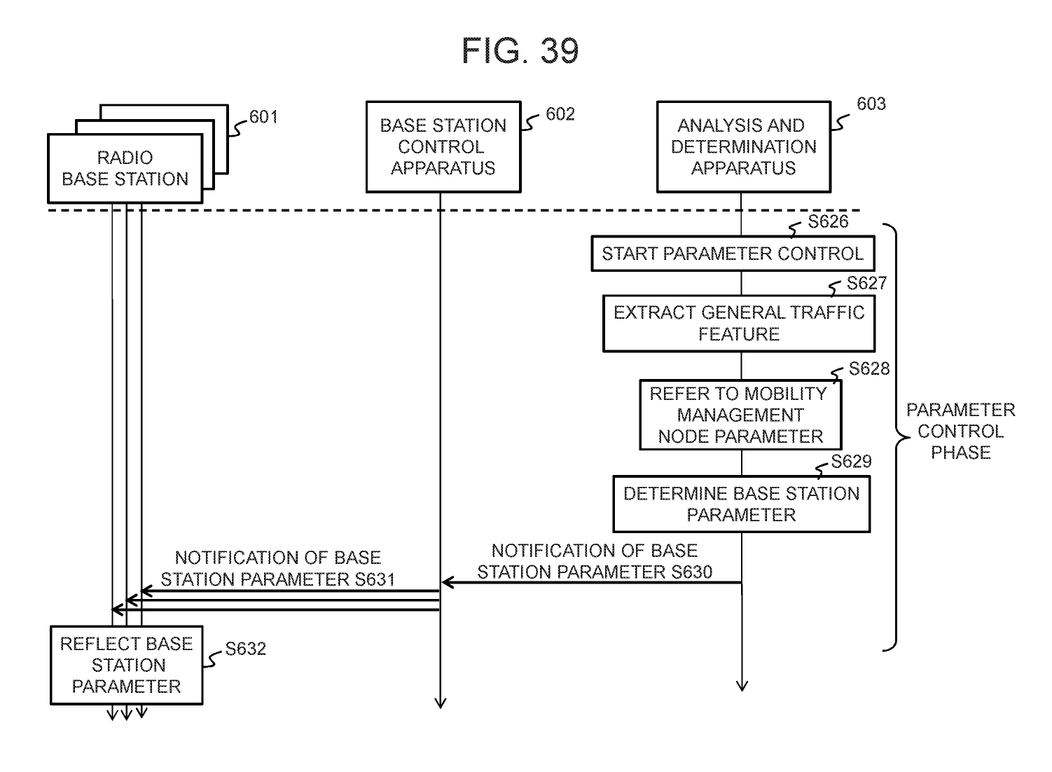

As shown in FIG. 37, operation in the present exemplary embodiment includes a traffic data collection phase and a parameter control phase. Hereinafter, the traffic data collection phase and parameter control phase will be described in detail with reference to FIGS. 38 and 39. However, the traffic data collection phase and parameter control phase can be operated independently of each other, and it is also possible that while traffic data is collected, parameter control is performed in parallel every time data is accumulated. Real-time control can be achieved, in particular, by making time taken to transition from the completion of the traffic data collection phase to the parameter control phase as null as possible.

In the traffic data collection phase shown in FIG. 38, the traffic data acquisition section 514 of each radio base station 601 acquires traffic data (Operation S620) and sends it to an upper base station control apparatus 602 (Operation S621).

At each base station control apparatus 602, when the traffic data received from the radio base stations 601 under control is accumulated in the traffic data accumulation section 521 (Operation S622), the traffic feature extraction section 522 extracts a local traffic feature as traffic information from the accumulated traffic data (Operation S623) and sends it to the analysis and determination apparatus 603 via the traffic information transmission section 523 (Operation S624). The traffic information reception section 610 of the analysis and determination apparatus 603, when receiving the traffic information (local traffic features) from the plurality of base station control apparatuses 602, accumulates them in the traffic information accumulation section 611 (Operation S625).

In the parameter control phase shown in FIG. 39, when the local traffic features are accumulated in the traffic information accumulation section 611 of the analysis and determination apparatus 603, the control section 615 starts parameter control (Operation S626). First, the traffic feature extraction section 612 extracts a traffic feature of the entire network by using the local traffic features accumulated in the traffic information accumulation section 611 (Operation S627), and then the control section 615 controls the base station parameter determination section 613 to refer to a mobility management node parameter in the mobility management node parameter management section 614 (Operation S628). The base station parameter determination section 613 determines a base station parameter by using the mobility management node parameter acquired from the mobility management node parameter management section 614 and the traffic feature extracted by the traffic feature extraction section 612 (Operation S629). The base station parameter notification section 616 notifies the determined base station parameter to the base station control apparatuses 602 (Operation S630).

At each base station control apparatus 602, when the base station parameter reception section 524 receives the base station parameter, the base station parameter notification section 526 transfers this base station parameter to the radio base stations 601 under control (Operation S631). When the base station parameter reception section 516 of each radio base station 601 receives the base station parameter, the radio base station 601 operates, by the base station reflection section 517 reflecting the base station parameter (Operation S632).

### 7.3) Effects

As described above, according to the seventh exemplary embodiment of the present invention, in a hierarchical structure in which the base station control apparatuses each accommodating a plurality of radio base stations are deployed and the even upper analysis and determination apparatus is deployed, traffic feature extraction is hierarchized, whereby it is possible to obtain effects similar to those of the above-described fifth exemplary embodiment. That is, since parameter control through cooperation between the base station control apparatuses and the upper analysis and determination apparatus can be performed, it is possible achieve parameter control using traffic information in an arbitrary area. Moreover, it is possible to reduce the amount of information transmitted because information sent from each base station control apparatus to the analysis and determination apparatus is not traffic data but a traffic feature.

### 8. Eighth Exemplary Embodiment

In the above-described second to seventh exemplary embodiments, a parameter of radio base stations in a radio access network is controlled depending on the network status. However, the targets for which a parameter is controlled are not limited to radio base stations. Not only base stations, it is also possible to control a control parameter to be retained by a mobility management node or a mobile terminal, depending on the network status.

Accordingly, as an eighth exemplary embodiment of the present invention, a description will be given of mobility management node parameter control, which is applied to the network architecture according to the fourth exemplary embodiment (FIG. 18), as an example. However, the mobility management node parameter control is also applicable to the networks according to other exemplary embodiments (the above-described second, third, and fifth to seventh exemplary embodiments).

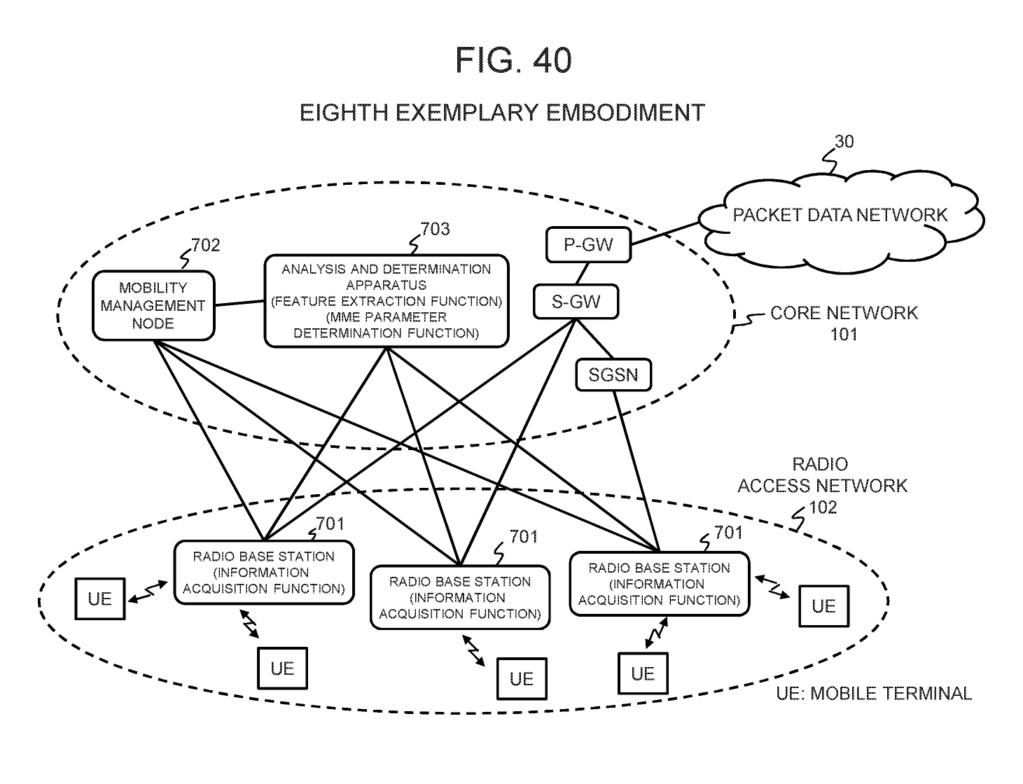

The basic architecture of a network according to the eighth exemplary embodiment of the present invention is similar to the system according to the fourth exemplary embodiment (see FIG. 18), with the difference that a mobility management node (MME) has a parameter setting function and an analysis and determination apparatus has a mobility management node parameter determination function. Hereinafter, the mobile network according to the present exemplary embodiment will be described with reference to FIGS. 40 to 46.

### 8.1) System Architecture

Referring to FIG. 40, the network according to the present exemplary embodiment includes a core network 101 and a radio access network 102, wherein radio base stations 701 in the radio access network 102 are provided with a function of acquiring C-plane and U-plane traffic data, and an analysis and determination apparatus 703 is provided separately from a mobility management node 702 in the core network 101.

The analysis and determination apparatus 703 has functions of extracting a traffic feature from traffic data acquired by the radio base stations 701, determining a parameter of the mobility management node 702 based on the extracted traffic feature, and directly setting it on the mobility management node 702. The analysis and determination apparatus 703 can be also implemented on, for example, a SON (Self-Organizing Network) server. The mobility management node 702, in addition to the ordinary mobility management functionality, can also have a function of notifying load monitoring information to the analysis and determination apparatus 703, which will be described later. The other architecture and functions, as well as the targets from which traffic data is to be collected, are similar to those of the second and third exemplary embodiments.

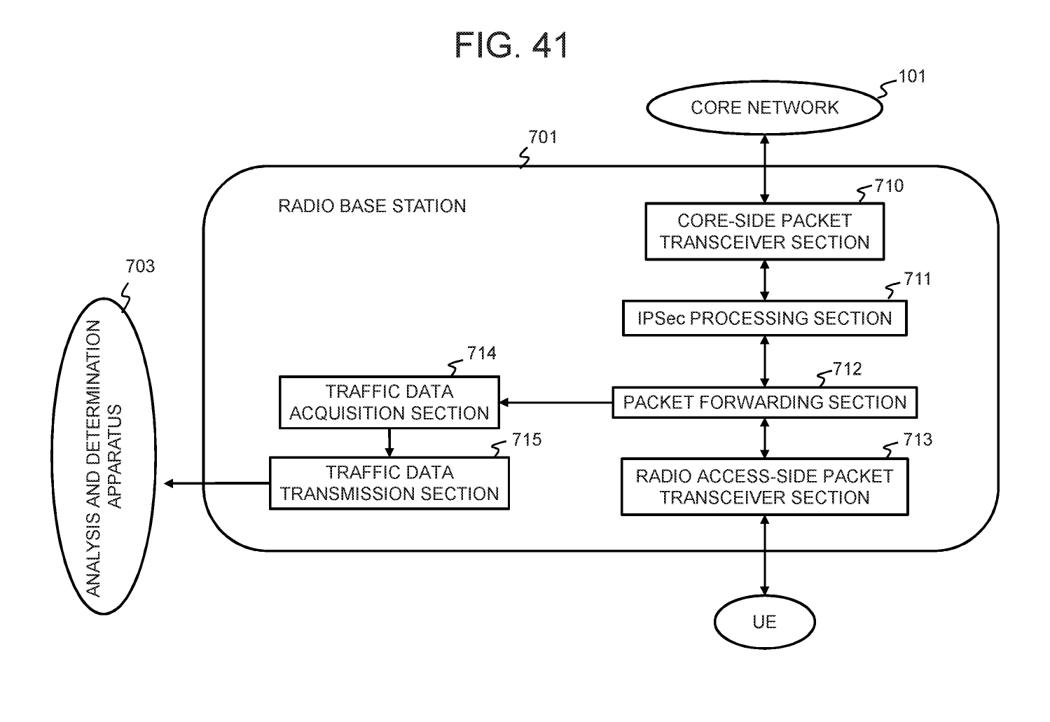

Referring to FIG. 41, a core-side packet transceiver section 710 of the radio base station 701 sends and receives packets to/from the core network 101, and an IPsec processing section 711 terminates an IPsec protocol on the core side. Packets from mobile terminals UE or packets addressed to mobile terminals UE are received from or sent to the mobile terminals UE under control via a packet forwarding section 712 and a radio access-side packet transceiver section 713. Moreover, a traffic data acquisition section 714 acquires traffic data from the packet forwarding section 712 and sends it to the analysis and determination apparatus 703 via a traffic data transmission section 715. Note that these functional configurations can be also implemented by executing programs on a processor (not shown) of the radio base station 701.

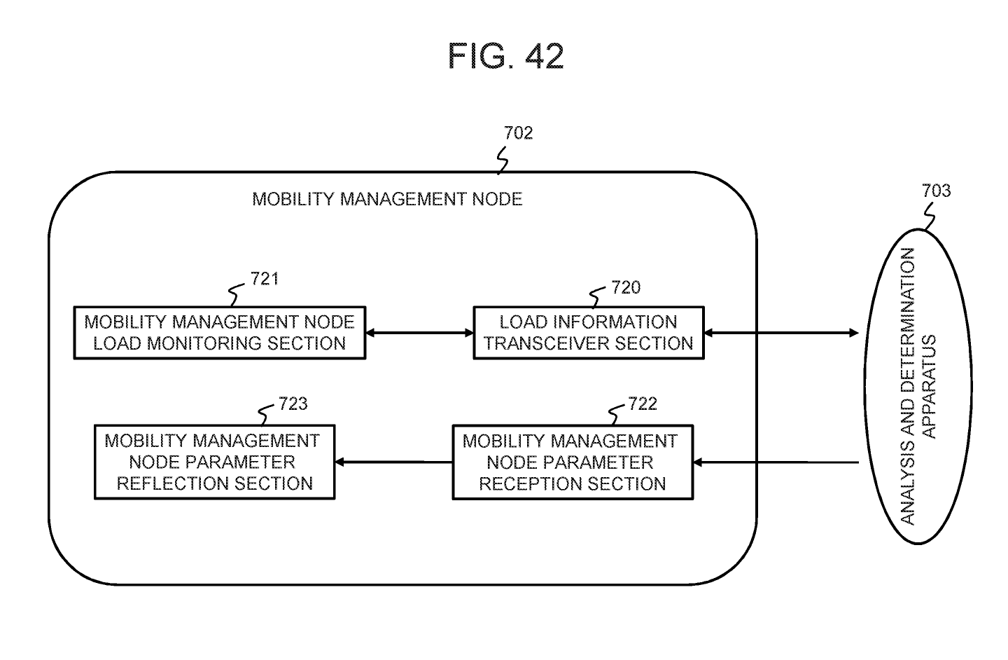

Referring to FIG. 42, the mobility management node 702 has a load information transceiver section 720 and a mobility management node load monitoring section 721, apart from the ordinary mobility management functionality. The load information transceiver section 720 sends information indicating the load status of its own node, which can be acquired by the mobility management node load monitoring section 721, to the analysis and determination apparatus 703 in accordance with a request from the analysis and determination apparatus 703. When a mobility management node parameter reception section 722 receives a mobility management node parameter from the analysis and determination apparatus 703, a mobility management node parameter reflection section 723 reflects the mobility management node parameter to operate.

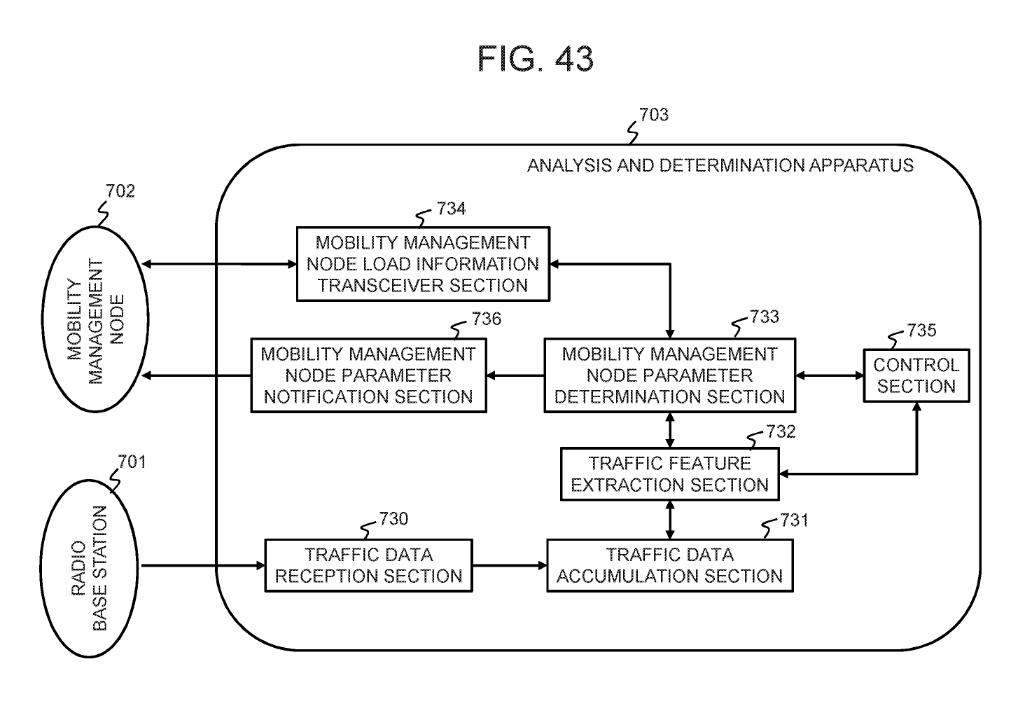

Referring to FIG. 43, a traffic data reception section 730 of the analysis and determination apparatus 703 receives traffic data from the radio base stations 701 and accumulates it in a traffic data accumulation section 731. A traffic feature extraction section 732 extracts a traffic feature from the accumulated traffic data. A mobility management node parameter determination section 733 determines a mobility management node parameter by using the extracted traffic feature and mobility management node load information, which is received from the mobility management node 702 via a mobility management node load information transceiver section 734. The operations of the traffic feature extraction section 732 and base station parameter determination section 733 are controlled by a control section 735. A base station parameter notification section 736 sends the determined mobility management node parameter to the mobility management node 702.

### 8.2) Operation

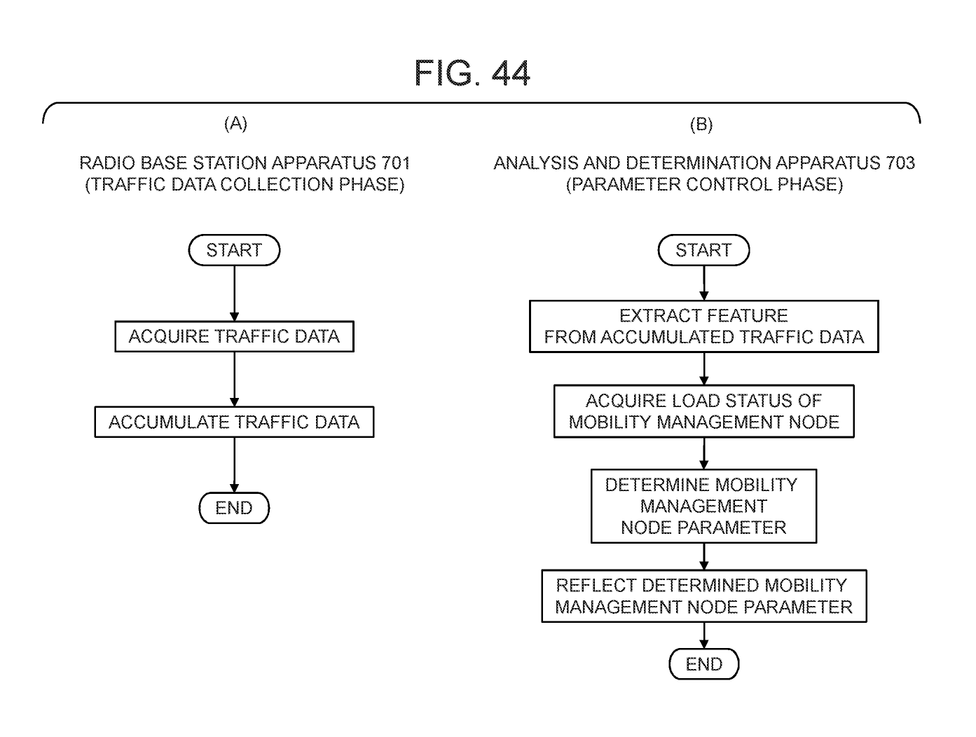

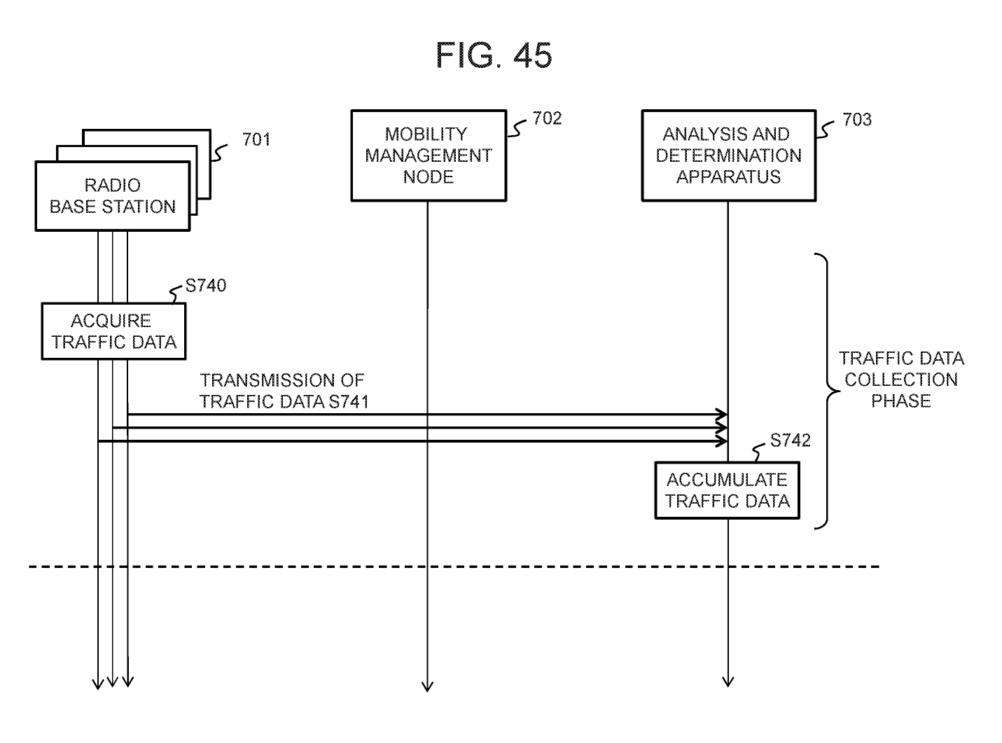

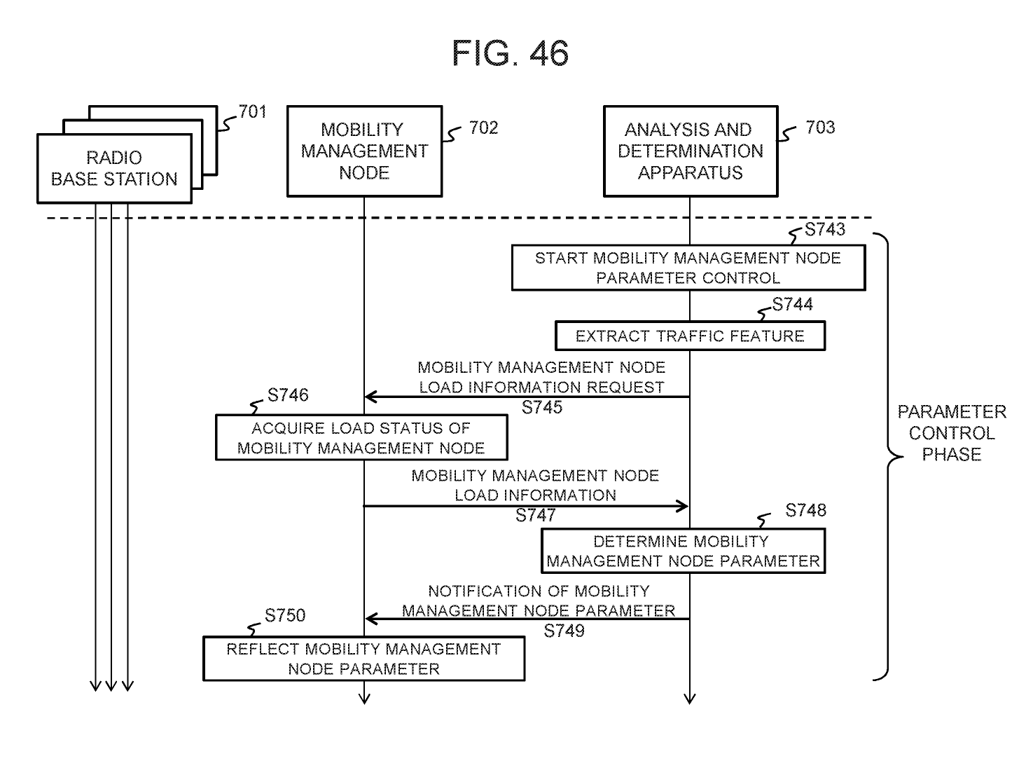

Operation in the present exemplary embodiment includes a traffic data collection phase and a parameter control phase as shown in FIG. 44. Hereinafter, the traffic data collection phase and parameter control phase will be individually described in detail with reference to FIGS. 45 and 46. However, the traffic data collection phase and parameter control phase can be operated independently of each other, and it is also possible that while traffic data is collected, parameter control is performed in parallel every time data is accumulated.

In the traffic data collection phase shown in FIG. 45, it is assumed that the radio base stations 701 have acquired traffic data (Operation S740) and have sent it to the analysis and determination apparatus 703 (Operation S741). The traffic data reception section 730 of the analysis and determination apparatus 703 collects the traffic data from the plurality of radio base stations 701 and accumulates it in the traffic data accumulation section 731 (Operation S742).

In the parameter control phase shown in FIG. 46, after the traffic data has been accumulated in the traffic data accumulation section 731, the control section 735 starts parameter control at an arbitrary timing (Operation S743). First, the traffic feature extraction section 732 extracts a traffic feature from the accumulated traffic data (Operation S744), and then the control section 735 controls the mobility management node parameter determination section 733 to send a mobility management node load information request to the mobility management node 702 via the mobility management node load information transceiver section 734 (Operation S745).

When receiving the mobility management node load information request from the analysis and determination apparatus 703, the load information transceiver section 720 of the mobility management node 702 acquires information about the load status of its own node from the mobility management node load monitoring section 721 (Operation S746) and sends it to the analysis and determination apparatus 703 (Operation S747).

The mobility management node parameter determination section 733 of the analysis and determination apparatus 703 determines a mobility management node parameter by using the mobility management node load information received via the mobility management node load information transceiver section 734 and the traffic feature extracted by the traffic feature extraction section 732 (Operation S748). The determined mobility management node parameter is sent to the mobility management node 702 via the mobility management node parameter transmission section 736 (Operation S749). The mobility management node 702 operates, reflecting the received mobility management node parameter (Operation S750).

### 8.3) Effects

As described above, according to the eighth exemplary embodiment of the present invention, a parameter (restriction rate, back-off timer value, or the like) of the mobility management node 702 is determined based on a traffic feature (C-packet occurrence rate, simultaneous arrival rate, periodic interval, phase, phase shift, or the like) in the radio access network 102. Thus, it is possible to achieve an effective mobility management node load reduction, overviewing the entire network. Further, it is possible to perform adequate parameter control even in the face of a failure of network equipment and a change in the status of the network such as congestion.

Moreover, the processing load can be distributed because the analysis and determination apparatus 703 is provided externally as in the above-described fourth exemplary embodiment and the analysis and determination apparatus 703 directly sets a control parameter on the mobility management node 702. Thus, it is possible to achieve an effective mobility management node load reduction overviewing the entire network, without reinforcing the throughput of the mobility management node. Further, since traffic data is acquired by the radio base stations 301, U-plane traffic information can be also acquired, making it possible to increase information that can be used in control.

### 9. Ninth Exemplary Embodiment

A ninth exemplary embodiment of the present invention will be described, taking mobile terminal parameter control, which is applied to the network architecture according to the fourth exemplary embodiment (FIG. 18), as an example. However, the mobile terminal parameter control is also applicable to the networks according to other exemplary embodiments (the above-described second, third, and fifth to seventh exemplary embodiments).

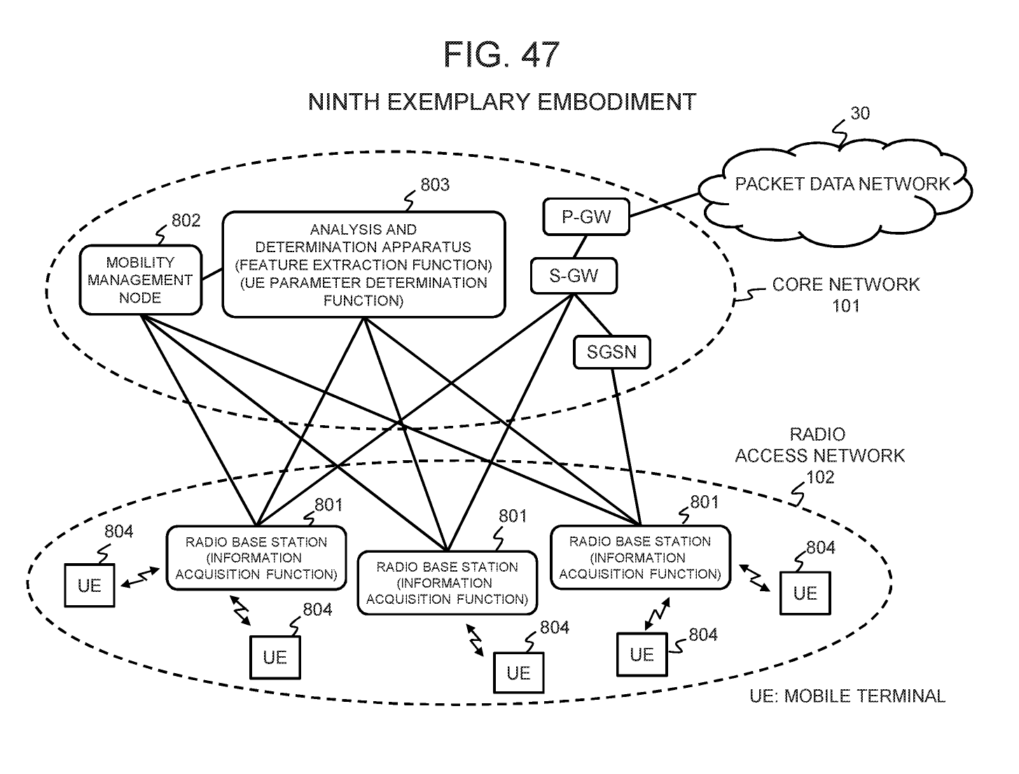

The basic architecture of a network according to the ninth exemplary embodiment of the present invention is similar to the system according to the fourth exemplary embodiment (see FIG. 18), with the difference that mobile terminals (UE) have a parameter setting function and an analysis and determination apparatus has a mobile terminal parameter determination function. Hereinafter, the mobile network according to the present exemplary embodiment will be described with reference to FIGS. 47 to 54.

### 9.1) System Architecture

Referring to FIG. 47, the network according to the ninth exemplary embodiment of the present invention includes a core network 101 and a radio access network 102, wherein the core network 101 includes an analysis and determination apparatus 803 separately from a mobility management node 802, and the radio access network 102 includes a plurality of radio base stations 801 and mobile terminals 804 connected to the radio base stations. Moreover, the radio base stations 801 are provided with a function of acquiring C-plane and U-plane traffic data, and the terminals 804 are provided with a parameter reflection function.

The analysis and determination apparatus 803 has functions of extracting a traffic feature from traffic data acquired by the radio base stations 801, determining a parameter of the mobile terminals 804 based on the extracted traffic feature, and setting the determined parameter on the mobile terminals 804 via the mobility management node 802 and radio base stations 801. The analysis and determination apparatus 803 can be also implemented on, for example, a SON (Self-Organizing Network) server. The mobility management node 802 has the ordinary mobility management functionality. The other architecture and functions, as well as the targets from which traffic data is to be collected, are similar to those of the second and third exemplary embodiments.

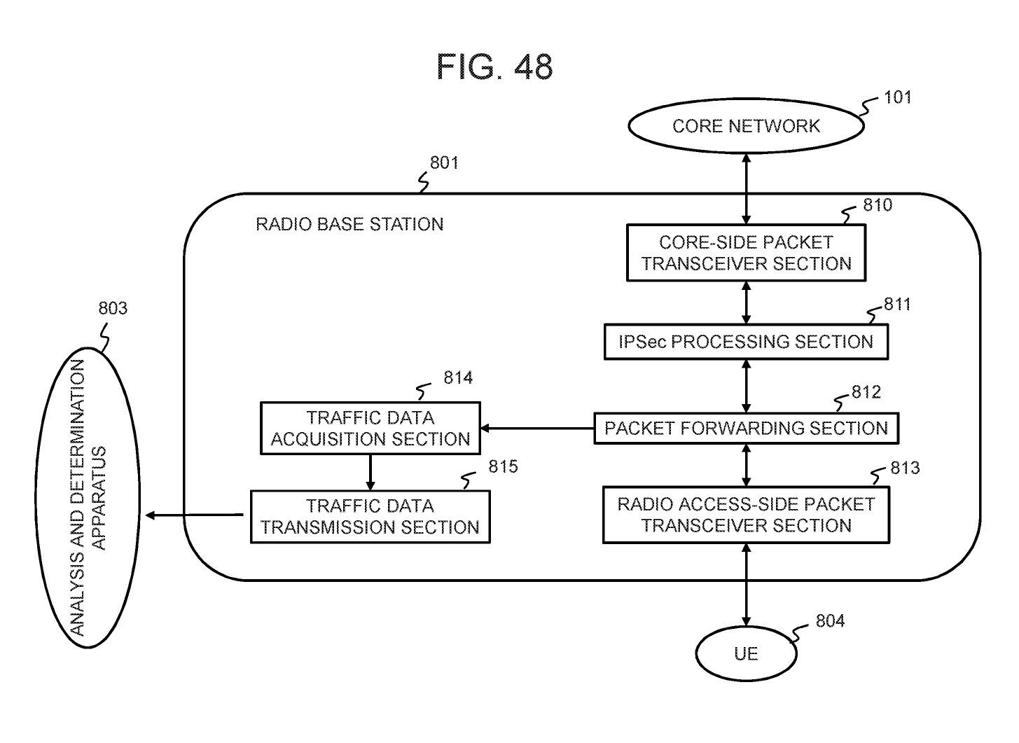

Referring to FIG. 48, a core-side packet transceiver section 810 of the radio base station 801 sends and receives packets to/from the core network 101, and an IPsec processing section 811 terminates an IPsec protocol on the core side. Packets from mobile terminals 804 or packets addressed to mobile terminals UE are received from or sent to the mobile terminals 804 under control via a packet forwarding section 812 and a radio access-side packet transceiver section 813. Moreover, a traffic data acquisition section 814 acquires traffic data from the packet forwarding section 812 and sends it to the analysis and determination apparatus 803 via a traffic data transmission section 815. Note that these functional configurations can be also implemented by executing programs on a processor (not shown) of the radio base station 801.

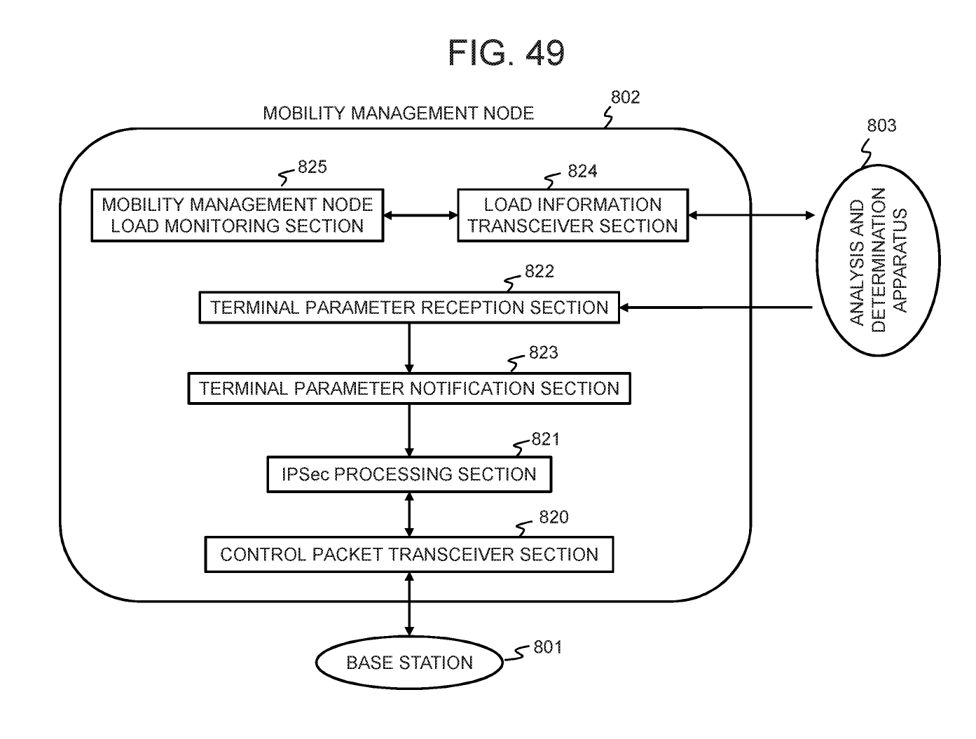

Referring to FIG. 49, a control packet transceiver section 820 of the mobility management node 802 sends and receives control packets to/from radio base stations 801 under control, and an IPsec processing section 821 terminates an IPsec protocol on the base station side. When a terminal parameter reception section 822 receives a terminal parameter from the analysis and determination apparatus 803, a terminal parameter notification section 823 notifies this terminal parameter to radio base stations 801 to which mobile terminals to set the terminal parameter on are connected, via the IPsec processing section 821 and control packet transceiver section 820. Moreover, a load information transceiver section 824 sends information indicating the load status of its own node, which can be acquired by a mobility management node load monitoring section 825, to the analysis and determination apparatus 803 in accordance with a request from the analysis and determination apparatus 803. Note that these functional configurations can be also implemented by executing programs on a processor (not shown) of the mobility management node 803.

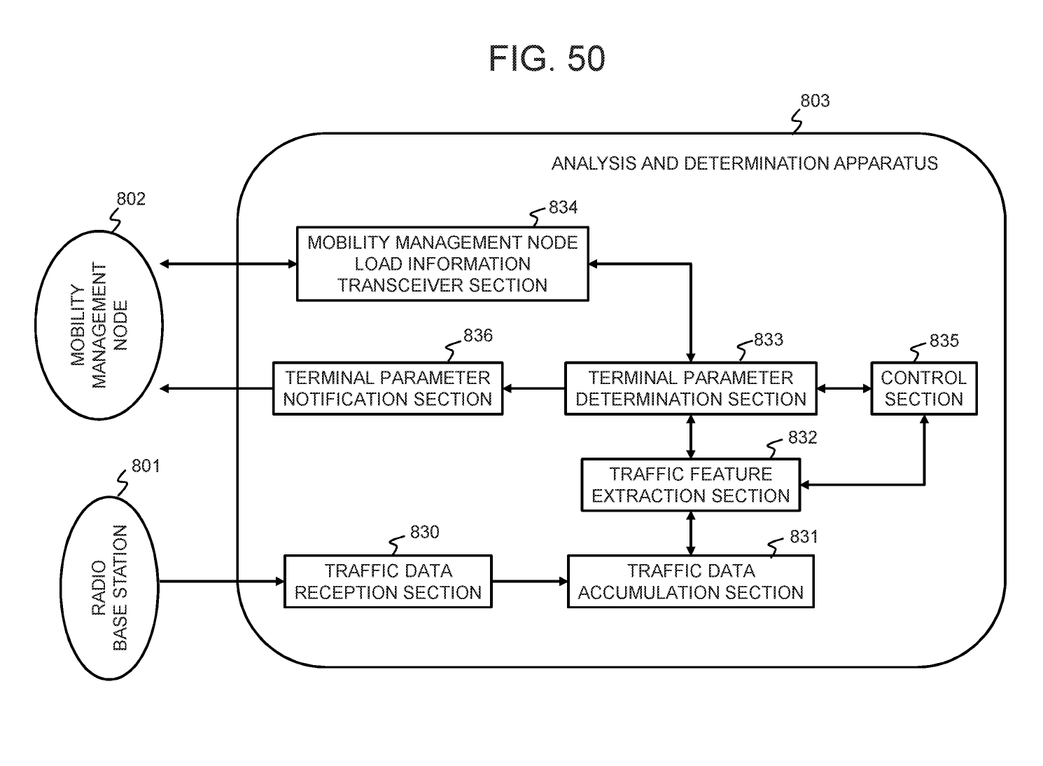

Referring to FIG. 50, a traffic data reception section 830 of the analysis and determination apparatus 803 receives traffic data from the radio base stations 801 and accumulates it in a traffic data accumulation section 831. A traffic feature extraction section 832 extracts a traffic feature from the accumulated traffic data. A terminal parameter determination section 833 determines a terminal parameter by using the extracted traffic feature and mobility management node load information, which is received from the mobility management node 802 via a mobility management node load information transceiver section 834. The operations of the traffic feature extraction section 832 and terminal parameter determination section 833 are controlled by a control section 835. A terminal parameter notification section 836 sends the determined terminal parameter to the mobility management node 802. Note that these functional configurations can be also implemented by executing programs on a processor (not shown) of the analysis and determination apparatus 803.

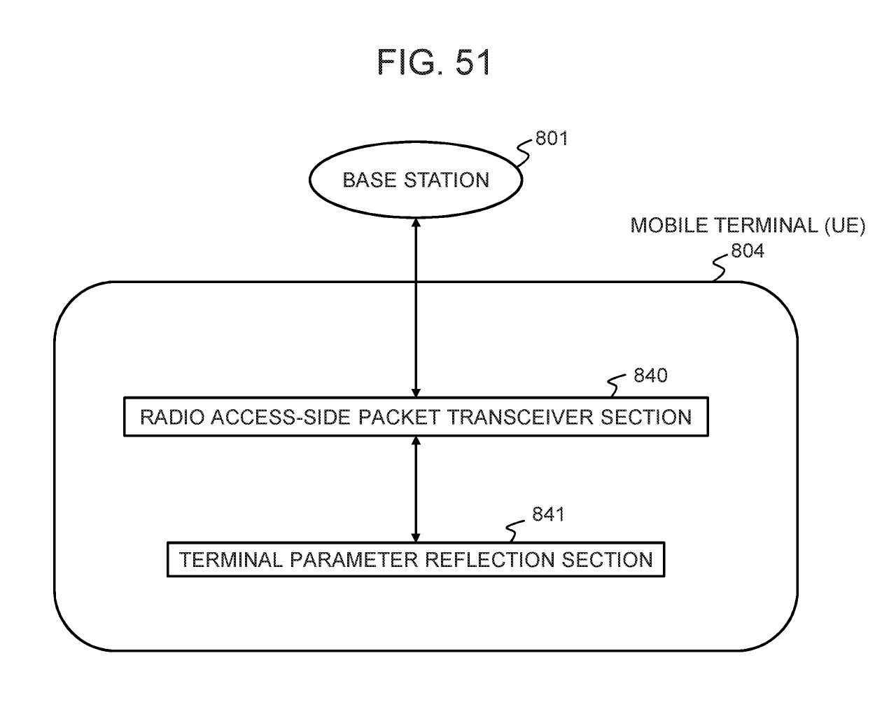

Referring to FIG. 51, the mobile terminal 804 in the present exemplary embodiment is provided with a radio access-side packet transceiver section 840 and a terminal parameter reflection section 841. However, the configurations of an ordinary data processing system and an ordinary control system in the mobile terminal are omitted. When the radio access-side packet transceiver section 840 receives a terminal parameter from a radio base station 801 to which it is connected, the terminal parameter reflection section 841 reflects the received terminal parameter on the control system. Note that these functional configurations can be also implemented by executing programs on a processor (not shown) of the mobile terminal 804.

### 9.2) Operation

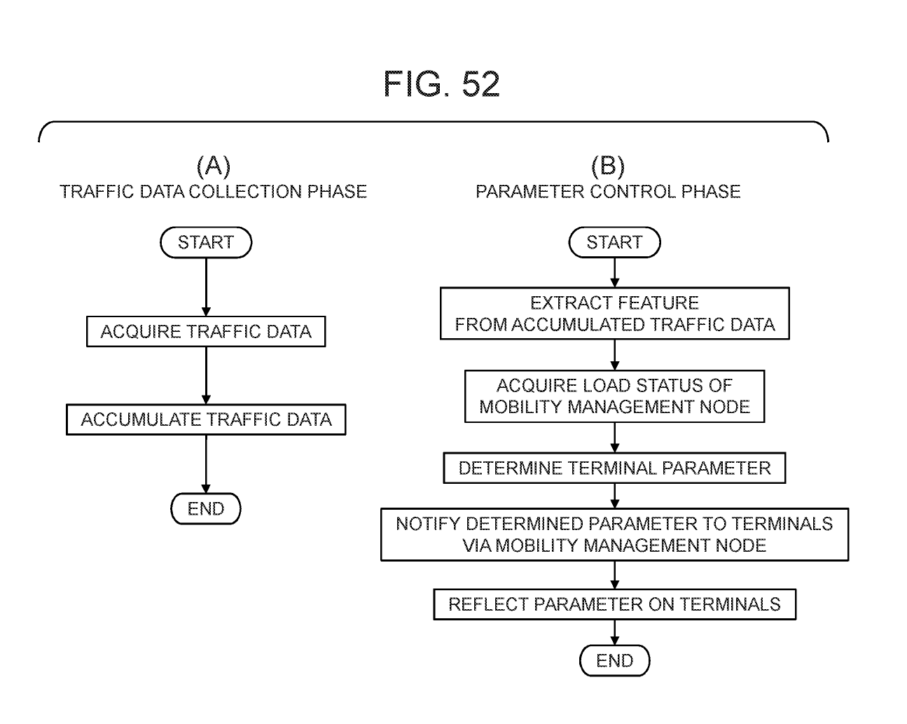

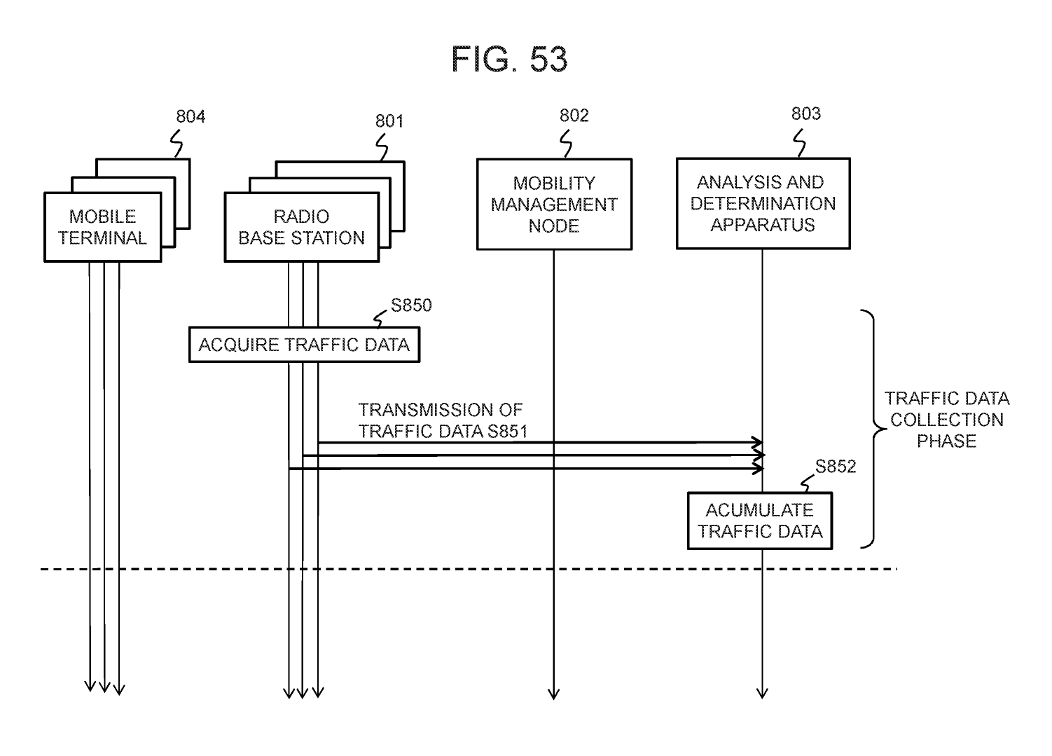

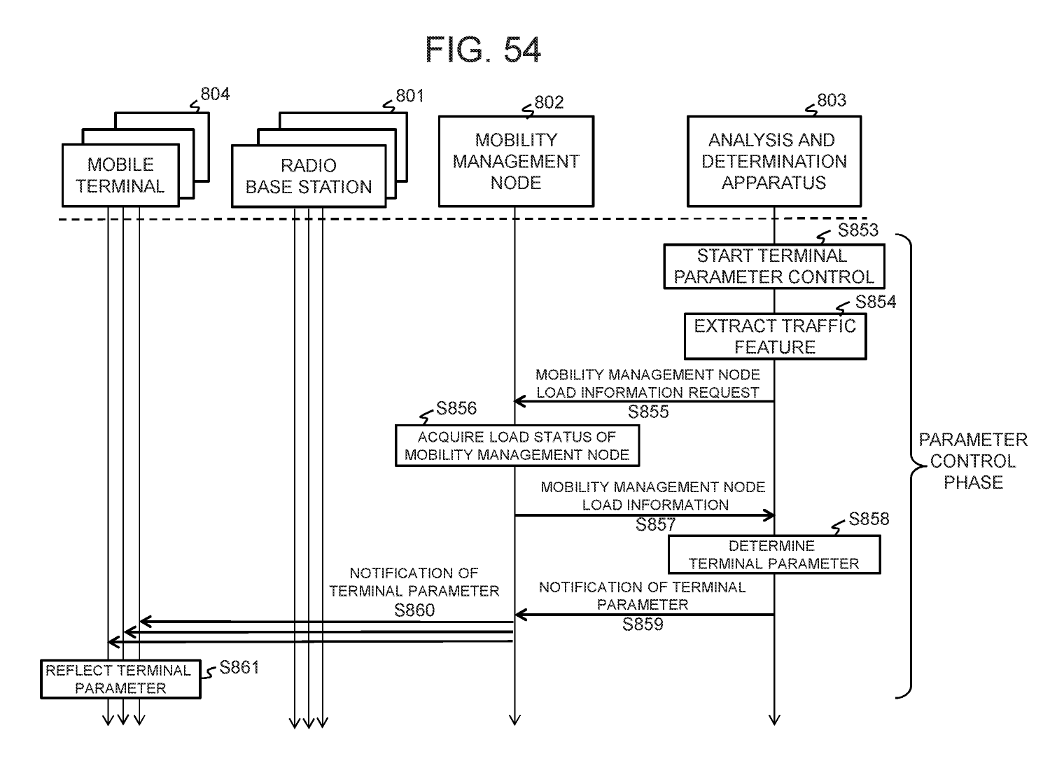

As shown in FIG. 52, operation in the present exemplary embodiment includes a traffic data collection phase and a parameter control phase. Hereinafter, the traffic data collection phase and parameter control phase will be individually described in detail with reference to FIGS. 53 and 54. However, the traffic data collection phase and parameter control phase can be operated independently of each other, and it is also possible that while traffic data is collected, parameter control is performed in parallel every time data is accumulated.

In the traffic data collection phase shown in FIG. 53, it is assumed that the radio base stations 801 have acquired traffic data (Operation S850) and have sent it to the analysis and determination apparatus 803 (Operation S851). The traffic data reception section 830 of the analysis and determination apparatus 803 collects the traffic data from the plurality of radio base stations 801 and accumulates it in the traffic data accumulation section 831 (Operation S852).

In the parameter control phase shown in FIG. 54, after the traffic data has been accumulated in the traffic data accumulation section 831 of the analysis and determination apparatus 803, the control section 835 starts terminal parameter control at an arbitrary timing (Operation S853). First, the traffic feature extraction section 832 extracts a traffic feature from the accumulated traffic data (Operation S854), and then the control section 835 controls the terminal parameter determination section 833 to send a mobility management node load information request to the mobility management node 802 via the mobility management node load information transceiver section 834 (Operation S855).

When receiving the mobility management node load information request from the analysis and determination apparatus 803, the load information transceiver section 824 of the mobility management node 802 acquires information about the load status of its own node from the mobility management node load monitoring section 825 (Operation S856) and sends it to the analysis and determination apparatus 803 (Operation S857).

The terminal parameter determination section 833 of the analysis and determination apparatus 803 determines a terminal parameter by using the mobility management node load information received via the mobility management node load information transceiver section 834 and the traffic feature extracted by the traffic feature extraction section 832 (Operation S858). The determined terminal parameter is sent to the mobility management node 802 via the terminal parameter transmission section 836 (Operation S859). When the terminal parameter reception section 822 of the mobility management node 802 receives the terminal parameter, the terminal parameter notification section 823 sends this terminal parameter toward destination mobile terminals 801 (Operation S860). The mobile terminals 804 that have thus received the terminal parameter perform operation in accordance with the terminal parameter (Operation S861).

Note that although the terminal parameter is notified from the analysis and determination apparatus 803 to the mobile terminals 804 via the mobility management node 802 and radio base stations 801 in the present exemplary embodiment, it is also possible that the terminal parameter is sent from the analysis and determination apparatus 803 directly to the radio base stations 801 and then notified to the mobile terminals 804.

### 9.3) Effects

As described above, according to the ninth exemplary embodiment of the present invention, a mobile terminal parameter (restriction rate or the like) is determined based on a traffic feature (C-packet occurrence rate, simultaneous arrival rate, periodic interval, phase, phase shift, or the like) in the radio access network 102, whereby parameter control is performed on target mobile terminals 804. Thus, parameter control is performed, overviewing the entire network, only on mobile terminals that are effective in reducing the load on the mobility management node, and accordingly it is possible to reduce traffic loads in the network.

### INDUSTRIAL APPLICABILITY

This invention can be applied to mobile networks having a C-plane management node in general.

### REFERENCE SIGNS LIST

10 Network control system
11 Traffic information collection function
12 Traffic feature extraction function
13 Control parameter determination function
20 Network
21 Communication node
22 C-plane processing node
30 Packet data network
101 Core network
102, 102a, 102b Radio access network
103 Mobility management node
104 Radio base station
201 Mobility management node
202 Analysis and determination apparatus
301 Radio base station
302 Mobility management node
303 Analysis and determination apparatus
401 Radio base station
402 Analysis and determination apparatus
501 Radio base station
502 Base station control apparatus
503 Analysis and determination apparatus
601 Radio base station
602 Base station control apparatus
603 Analysis and determination apparatus
701 Radio base station
702 Mobility management node
703 Analysis and determination apparatus
801 Radio base station
802 Mobility management node
803 Analysis and determination apparatus

1. A system for controlling a network including a plurality of nodes, comprising:
a first apparatus that is configured to collect traffic data from the network;
a second apparatus that is configured to extract a traffic feature of the network in its entirety from the traffic data collected; and
a third apparatus that is configured to determine a control parameter to be set on the node, based on the traffic feature.

2. The system according to claim 1, characterized in that the traffic feature is a statistic related to occurrence or arrival of traffic within the network.

3. The system according to claim 1, wherein the traffic feature is a rate of simultaneous arrival of packets at two or more nodes in the network.

4. The system according to claim 1, wherein the third apparatus that is configured to change a value of at least one control parameter among a control parameter for suppressing occurrence of a packet itself, a control parameter for discarding a packet generated, and a control parameter for distributing concentrated packet processing, depending on a change in the traffic feature.

5. The system according to claim 1, wherein the network includes a plurality of base station nodes and a control signal processing node, wherein the third apparatus that is configured to determine a control parameter of at least part of the plurality of base station nodes.

6. The system according to claim 1, wherein the network includes a plurality of base station nodes and a control signal processing node, wherein the third apparatus that is configured to determine a control parameter of the control signal processing node.

7. The system according to claim 1, wherein the network includes a plurality of base station nodes, a control signal processing node, and mobile terminal nodes capable of connecting to each base station node, wherein the third apparatus that is configured to determine a control parameter of at least one mobile terminal node connected to at least part of the plurality of base station nodes.

8. The system according to claim 1 wherein the network includes a plurality of base station nodes and a control signal processing node, wherein the traffic data is traffic data acquired by at least part of the plurality of base station nodes.

9. The system according to claim 8, wherein the at least part of the base station nodes are nodes selected at random from the network in its entirety.

10. The system according to claim 8, wherein all nodes in the network are classified into a plurality of classes, and the at least part of the base station nodes include nodes selected at random from each class.

11. The system according to claim 1, wherein the network includes a plurality of base station nodes and a control signal processing node, wherein the control signal processing node includes the first apparatus, the second apparatus, and the third apparatus.

12. The system according to claim 1, wherein the network includes a plurality of base station nodes and a control signal processing node, wherein the control signal processing node includes the first apparatus, and an analysis and determination apparatus connected to the control signal processing node includes the second apparatus and the third apparatus.

13. The system according to claim 1, wherein
the network comprises: a plurality of base station nodes; a control signal processing node; and an analysis and determination apparatus connected to the control signal processing node,
wherein the plurality of base station nodes are directly connected to the analysis and determination apparatus, and
each of the plurality of base station nodes acquire the traffic data, and the analysis and determination apparatus includes the first apparatus, the second apparatus, and the third apparatus.

14. The system according to claim 1, wherein the second apparatus comprises:
a first traffic feature extraction unit that is configured to extract a local traffic feature from the traffic data collected;
a second traffic feature extraction unit that is configured to extract a the traffic feature from the local traffic features.

15.-19. (canceled)

20. The system according to claim 1, wherein the network includes a plurality of base stations and a plurality of base station control apparatuses, wherein
each of the plurality of base stations comprises a traffic data acquisition unit that is configured to acquire the traffic data to send it to the first apparatus, and
each of the base station control apparatuses comprises: the second apparatus and the third apparatus, wherein the second apparatus extracts the traffic feature under control of this base station control apparatus from the traffic data collected and the third apparatus determines the control parameter to be set on the base stations under control based on the traffic feature.

21. The system according to claim 1, wherein the network includes a plurality of base stations and a plurality of base station control apparatuses, wherein each of the plurality of base stations comprises a traffic data acquisition unit that is configured to acquire the traffic data to send it to the first apparatus,
wherein the second apparatus comprises a first traffic feature extraction and a second traffic feature extraction unit,
wherein each of the plurality of base station control apparatuses comprises the first traffic feature extraction unit that is configured to extract a local traffic feature of a network under control of this base station control apparatus from the traffic data collected from base stations under control,
the system further comprises:
an analysis and determination apparatus that is configured to accommodates the plurality of base station control apparatuses, wherein the analysis and determination apparatus comprises: the second traffic feature extraction unit that is configured to extract the traffic feature of the network in its entirety from the local traffic features collected from the plurality of base station control apparatuses.

22. A network control method for controlling a network including a plurality of nodes, comprising:
collecting traffic data from the network;
extracting a traffic feature of the network in its entirety from the collected traffic data; and
determining a control parameter to be set on the node, based on the traffic feature.

23.-34. (canceled)

35. The method according to claim 22, wherein the traffic feature is extracted by:
extracting a local traffic feature from the traffic data collected;
extracting the traffic feature from the local traffic features.

36.-40. (canceled)

41. The method according to claim 22, wherein the network includes a plurality of base stations and a plurality of base station control apparatuses, wherein:
at each of the plurality of base stations, acquiring the traffic data to send it to the first apparatus; and
at each of the base station control apparatuses,
extracting the traffic feature under control of this base station control apparatus from the traffic data collected from base stations under control; and
determining the control parameter to be set on the base station under control based on the traffic feature.

42. The method according to claim 22, wherein the network includes a plurality of base stations and a plurality of base station control apparatuses, wherein:
at each of the plurality of base stations, acquiring the traffic data to send it to the first apparatus;
at each of the plurality of base station control apparatuses, extracting a local traffic feature of the network under control of this base station control apparatus from the traffic data collected from base stations under control; and
at an analysis and determination apparatus that accommodates the plurality of base station control apparatus,
extracting the traffic feature of the network in its entirety from the local traffic features collected from the plurality of base station control apparatuses, and
determining the control parameter to be set on the base stations based on the traffic feature.

43. (canceled)

44. An apparatus for managing a mobile network including a plurality of base station nodes, comprising:
a first apparatus that is configured to collect traffic data from the network;
a second apparatus that is configured to extract a traffic feature of the network in its entirety from the traffic data collected; and
a third apparatus that is configured to determine a control parameter to be set on the node, based on the traffic feature.

45. (canceled)

46. The apparatus according to claim 44, wherein the second apparatus comprises:
a first traffic feature extraction unit that is configured to extract a local traffic feature from the traffic data collected from the base station nodes in the mobile network; and
a second traffic feature extraction unit that is configured to extract the traffic feature from the local traffic features.
